(19) United States
(12) Patent Application Publication
(10) Pub. No.: US 2023/0406499 A1
(43) Pub. Date: Dec. 21, 2023

(54) Curbside UAV Loading

(71) Applicant: Wing Aviation LLC, Mountain View, CA (US)

(72) Inventors: Adam Woodworth, San Jose, CA (US); André Prager, Sunnyvale, CA (US); Marcus Hammond, Redwood City, CA (US); Kevin Jenkins, Dallas, TX (US); Ivan Qiu, Redwood City, CA (US); Jasper Lewin, Santa Cruz, CA (US); Jonathan Lesser, Oakland, CA (US); Elizabeth Marshman, San Francisco, CA (US)

(21) Appl. No.: 18/210,634

(22) Filed: Jun. 15, 2023

Related U.S. Application Data
(60) Provisional application No. 63/366,455, filed on Jun. 15, 2022.

(51) Int. Cl. B64D 1/10; B64D 1/22

(52) U.S. Cl. CPC B64D 1/10; B64D 1/22; B64U 2101/64

(57) ABSTRACT

A delivery method using curbside payload pickup by a UAV is provided. The method includes providing instructions to cause physical loading of a payload onto an autoloader device for subsequent UAV transport of the payload. A communication signal is received indicating that the autoloader device has been physically loaded with the payload. A UAV from a group of one or more UAVs is selected to pick up the payload from the autoloader device. Instructions are provided to cause the selected UAV to navigate to the autoloader device to pick up the payload and transport the payload to a delivery location.

### CROSS REFERENCE TO RELATED APPLICATION

This application claims priority to U.S. Provisional Patent Application No. 63/366,455, filed Jun. 15, 2022, the contents of which are incorporated by reference.

### BACKGROUND

An unmanned vehicle, which may also be referred to as an autonomous vehicle, is a vehicle capable of travel without a physically-present human operator. An unmanned vehicle may operate in a remote-control mode, in an autonomous mode, or in a partially autonomous mode.

When an unmanned vehicle operates in a remote-control mode, a pilot or driver that is at a remote location can control the unmanned vehicle via commands that are sent to the unmanned vehicle via a wireless link. When the unmanned vehicle operates in autonomous mode, the unmanned vehicle typically moves based on pre-programmed navigation waypoints, dynamic automation systems, or a combination of these. Further, some unmanned vehicles can operate in both a remote-control mode and an autonomous mode, and in some instances may do so simultaneously. For instance, a remote pilot or driver may wish to leave navigation to an autonomous system while manually performing another task, such as operating a mechanical system for picking up objects, as an example.

Various types of unmanned vehicles exist for various different environments. For instance, unmanned vehicles exist for operation in the air, on the ground, underwater, and in space. Examples include quad-copters and tail-sitter UAVs, among others. Unmanned vehicles also exist for hybrid operations in which multi-environment operation is possible. Examples of hybrid unmanned vehicles include an amphibious craft that is capable of operation on land as well as on water or a floatplane that is capable of landing on water as well as on land. Other examples are also possible.

### SUMMARY

The present embodiments are directed to systems and methods for delivering packages from an item provider using a UAV.

In one aspect, a method includes providing instructions to cause physical loading of a payload onto an autoloader device for subsequent unmanned aerial vehicle (UAV) transport of the payload; receiving a communication signal indicating that the autoloader device has been physically loaded with the payload; selecting a UAV from a group of one or more UAVs to pick up the payload from the autoloader device; and providing instructions to cause the selected UAV to navigate to the autoloader device to pick up the payload and transport the payload to a delivery location

In another aspect, the disclosure provides one or more computing devices comprising non-transitory computer readable medium comprising program instructions executable by one or more processors to cause the one or more computing devices to perform functions comprising: providing instructions to cause physical loading of a payload onto an autoloader device for subsequent unmanned aerial vehicle (UAV) transport of the payload; receiving a communication signal indicating that the autoloader device has been physically loaded with the payload; selecting a UAV from a group of one or more UAVs to pick up the payload from the autoloader device; and providing instructions to cause the selected UAV to navigate to the autoloader device to pick up the payload and transport the payload to a delivery location.

In another aspect the disclosure provides one or more non-transitory computer readable media comprising program instructions executable by one or more processors to cause one or more computing devices to perform functions comprising: providing instructions to cause physical loading of a payload onto an autoloader device for subsequent unmanned aerial vehicle (UAV) transport of the payload; receiving a communication signal indicating that the autoloader device has been physically loaded with the payload; selecting a UAV from a group of one or more UAVs to pick up the payload from the autoloader device; and providing instructions to cause the selected UAV to navigate to the autoloader device to pick up the payload and transport the payload to a delivery location.

In another aspect, a payload retrieval apparatus is provided. The payload retrieval apparatus comprises: an extending member having an upper end and a lower end; a channel having a first end and a second end, the channel coupled to the extending member; a first tether engager that extends in a first direction from the first end of the channel; and a payload holder positioned near the second end of the channel and adapted to secure a payload, wherein the payload retrieval apparatus is mounted to a structure.

In another aspect, a wall-mounted payload retrieval apparatus is provided. The payload retrieval apparatus comprises: an extending member having an upper end and a lower end; a channel having a first end and a second end, the channel coupled to the extending member; a first tether engager that extends in a first direction from the first end of the channel; and a payload holder positioned near the second end of the channel and is adapted to secure a payload, wherein the payload retrieval apparatus is mounted to a boom arm that is mounted to a wall with a boom mount, wherein the boom mount is movable to allow the payload retrieval apparatus to be lowered to allow an operator to secure a payload to the payload retrieval apparatus.

In another aspect, a movable payload retrieval apparatus is provided. The movable payload retrieval apparatus includes an extending member having an upper end and a lower end, a channel having a first end and a second end, the channel coupled to the extending member; a first tether engager that extends in a first direction from the first end of the channel; a payload holder positioned near the second end of the channel and is adapted to secure a payload, wherein the payload retrieval apparatus includes a movable base positioned below the lower end of the extending member.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1A is a simplified illustration of an unmanned aerial vehicle, according to an example embodiment.

FIG. 1B is a simplified illustration of an unmanned aerial vehicle, according to an example embodiment.

FIG. 1C is a simplified illustration of an unmanned aerial vehicle, according to an example embodiment.

FIG. 1D is a simplified illustration of an unmanned aerial vehicle, according to an example embodiment.

FIG. 1E is a simplified illustration of an unmanned aerial vehicle, according to an example embodiment.

FIG. 2 is a simplified block diagram illustrating components of an unmanned aerial vehicle, according to an example embodiment.

FIG. 3A is a simplified block diagram illustrating a UAV system, according to an example embodiment.

FIG. 3B is a block diagram showing an example arrangement for a transport provider system, according to example implementations.

FIGS. 4A, 4B, and 4C show a payload delivery apparatus, according to example embodiments.

FIG. 5A shows a perspective view of a payload delivery apparatus 500 including payload 510, according to an example embodiment.

FIG. 5B is a cross-sectional side view of payload delivery apparatus 500 and payload 510 shown in FIG. 5A.

FIG. 5C is a side view of payload delivery apparatus 500 and payload 510 shown in FIGS. 5A and 5B.

FIG. 6A is a perspective view of payload coupling apparatus 800, according to an example embodiment.

FIG. 6B is a side view of payload coupling apparatus 800 shown in FIG. 6A.

FIG. 6C is a front view of payload coupling apparatus 800 shown in FIGS. 6A and 6B.

FIG. 7 is a perspective view of payload coupling apparatus 800 shown in FIGS. 6A-6C, prior to insertion into a payload coupling apparatus receptacle positioned in the fuselage of a UAV.

FIG. 8 is another perspective view of payload coupling apparatus 800 shown in FIGS. 6A-6C, prior to insertion into a payload coupling apparatus receptacle positioned in the fuselage of a UAV.

FIG. 9 shows a perspective view of a recessed restraint slot and payload coupling apparatus receptacle positioned in a fuselage of a UAV.

FIG. 10A shows a side view of a payload delivery apparatus 500 with a handle 511 of payload 510 secured within a payload coupling apparatus 800 as the payload 510 moves downwardly prior to touching down for delivery.

FIG. 10B shows a side view of payload delivery apparatus 500 after payload 510 has landed on the ground showing payload coupling apparatus 800 decoupled from handle 511 of payload 510.

FIG. 10C shows a side view of payload delivery apparatus 500 with payload coupling apparatus 800 moving away from handle 511 of payload 510.

FIG. 11A is a side view of handle 511 of payload 510 having openings 514 and 516 adapted to receive pins positioned on a payload holder, according to an example embodiment.

FIG. 11B is a side view of handle 511′ of a payload having magnets 514′ and 516′ positioned thereon for magnetic engagement with a payload holder, according to an example embodiment.

FIG. 12 shows a pair of locking pins 570, 572 extending through holes 514 and 516 in handle 511 of payload 510 to secure the handle 511 and top of payload 510 within the fuselage of a UAV, or to secure the handle 511 to a payload holder on a payload retrieval apparatus.

FIG. 13A is a side view of payload coupling apparatus 800′ with a slot 808 positioned above lip 806′, according to an example embodiment.

FIG. 13B is a side view of payload coupling apparatus 800′ after lip 806′ has been moved outwardly to facilitate engagement with a handle of a payload.

FIG. 13C is a side view of payload coupling apparatus 800″ having a plurality of magnets 830 positioned thereon, according to an example embodiment.

FIG. 13D is a side view of payload coupling apparatus 900 having a weighted side 840, according to an example embodiment.

FIG. 14A is a perspective view of payload retrieval apparatus 1000 having a payload 510 positioned thereon, according to an example embodiment.

FIG. 14B is another perspective view of payload retrieval apparatus 1000 and payload 510 shown in FIG. 14A.

FIG. 14C is a further perspective view of payload retrieval apparatus 1000 and payload 510 shown in FIGS. 14A and 14B.

FIG. 14D shows a sequence of steps A-D performed in the retrieval of payload 510 from payload retrieval apparatus 1000 shown in FIGS. 14A-14C.

FIG. 15 is a flowchart of a method of delivery including curbside pickup according to an example embodiment.

FIGS. 16A-16F illustrate a method of delivery including curbside pickup according to an example embodiment.

FIGS. 17A-17F illustrate a method of delivery including curbside pickup according to another example embodiment.

FIGS. 18A-18E are flowcharts of example methods of delivery according to an example embodiment.

FIG. 19 is a perspective view of payload retrieval apparatus 1000 shown in FIGS. 14A-14C with a payload loading apparatus 1080 having a plurality of payloads positioned thereon, according to an example embodiment.

FIG. 20A is a perspective view of channel 1050 of the payload retrieval apparatus 1000 shown in FIGS. 14A-14C with a payload retriever 800 positioned therein.

FIG. 20B is a perspective view of channel 1050 of the payload retrieval apparatus 1000 shown in FIGS. 14A-14C with a payload retriever 800″ positioned therein.

FIG. 21A is a cross-sectional view of channel 1050, according to an example embodiment.

FIG. 21B is a side view of channel 1050 having a spring 1059 biased against end 1057 thereof.

FIG. 22 is a side view of payload retrieval apparatus 1400.

FIG. 23 is a top view of payload retrieval apparatus 1400.

FIGS. 24A-E illustrate a sequence of steps used to automatically pick up payload 510.

FIG. 25A is a perspective view of payload retrieval apparatus 1480.

FIG. 25B is a side view of payload retrieval apparatus 1480.

FIG. 25C is a side view of an end of payload retrieval apparatus 1480 with payload 510 positioned on curved portion 1439.

FIG. 25D is a perspective view of an end of payload retrieval apparatus 1480 with payload 510 positioned on curved portion 1439.

FIG. 25E shows a perspective view of payload retrieval apparatus 1500.

FIG. 26 is a perspective view of payload retrieval apparatus 1480.

FIG. 27A shows perspective views of rotational spring loaded pusher 1600.

FIG. 27B shows a side view of leaf spring 1640.

FIG. 27C shows a side view of linear spring plunger 1650.

FIG. 28 is a perspective view of payload retrieval apparatus 1700.

FIGS. 29A-B show perspective and side views of spring loaded plunger pin 1484.

FIGS. 30A-B show side views of protrusions 1519.

FIGS. 31A-B show side and perspective views of curved portion 1439.

FIGS. 32A-C show side and perspective views of curved portion 1439.

FIGS. 33A-B show perspective views of curved portion 1439.

FIGS. 34A-E show various perspective views of pivoting carriage 1700.

FIG. 35 shows a side view of payload retrieval apparatus 1000.

FIG. 36 shows a front view of payload retrieval apparatus 1900.

FIG. 37 shows a perspective side view of payload retrieval apparatus 1900.

FIG. 38 shows a rear view of payload retrieval apparatus 1900.

FIG. 39 shows a top view of payload retrieval apparatus 1900.

FIG. 40A shows a partial top view of payload retrieval apparatus 1900.

FIG. 40B shows a partial rear perspective view of payload retrieval apparatus 1900.

FIG. 40C shows a partial rear perspective view of payload retrieval apparatus 1900.

FIG. 40D shows a partial rear perspective view of payload retrieval apparatus 1900.

FIG. 41A shows a perspective view of payload retrieval apparatus 1950.

FIG. 41B shows a front view of payload retrieval apparatus 1950.

FIG. 41C shows a partial side view of payload retrieval apparatus 1950.

FIG. 42 illustrates an autoloader device and a UAV side-step trajectory, in accordance with examples described herein.

FIG. 43 illustrates an autoloader device and a sequence of UAV trajectories, in accordance with examples described herein.

FIG. 44 illustrates a UAV mission profile and tolerances, in accordance with examples described herein.

FIG. 45 is a graph of tether offset profiles at a plurality of different wind speeds, in accordance with examples described herein.

FIG. 46 is a graph of horizontal and vertical displacements of a payload coupling apparatus at different wind speeds, in accordance with examples described herein.

FIG. 47 is a block diagram of a method, in accordance with examples described herein.

FIG. 48 is a perspective view of payload retrieval apparatus 5100 mounted to light post 5140.

FIG. 49 provides perspective views of payload retrieval apparatus 5100 mounted to sign post 5150.

FIG. 50 is a perspective view of payload retrieval apparatus 5100 mounted to flagpole 5160.

FIG. 51 provides a close-up perspective view of payload retrieval apparatus 5100 mounted to flagpole 5160.

FIG. 52 is a perspective view of payload retrieval apparatus 5100 mounted to a boom arm 5170 mounted to wall 5174 with wall mount 5172.

FIG. 53 is a perspective view of payload retrieval apparatus 5100 mounted to wall 5174.

FIG. 54 provides a perspective view of bike racks 5175 to which payload retrieval apparatus 5100 may be mounted.

FIG. 55 illustrates a perspective view of a plurality of poles 5190 each having a payload retrieval apparatus 5100 mounted on the top of each pole 5190 to form a payload retrieval zone.

FIG. 56 illustrates a perspective view of payload retrieval apparatus 5100 mounted above a movable base 5142.

FIG. 57 illustrates a perspective view of payload retrieval apparatus 5100 mounted above a movable tripod base 5123.

FIG. 58 illustrates a perspective view of payload retrieval apparatus 5100 mounted above a movable wheeled base 5169.

FIGS. 59 to 66 illustrate example payload retrieval apparatuses that are integrated into other structures.

FIG. 67 illustrates an example mobile base for a payload retrieval apparatus.

FIG. 68 illustrates movement of a payload retrieval apparatus along a line tracker.

FIG. 69 illustrates mounting a payload retrieval apparatus onto a mobile base.

### DETAILED DESCRIPTION

Exemplary methods and systems are described herein. It should be understood that the word “exemplary” is used herein to mean “serving as an example, instance, or illustration.” Any implementation or feature described herein as “exemplary” or “illustrative” is not necessarily to be construed as preferred or advantageous over other implementations or features. In the figures, similar symbols typically identify similar components, unless context dictates otherwise. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

Furthermore, the particular arrangements shown in the Figures should not be viewed as limiting. It should be understood that other embodiments might include more or less of each element shown in a given Figure. Further, some of the illustrated elements may be combined or omitted. Yet further, an example embodiment may include elements that are not illustrated in the Figures.

### I. Overview

The present embodiments are related to the use of unmanned aerial vehicles (UAVs) or unmanned aerial systems (UASs) (referred to collectively herein as UAVs) that are used to carry a payload to be delivered or retrieved. As examples, UAVs may be used to deliver or retrieve a payload to or from an individual or business. In operation the payload to be delivered is secured to the UAV and the UAV is then flown to the desired delivery site. The payload may be secured beneath the UAV, positioned within the UAV, or positioned partially within the UAV, as the UAV flies to the delivery site. Once the UAV arrives at the delivery site, the UAV may land to deliver the payload, or may be operated in a hover mode while the payload is dropped or lowered from the UAV towards the delivery site using a tether and a winch mechanism positioned within the UAV.

### II. Illustrative Unmanned Vehicles

Herein, the terms “unmanned aerial vehicle” and “UAV” refer to any autonomous or semi-autonomous vehicle that is capable of performing some functions without a physically present human pilot.

A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “unmanned aerial vehicle system” (UAVS), or “unmanned aerial system” (UAS) may also be used to refer to a UAV.

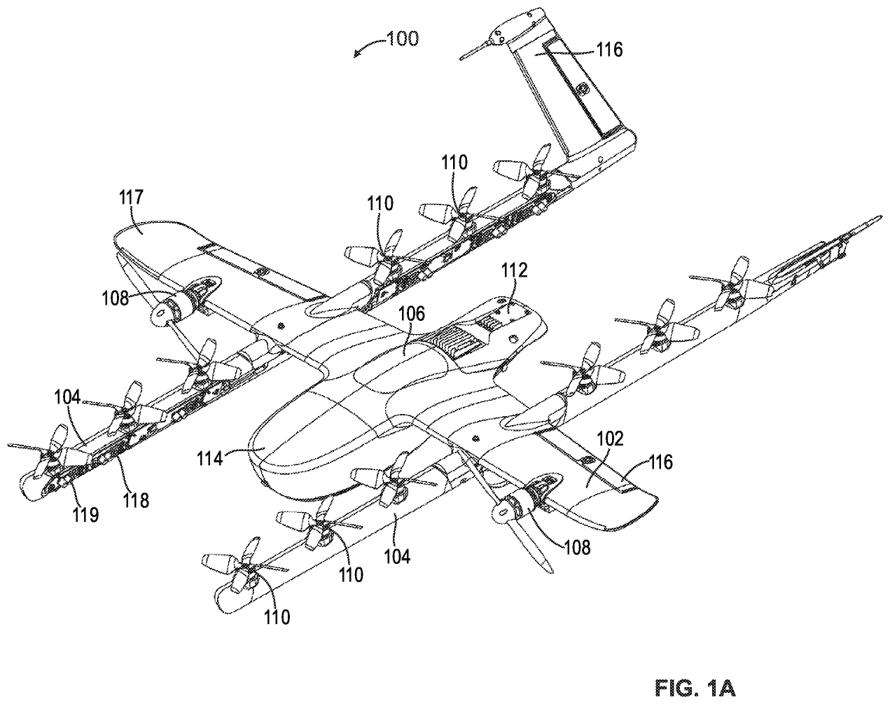

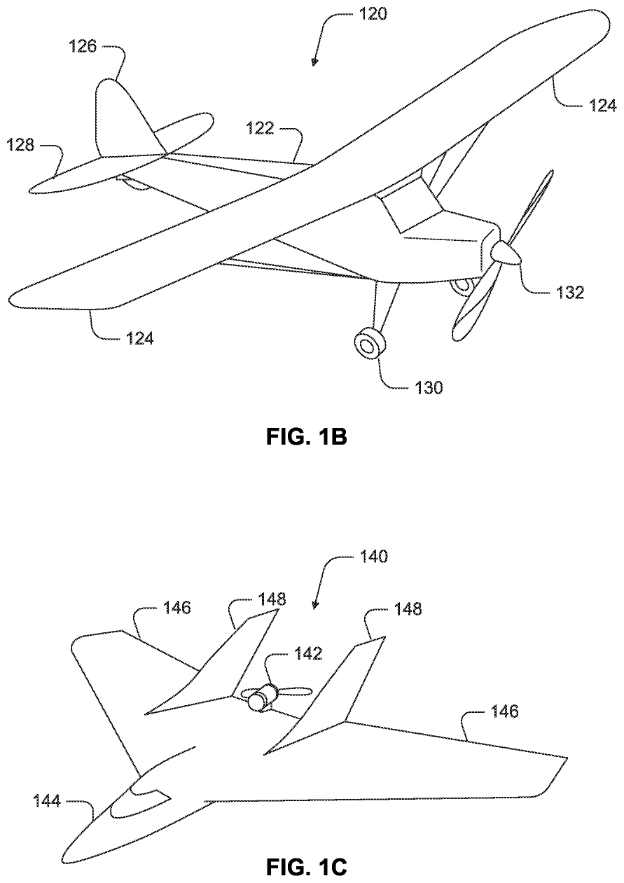

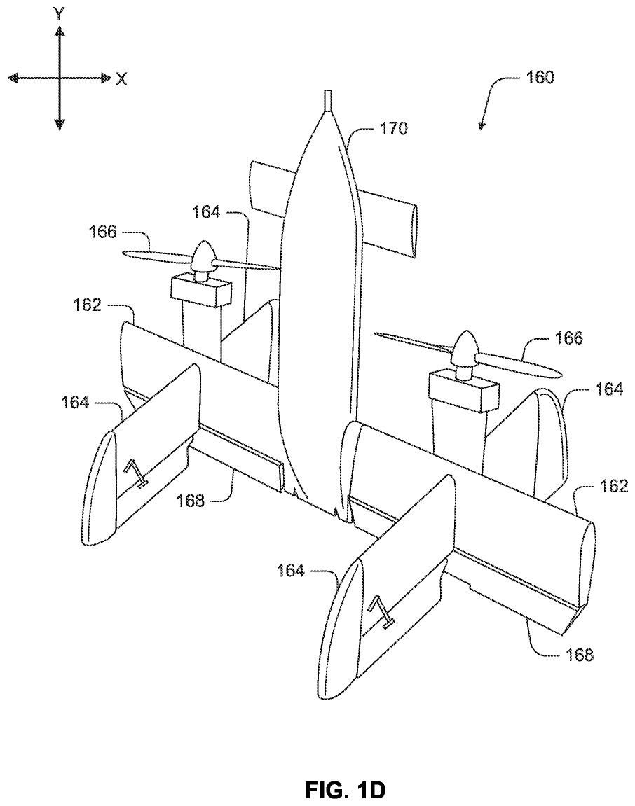

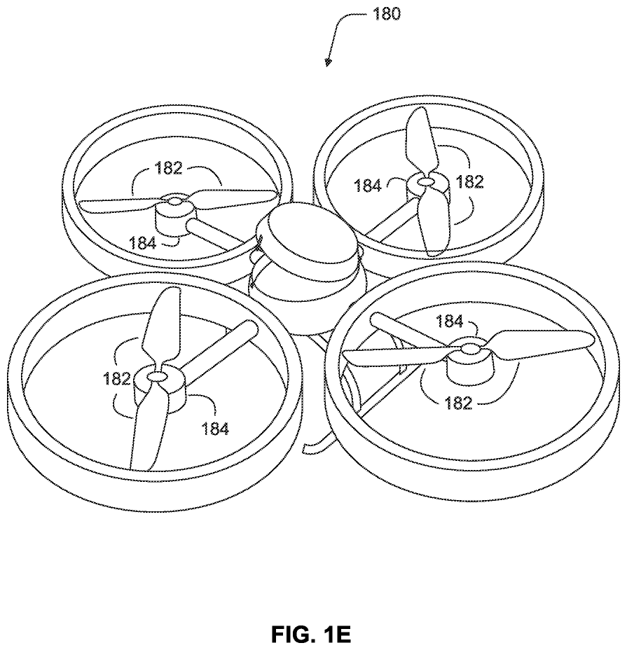

FIG. 1A is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per the boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, UAVs with more wings (e.g., an “x-wing” configuration with four wings), are also possible. Although FIG. 1A illustrates two wings 102, two booms 104, two horizontal propulsion units 108, and six vertical propulsion units 110 per boom 104, it should be appreciated that other variants of UAV 100 may be implemented with more or less of these components. For example, UAV 100 may include four wings 102, four booms 104, and more or less propulsion units (horizontal or vertical).

Similarly, FIG. 1B shows another example of a fixed-wing UAV 120. The fixed-wing UAV 120 includes a fuselage 122, two wings 124 with an airfoil-shaped cross section to provide lift for the UAV 120, a vertical stabilizer 126 (or fin) to stabilize the plane's yaw (turn left or right), a horizontal stabilizer 128 (also referred to as an elevator or tailplane) to stabilize pitch (tilt up or down), landing gear 130, and a propulsion unit 132, which can include a motor, shaft, and propeller.

FIG. 1C shows an example of a UAV 140 with a propeller in a pusher configuration. The term “pusher” refers to the fact that a propulsion unit 142 is mounted at the back of the UAV and “pushes” the vehicle forward, in contrast to the propulsion unit being mounted at the front of the UAV. Similar to the description provided for FIGS. 1A and 1B, FIG. 1C depicts common structures used in a pusher plane, including a fuselage 144, two wings 146, vertical stabilizers 148, and the propulsion unit 142, which can include a motor, shaft, and propeller.

FIG. 1D shows an example of a tail-sitter UAV 160. In the illustrated example, the tail-sitter UAV 160 has fixed wings 162 to provide lift and allow the UAV 160 to glide horizontally (e.g., along the x-axis, in a position that is approximately perpendicular to the position shown in FIG. 1D). However, the fixed wings 162 also allow the tail-sitter UAV 160 to take off and land vertically on its own.

For example, at a launch site, the tail-sitter UAV 160 may be positioned vertically (as shown) with its fins 164 and/or wings 162 resting on the ground and stabilizing the UAV 160 in the vertical position. The tail-sitter UAV 160 may then take off by operating its propellers 166 to generate an upward thrust (e.g., a thrust that is generally along the y-axis). Once at a suitable altitude, the tail-sitter UAV 160 may use its flaps 168 to reorient itself in a horizontal position, such that its fuselage 170 is closer to being aligned with the x-axis than the y-axis. Positioned horizontally, the propellers 166 may provide forward thrust so that the tail-sitter UAV 160 can fly in a similar manner as a typical airplane.

Many variations on the illustrated fixed-wing UAVs are possible. For instance, fixed-wing UAVs may include more or fewer propellers, and/or may utilize a ducted fan or multiple ducted fans for propulsion. Further, UAVs with more wings (e.g., an “x-wing” configuration with four wings), with fewer wings, or even with no wings, are also possible.

As noted above, some embodiments may involve other types of UAVs, in addition to or in the alternative to fixed-wing UAVs. For instance, FIG. 1E shows an example of a rotorcraft that is commonly referred to as a multicopter 180. The multicopter 180 may also be referred to as a quadcopter, as it includes four rotors 182. It should be understood that example embodiments may involve a rotorcraft with more or fewer rotors than the multicopter 180. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to the multicopter 180 in greater detail, the four rotors 182 provide propulsion and maneuverability for the multicopter 180. More specifically, each rotor 182 includes blades that are attached to a motor 184. Configured as such, the rotors 182 may allow the multicopter 180 to take off and land vertically, to maneuver in any direction, and/or to hover. Further, the pitch of the blades may be adjusted as a group and/or differentially, and may allow the multicopter 180 to control its pitch, roll, yaw, and/or altitude.

It should be understood that references herein to an “unmanned” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of unmanned aerial vehicle.

### III. Illustrative UAV Components

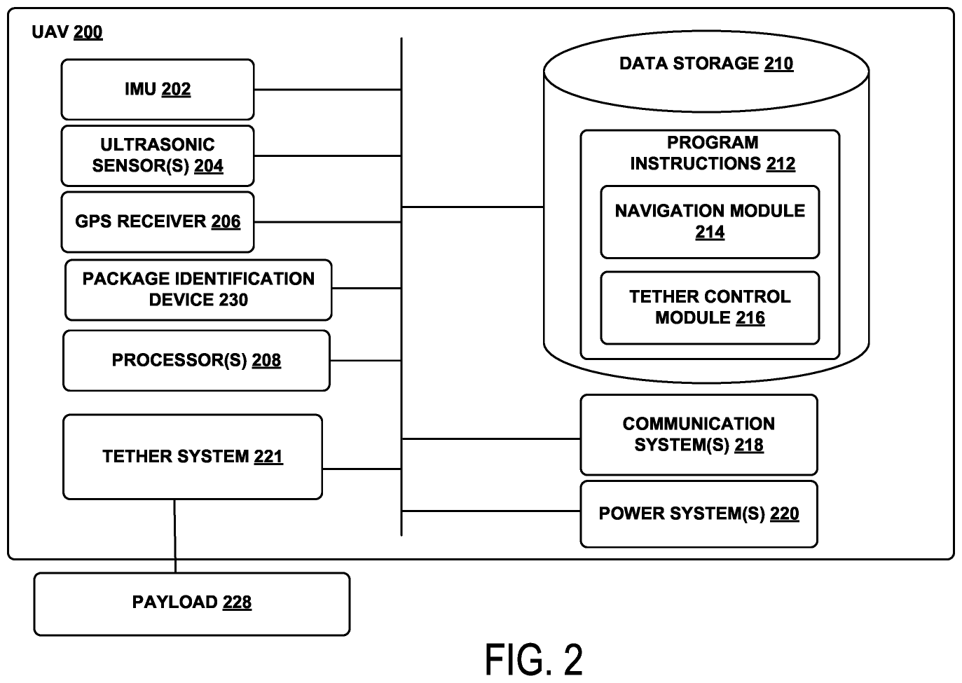

FIG. 2 is a simplified block diagram illustrating components of a UAV 200, according to an example embodiment. UAV 200 may take the form of, or be similar in form to, one of the UAVs 100, 120, 140, 160, and 180 described in reference to FIGS. 1A-1E. However, UAV 200 may also take other forms.

UAV 200 may include various types of sensors, and may include a computing system configured to provide the functionality described herein. In the illustrated embodiment, the sensors of UAV 200 include an inertial measurement unit (IMU) 202, ultrasonic sensor(s) 204, and a GPS 206, among other possible sensors and sensing systems.

In the illustrated embodiment, UAV 200 also includes one or more processors 208. A processor 208 may be a general-purpose processor or a special purpose processor (e.g., digital signal processors, application specific integrated circuits, etc.). The one or more processors 208 can be configured to execute computer-readable program instructions 212 that are stored in the data storage 210 and are executable to provide the functionality of a UAV described herein.

The data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of the one or more processors 208. In some embodiments, the data storage 210 can be implemented using a single physical device (e.g., one optical, magnetic, organic or other memory or disc storage unit), while in other embodiments, the data storage 210 can be implemented using two or more physical devices.

As noted, the data storage 210 can include computer-readable program instructions 212 and perhaps additional data, such as diagnostic data of the UAV 200. As such, the data storage 210 may include program instructions 212 to perform or facilitate some or all of the UAV functionality described herein. For instance, in the illustrated embodiment, program instructions 212 include a navigation module 214 and a tether control module 216.

### A. Sensors

In an illustrative embodiment, IMU 202 may include both an accelerometer and a gyroscope, which may be used together to determine an orientation of the UAV 200. In particular, the accelerometer can measure the orientation of the vehicle with respect to earth, while the gyroscope measures the rate of rotation around an axis. IMUs are commercially available in low-cost, low-power packages. For instance, an IMU 202 may take the form of or include a miniaturized MicroElectroMechanical System (MEMS) or a NanoElectroMechanical System (NEMS). Other types of IMUs may also be utilized.

An IMU 202 may include other sensors, in addition to accelerometers and gyroscopes, which may help to better determine position and/or help to increase autonomy of the UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of the UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmission of the wave and receiving the corresponding echo off an object. A typical application of an ultrasonic sensor for unmanned vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with unmanned vehicles. Such imaging sensor(s) have numerous possible applications, such as obstacle avoidance, localization techniques, ground tracking for more accurate navigation (e.g., by applying optical flow techniques to images), video feedback, and/or image recognition and processing, among other possibilities.

UAV 200 may also include a GPS receiver 206. The GPS receiver 206 may be configured to provide data that is typical of well-known GPS systems, such as the GPS coordinates of the UAV 200. Such GPS data may be utilized by the UAV 200 for various functions. As such, the UAV may use its GPS receiver 206 to help navigate to the caller's location, as indicated, at least in part, by the GPS coordinates provided by their mobile device. Other examples are also possible.

### B. Navigation and Location Determination

The navigation module 214 may provide functionality that allows the UAV 200 to, e.g., move about its environment and reach a desired location. To do so, the navigation module 214 may control the altitude and/or direction of flight by controlling the mechanical features of the UAV that affect flight (e.g., its rudder(s), elevator(s), aileron(s), and/or the speed of its propeller(s)).

In order to navigate the UAV 200 to a target location (e.g., a delivery location), the navigation module 214 may implement various navigation techniques, such as map-based navigation and localization-based navigation, for instance. With map-based navigation, the UAV 200 may be provided with a map of its environment, which may then be used to navigate to a particular location on the map. With localization-based navigation, the UAV 200 may be capable of navigating in an unknown environment using localization. Localization-based navigation may involve the UAV 200 building its own map of its environment and calculating its position within the map and/or the position of objects in the environment. For example, as a UAV 200 moves throughout its environment, the UAV 200 may continuously use localization to update its map of the environment. This continuous mapping process may be referred to as simultaneous localization and mapping (SLAM). Other navigation techniques may also be utilized.

In some embodiments, the navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, the navigation module 214 and/or other components and systems of the UAV 200 may be configured for “localization” to more precisely navigate to the scene of a target location. More specifically, it may be desirable in certain situations for a UAV to be within a threshold distance of the target location where a payload 228 is being delivered by a UAV (e.g., within a few feet of the target destination). To this end, a UAV may use a two-tiered approach in which it uses a more-general location-determination technique to navigate to a general area that is associated with the target location, and then use a more-refined location-determination technique to identify and/or navigate to the target location within the general area.

For example, the UAV 200 may navigate to the general area of a target destination where a payload 228 is being delivered using waypoints and/or map-based navigation. The UAV may then switch to a mode in which it utilizes a localization process to locate and travel to a more specific location. For instance, if the UAV 200 is to deliver a payload to a user's home, the UAV 200 may need to be substantially close to the target location in order to avoid delivery of the payload to undesired areas (e.g., onto a roof, into a pool, onto a neighbor's property, etc.). However, a GPS signal may only get the UAV 200 so far (e.g., within a block of the user's home). A more precise location-determination technique may then be used to find the specific target location.

Various types of location-determination techniques may be used to accomplish localization of the target delivery location once the UAV 200 has navigated to the general area of the target delivery location. For instance, the UAV 200 may be equipped with one or more sensory systems, such as, for example, ultrasonic sensors 204, infrared sensors (not shown), and/or other sensors, which may provide input that the navigation module 214 utilizes to navigate autonomously or semi-autonomously to the specific target location.

As another example, once the UAV 200 reaches the general area of the target delivery location (or of a moving subject such as a person or their mobile device), the UAV 200 may switch to a “fly-by-wire” mode where it is controlled, at least in part, by a remote operator, who can navigate the UAV 200 to the specific target location. To this end, sensory data from the UAV 200 may be sent to the remote operator to assist them in navigating the UAV 200 to the specific location.

As yet another example, the UAV 200 may include a module that is able to signal to a passer-by for assistance in either reaching the specific target delivery location; for example, the UAV 200 may display a visual message requesting such assistance in a graphic display, play an audio message or tone through speakers to indicate the need for such assistance, among other possibilities. Such a visual or audio message might indicate that assistance is needed in delivering the UAV 200 to a particular person or a particular location, and might provide information to assist the passer-by in delivering the UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once the UAV 200 arrives at the general area of a target delivery location, the UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, the UAV 200 may be configured to navigate by “sourcing” such directional signals—in other words, by determining where the signal is strongest and navigating accordingly. As another example, a mobile device can emit a frequency, either in the human range or outside the human range, and the UAV 200 can listen for that frequency and navigate accordingly. As a related example, if the UAV 200 is listening for spoken commands, then the UAV 200 could utilize spoken statements, such as “I'm over here!” to source the specific location of the person requesting delivery of a payload.

In an alternative arrangement, a navigation module may be implemented at a remote computing device, which communicates wirelessly with the UAV 200. The remote computing device may receive data indicating the operational state of the UAV 200, sensor data from the UAV 200 that allows it to assess the environmental conditions being experienced by the UAV 200, and/or location information for the UAV 200. Provided with such information, the remote computing device may determine altitudinal and/or directional adjustments that should be made by the UAV 200 and/or may determine how the UAV 200 should adjust its mechanical features (e.g., its rudder(s), elevator(s), aileron(s), and/or the speed of its propeller(s)) in order to effectuate such movements. The remote computing system may then communicate such adjustments to the UAV 200 so it can move in the determined manner.

### C. Communication Systems

In a further aspect, the UAV 200 includes one or more communication systems 218. The communications systems 218 may include one or more wireless interfaces and/or one or more wireline interfaces, which allow the UAV 200 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, a UAV 200 may include communication systems 218 that allow for both short-range communication and long-range communication. For example, the UAV 200 may be configured for short-range communications using Bluetooth and for long-range communications under a CDMA protocol. In such an embodiment, the UAV 200 may be configured to function as a “hot spot;” or in other words, as a gateway or proxy between a remote support device and one or more data networks, such as a cellular network and/or the Internet. Configured as such, the UAV 200 may facilitate data communications that the remote support device would otherwise be unable to perform by itself.

For example, the UAV 200 may provide a WiFi connection to a remote device, and serve as a proxy or gateway to a cellular service provider's data network, which the UAV might connect to under an LTE or a 3G protocol, for instance. The UAV 200 could also serve as a proxy or gateway to a high-altitude balloon network, a satellite network, or a combination of these networks, among others, which a remote device might not be able to otherwise access.

### D. Power Systems

In a further aspect, the UAV 200 may include power system(s) 220. The power system 220 may include one or more batteries for providing power to the UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

In a further aspect, the power systems 220 of UAV 200 a power interface for electronically coupling to an external AC power source, and an AC/DC converter coupled to the power interface and operable to convert alternating current to direct current that charges the UAV's battery or batteries. For instance, the power interface may include a power jack or other electric coupling for connecting to a 110V, 120V, 220V, or 240V AC power source. Such a power system may facilitate a recipient-assisted recharging process, where a recipient can connect the UAV to a standard power source at a delivery location, such as the recipient's home or office. Additionally or alternatively, power systems 220 could include an inductive charging interface, such that recipient-assisted recharging can be accomplished wirelessly via an inductive charging system installed or otherwise available at the delivery location.

### E. Payload Delivery

The UAV 200 may employ various systems and configurations in order to transport and deliver a payload 228. In some implementations, the payload 228 of a given UAV 200 may include or take the form of a “package” designed to transport various goods to a target delivery location. For example, the UAV 200 can include a compartment, in which an item or items may be transported. Such a package may contain one or more food items, purchased goods, medical items, or any other object(s) having a size and weight suitable to be transported between two locations by the UAV. In some embodiments, a payload 228 may simply be the one or more items that are being delivered (e.g., without any package housing the items). And, in some embodiments, the items being delivered, the container or package in which the items are transported, and/or other components may all be considered to be part of the payload.

In some embodiments, the payload 228 may be attached to the UAV and located substantially outside of the UAV during some or all of a flight by the UAV. For example, the package may be tethered or otherwise releasably attached below the UAV during flight to a target location. In an embodiment where a package carries goods below the UAV, the package may include various features that protect its contents from the environment, reduce aerodynamic drag on the system, and prevent the contents of the package from shifting during UAV flight.

For instance, when the payload 228 takes the form of a package for transporting items, the package may include an outer shell constructed of water-resistant cardboard, plastic, or any other lightweight and water-resistant material. Further, in order to reduce drag, the package may feature smooth surfaces with a pointed front that reduces the frontal cross-sectional area. Further, the sides of the package may taper from a wide bottom to a narrow top, which allows the package to serve as a narrow pylon that reduces interference effects on the wing(s) of the UAV. This may move some of the frontal area and volume of the package away from the wing(s) of the UAV, thereby preventing the reduction of lift on the wing(s) caused by the package. Yet further, in some embodiments, the outer shell of the package may be constructed from a single sheet of material in order to reduce air gaps or extra material, both of which may increase drag on the system. Additionally or alternatively, the package may include a stabilizer to dampen package flutter. This reduction in flutter may allow the package to have a less rigid connection to the UAV and may cause the contents of the package to shift less during flight.

In order to deliver the payload, the UAV may include a tether system 221, which may be controlled by the tether control module 216 in order to lower the payload 228 to the ground while the UAV hovers above. The tether system 221 may include a tether, which is couplable to a payload 228 (e.g., a package). The tether may be wound on a spool that is coupled to a motor of the UAV (although passive implementations, without a motor, are also possible). The motor may be a DC motor (e.g., a servo motor) that can be actively controlled by a speed controller, although other motor configurations are possible. In some embodiments, the tether control module 216 can control the speed controller to cause the motor to rotate the spool, thereby unwinding or retracting the tether and lowering or raising the payload coupling apparatus. In practice, a speed controller may output a desired operating rate (e.g., a desired RPM) for the spool, which may correspond to the speed at which the tether system should lower the payload towards the ground. The motor may then rotate the spool so that it maintains the desired operating rate (or within some allowable range of operating rates).

In order to control the motor via a speed controller, the tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as the motor causes rotation of the spool, a rotary encoder may be used to measure this rotation. In doing so, the rotary encoder may be used to convert a rotary position to an analog or digital electronic signal used by the tether control module 216 to determine the amount of rotation of the spool from a fixed reference angle and/or to an analog or digital electronic signal that is representative of a new rotary position, among other options. Other examples are also possible.

In some embodiments, a payload coupling component (e.g., a hook or another type of coupling component) can be configured to secure the payload 228 while being lowered from the UAV by the tether. The coupling apparatus or component and can be further configured to release the payload 228 upon reaching ground level via electrical or electro-mechanical features of the coupling component. The payload coupling component can then be retracted to the UAV by reeling in the tether using the motor.

In some implementations, the payload 228 may be passively released once it is lowered to the ground. For example, a payload coupling component may provide a passive release mechanism, such as one or more swing arms adapted to retract into and extend from a housing. An extended swing arm may form a hook on which the payload 228 may be attached. Upon lowering the release mechanism and the payload 228 to the ground via a tether, a gravitational force as well as a downward inertial force on the release mechanism may cause the payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of the payload 228 no longer forces the swing arm to extend from the housing. Retracting the swing arm into the housing may reduce the likelihood of the release mechanism snagging the payload 228 or other nearby objects when raising the release mechanism toward the UAV upon delivery of the payload 228.

In another implementation, a payload coupling component may include a hook feature that passively releases the payload when the payload contacts the ground. For example, the payload coupling component may take the form of or include a hook feature that is sized and shaped to interact with a corresponding attachment feature (e.g., a handle or hole) on a payload taking the form of a container or tote. The hook may be inserted into the handle or hole of the payload container, such that the weight of the payload keeps the payload container secured to the hook feature during flight. However, the hook feature and payload container may be designed such that when the container contacts the ground and is supported from below, the hook feature slides out of the container's attachment feature, thereby passively releasing the payload container. Other passive release configurations are also possible.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, a UAV 200 could include an air-bag drop system or a parachute drop system. Alternatively, a UAV 200 carrying a payload could simply land on the ground at a delivery location. Other examples are also possible.

In some arrangements, a UAV may not include a tether system 221. For example, a UAV could include an internal compartment or bay in which the UAV could hold items during transport. Such a compartment could be configured as a top-loading, side-loading, and/or bottom-loading chamber. The UAV may include electrical and/or mechanical means (e.g., doors) that allow the interior compartment in the UAV to be opened and closed. Accordingly, the UAV may open the compartment in various circumstances, such as: (a) when picking up an item for delivery at an item source location, such that the item can be placed in the UAV for delivery, (b) upon arriving at a delivery location, such that the recipient can place an item for return into the UAV, and/or (c) in other circumstances. Further, it is also contemplated, that other non-tethered mechanisms for securing payload items to a UAV are also possible, such as various fasteners for securing items to the UAV housing, among other possibilities. Yet further, a UAV may include an internal compartment for transporting items and/or other non-tethered mechanisms for securing payload items, in addition or in the alternative to a tether system 221.

### F. Package Identification Device

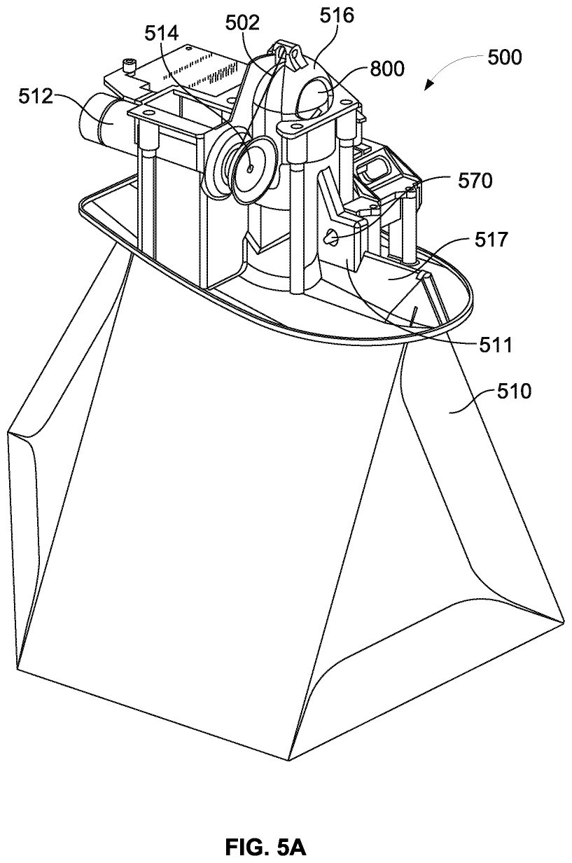

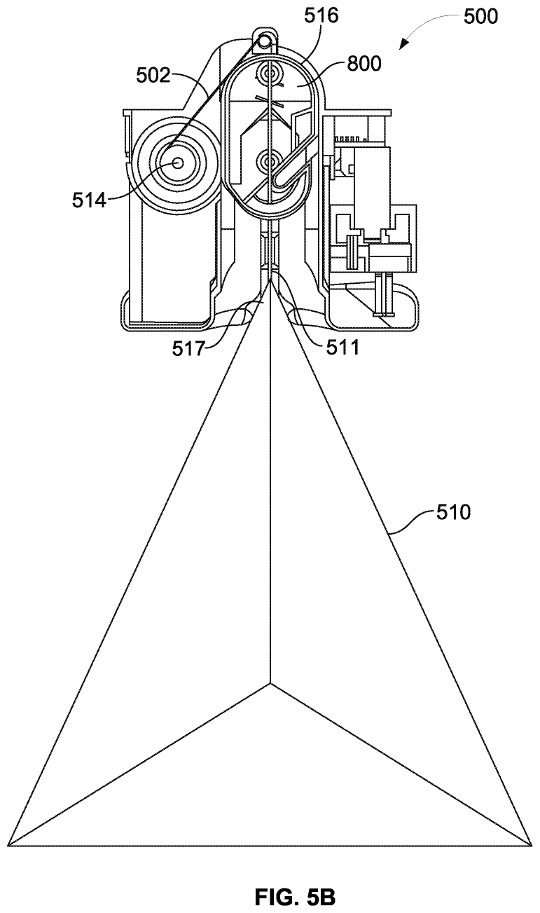

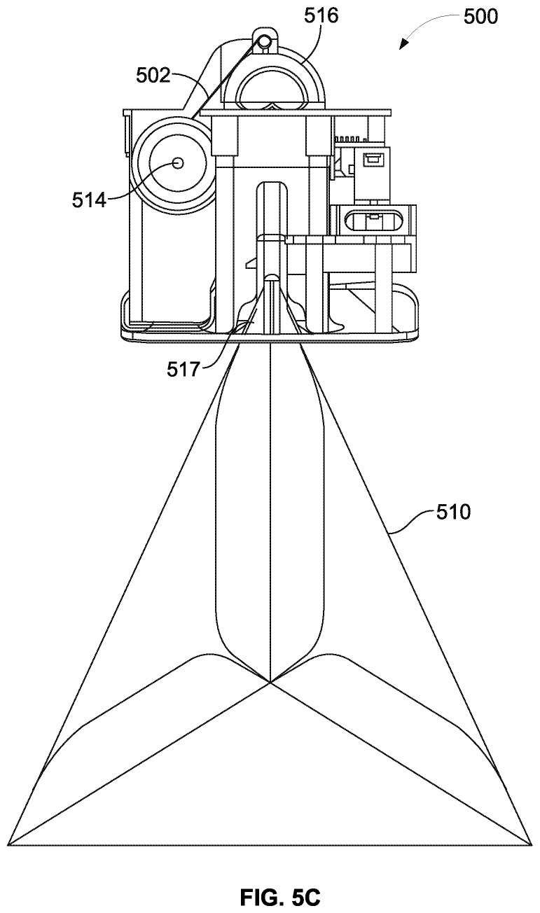

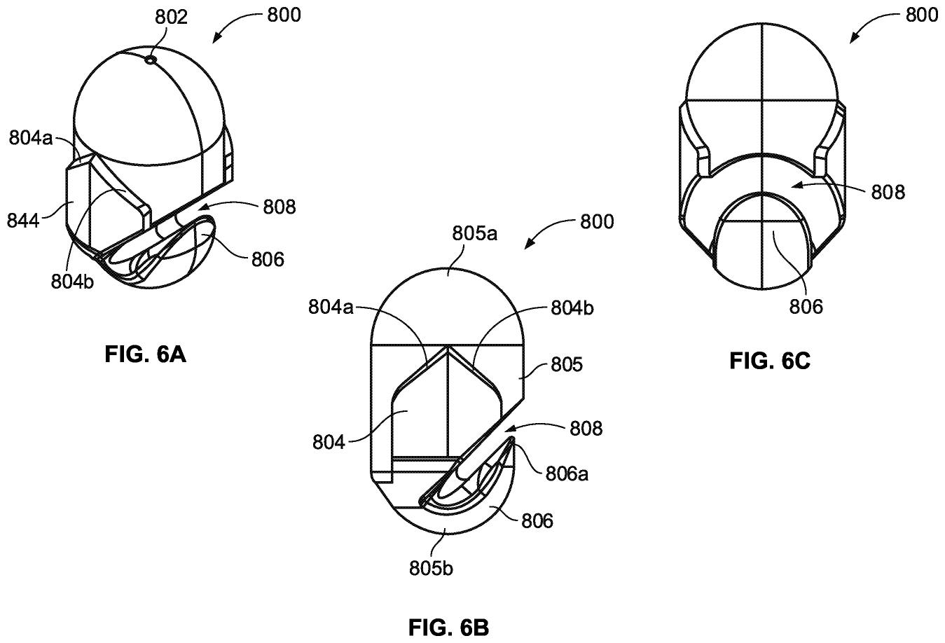

The UAV 200 can include a package identification device 230 that can be used to identify payload 228. Within examples, the package identification device 230 can be arranged on a surface of the UAV 200 that has a direct view of the payload 228. For instance, the package identification device 230 can be arranged on a surface of a payload compartment (see, e.g., compartments 506 and 604 in FIGS. 5 and 6, respectively). Other arrangements are possible.

Within examples, the package identification device 230 can be a sensor or a scanner that employs various technologies to interact with the payload 228 in order to identify the payload 228. For instance, the package identification device 230 can employ one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Additionally and/or alternatively, the package identification device 230 can employ various scanning technologies such as a 1-D or 2-D barcode scanner. Additionally and/or alternatively, the package identification device 230 can employ various image-capturing technologies such as cameras. Additionally and/or alternatively, the package identification device 230 can employ various text recognition software that can read identifying text (e.g., printed or handwritten) on the package.

### IV. Illustrative UAV Deployment Systems

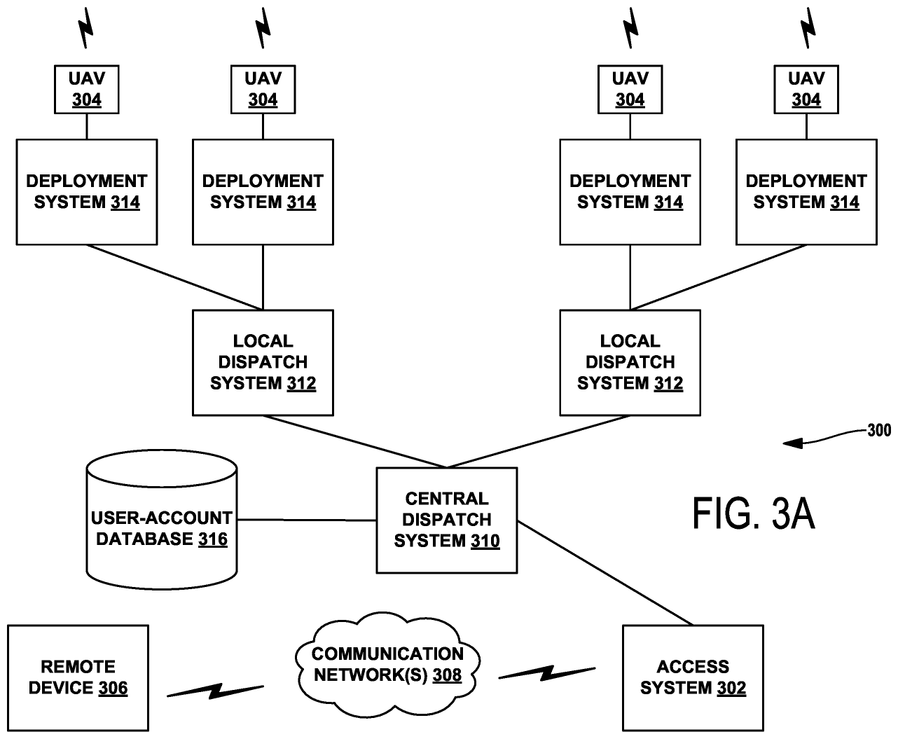

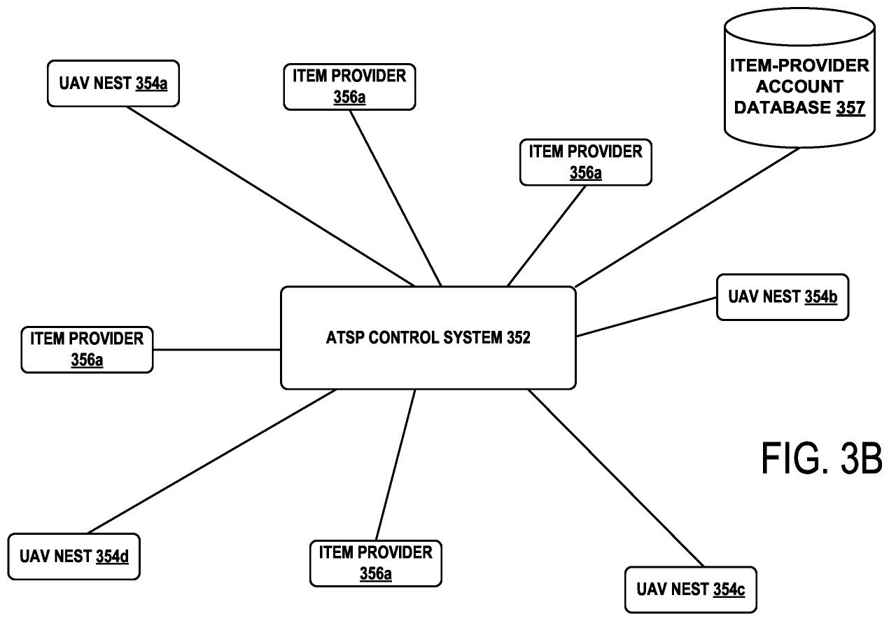

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3A is a simplified block diagram illustrating a distributed UAV system 300, according to an example embodiment.

In the illustrative UAV system 300, an access system 302 may allow for interaction with, control of, and/or utilization of a network of UAVs 304. In some embodiments, an access system 302 may be a computing system that allows for human-controlled dispatch of UAVs 304. As such, the control system may include or otherwise provide a user interface through which a user can access and/or control the UAVs 304.

In some embodiments, dispatch of the UAVs 304 may additionally or alternatively be accomplished via one or more automated processes. For instance, the access system 302 may dispatch one of the UAVs 304 to transport a payload to a target location, and the UAV may autonomously navigate to the target location by utilizing various on-board sensors, such as a GPS receiver and/or other various navigational sensors.

Further, the access system 302 may provide for remote operation of a UAV. For instance, the access system 302 may allow an operator to control the flight of a UAV via its user interface. As a specific example, an operator may use the access system 302 to dispatch a UAV 304 to a target location. The UAV 304 may then autonomously navigate to the general area of the target location. At this point, the operator may use the access system 302 to take control of the UAV 304 and navigate the UAV to the target location (e.g., to a particular person to whom a payload is being transported). Other examples of remote operation of a UAV are also possible.

In an illustrative embodiment, the UAVs 304 may take various forms. For example, each of the UAVs 304 may be a UAV such as those illustrated in FIGS. 1A-1E. However, UAV system 300 may also utilize other types of UAVs without departing from the scope of the invention. In some implementations, all of the UAVs 304 may be of the same or a similar configuration. However, in other implementations, the UAVs 304 may include a number of different types of UAVs. For instance, the UAVs 304 may include a number of types of UAVs, with each type of UAV being configured for a different type or types of payload delivery capabilities.

The UAV system 300 may further include a remote device 306, which may take various forms. Generally, the remote device 306 may be any device through which a direct or indirect request to dispatch a UAV can be made. (Note that an indirect request may involve any communication that may be responded to by dispatching a UAV, such as requesting a package delivery). In an example embodiment, the remote device 306 may be a mobile phone, tablet computer, laptop computer, personal computer, or any network-connected computing device. Further, in some instances, the remote device 306 may not be a computing device. As an example, a standard telephone, which allows for communication via plain old telephone service (POTS), may serve as the remote device 306. Other types of remote devices are also possible.

Further, the remote device 306 may be configured to communicate with access system 302 via one or more types of communication network(s) 308. For example, the remote device 306 may communicate with the access system 302 (or a human operator of the access system 302) by communicating over a POTS network, a cellular network, and/or a data network such as the Internet. Other types of networks may also be utilized.

In some embodiments, the remote device 306 may be configured to allow a user to request delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, the UAV system 300 may receive location information (e.g., GPS coordinates, etc.) from the user's mobile phone, or any other device on the user's person, such that a UAV can navigate to the user's location (as indicated by their mobile phone).

In an illustrative arrangement, the central dispatch system 310 may be a server or group of servers, which is configured to receive dispatch messages requests and/or dispatch instructions from the access system 302. Such dispatch messages may request or instruct the central dispatch system 310 to coordinate the deployment of UAVs to various target locations. The central dispatch system 310 may be further configured to route such requests or instructions to one or more local dispatch systems 312. To provide such functionality, the central dispatch system 310 may communicate with the access system 302 via a data network, such as the Internet or a private network that is established for communications between access systems and automated dispatch systems.

In the illustrated configuration, the central dispatch system 310 may be configured to coordinate the dispatch of UAVs 304 from a number of different local dispatch systems 312. As such, the central dispatch system 310 may keep track of which UAVs 304 are located at which local dispatch systems 312, which UAVs 304 are currently available for deployment, and/or which services or operations each of the UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when the central dispatch system 310 receives a request for UAV-related service (e.g., transport of an item) from the access system 302, the central dispatch system 310 may select a specific UAV 304 to dispatch. The central dispatch system 310 may accordingly instruct the local dispatch system 312 that is associated with the selected UAV to dispatch the selected UAV. The local dispatch system 312 may then operate its associated deployment system 314 to launch the selected UAV. In other cases, the central dispatch system 310 may forward a request for a UAV-related service to a local dispatch system 312 that is near the location where the support is requested and leave the selection of a particular UAV 304 to the local dispatch sy stem 312.

In an example configuration, the local dispatch system 312 may be implemented as a computing system at the same location as the deployment system(s) 314 that it controls. For example, the local dispatch system 312 may be implemented by a computing system installed at a building, such as a warehouse, where the deployment system(s) 314 and UAV(s) 304 that are associated with the particular local dispatch system 312 are also located. In other embodiments, the local dispatch system 312 may be implemented at a location that is remote to its associated deployment system(s) 314 and UAV(s) 304.

Numerous variations on and alternatives to the illustrated configuration of the UAV system 300 are possible. For example, in some embodiments, a user of the remote device 306 could request delivery of a package directly from the central dispatch system 310. To do so, an application may be implemented on the remote device 306 that allows the user to provide information regarding a requested delivery, and generate and send a data message to request that the UAV system 300 provide the delivery. In such an embodiment, the central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to the central dispatch system 310, the local dispatch system(s) 312, the access system 302, and/or the deployment system(s) 314 may be combined in a single system, implemented in a more complex system, and/or redistributed among the central dispatch system 310, the local dispatch system(s) 312, the access system 302, and/or the deployment system(s) 314 in various ways.

Yet further, while each local dispatch system 312 is shown as having two associated deployment systems 314, a given local dispatch system 312 may alternatively have more or fewer associated deployment systems 314. Similarly, while the central dispatch system 310 is shown as being in communication with two local dispatch systems 312, the central dispatch system 310 may alternatively be in communication with more or fewer local dispatch systems 312.

In a further aspect, the deployment systems 314 may take various forms. In general, the deployment systems 314 may take the form of or include systems for physically launching one or more of the UAVs 304. Such launch systems may include features that provide for an automated UAV launch and/or features that allow for a human-assisted UAV launch. Further, the deployment systems 314 may each be configured to launch one particular UAV 304, or to launch multiple UAVs 304.

The deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, the deployment systems 314 and their corresponding UAVs 304 (and possibly associated local dispatch systems 312) may be strategically distributed throughout an area such as a city. For example, the deployment systems 314 may be strategically distributed such that each deployment system 314 is proximate to one or more payload pickup locations (e.g., near a restaurant, store, or warehouse). However, the deployment systems 314 (and possibly the local dispatch systems 312) may be distributed in other ways, depending upon the particular implementation. As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, the UAV system 300 may include or have access to a user-account database 316. The user-account database 316 may include data for a number of user accounts, and which are each associated with one or more persons. For a given user account, the user-account database 316 may include data related to or useful in providing UAV-related services. Typically, the user data associated with each user account is optionally provided by an associated user and/or is collected with the associated user's permission.

Further, in some embodiments, a person may be required to register for a user account with the UAV system 300, if they wish to be provided with UAV-related services by the UAVs 304 from UAV system 300. As such, the user-account database 316 may include authorization information for a given user account (e.g., a username and password), and/or other information that may be used to authorize access to a user account.

In some embodiments, a person may associate one or more of their devices with their user account, such that they can access the services of UAV system 300. For example, when a person uses an associated mobile phone, e.g., to place a call to an operator of the access system 302 or send a message requesting a UAV-related service to a dispatch system, the phone may be identified via a unique device identification number, and the call or message may then be attributed to the associated user account. Other examples are also possible.

### V. UAV Transport Services With Separately Located Item Providers And UAV Hubs

As noted above, an ATSP can be a separate entity from the entity or entities that provide the items being transported and/or interface with the recipients who request delivery of these items. For example, a company that operates a fleet of UAVs configured for item delivery may provide delivery services for third-party entities, such as restaurants, clothing stores, grocery stores, and other “brick and mortar” and/or online retailers, among other possibilities. These third-party entities may have accounts with the UAV transport service provider, via which the third-parties can request and/or purchase UAV transport services from the transport service provider. Further, the third-party entities could interface with recipients (e.g., customers) directly, or through computing systems (e.g., applications and/or server systems) provided by the UAV transport service provider.

FIG. 3B is a block diagram showing an example arrangement for an aerial transport provider control system 352, which coordinates UAV transport services for a plurality of item providers that are located remotely from the service provider's dispatch locations, and served by a plurality of UAV hubs at various locations. As shown, an aerial transport service provider (ATSP) 402 may be communicatively coupled to UAV nests 354a to 354d, and communicatively coupled to item-provider computing systems 356a to 356d. Such communicative couplings may be implemented using various types of wired and/or wireless communication protocols and networks.

Each UAV nest 354a to 354d is a facility where UAVs can be stored for at least a short period of time, and from which UAVs can begin carrying out a UAV delivery mission (e.g., where UAVs can take off). In some implementations, some or all of UAV nests 354a to 354d may take the form of a local dispatch system and one or more deployment systems, such as those described in reference to FIG. 3A above. Of course, some or all UAV nests 354a to 354d could also take other forms and/or perform different functions.

Each item-provider computing system 356a to 356d may be associated with a different item-provider account. As such, a given item-provider computing system 356a to 356d may include one or more computing devices that are authorized to access the corresponding item-provider account with ATSP 352. Further, ATSP 352 may store data for item-provider accounts in an item-provider account database 357.

In practice, a given item-provider computing system 356a to 356d may include one or more remote computing devices (e.g., such as one or more remote devices 306 described in reference to FIG. 3A), which have logged in to or otherwise been authorized to access the same item-provider account (e.g., cell phones, laptops, and/or computing devices of a business's employees). Additionally or alternatively, an item-provider computing system 356a to 356d may be implemented with less of an ad-hoc approach; e.g., with one or more dedicated user-interface terminals installed at the item provider's facilities. Other types of item-provider computing systems are also possible.

In order to provide UAV transport services to various item providers in an efficient and flexible manner, a UAV transport service provider 352 may dynamically assign different UAVs to delivery missions for different item providers based on demand and/or other factors, rather than permanently assigning each UAV to a particular item provider. As such, the particular UAV or UAVs that carry out delivery missions for a given third-party item provider may vary over time.

The dynamic assignment of UAVs to flights for a number of different item providers can help a UAV transport service provider to more efficiently utilize a group of UAVs (e.g., by reducing unnecessary UAV downtime), as compared to an arrangement where specific UAVs are permanently assigned to specific item providers. More specifically, to dynamically assign UAVs to transport requests from third-party item providers, the UAV transport service provider 352 can dynamically redistribute UAVs amongst a number of UAV deployment locations (which may be referred to as, e.g., “hubs” or “nests”) through a service area, according to time-varying levels of demand at various locations or sub-areas within the service area.

With such an arrangement, a delivery flight may involve the additional flight leg to fly from the UAV hub to the item-provider's location to pick up the item or items for transport, before flying to the delivery location, as compared to an arrangement where delivery UAVs are stationed at the source location for items (such as a distributor or retailer warehouse or a restaurant). While the flight leg between the UAV hub and a loading location has associated costs, these costs can be offset by more efficient use of each UAV (e.g., more flights, and less unnecessary ground time, in a given period of time), which in turn can allow for a lesser number of UAVs to be utilized for a given number of delivery missions.

### VI. Illustrative Payload Retrieval and Delivery

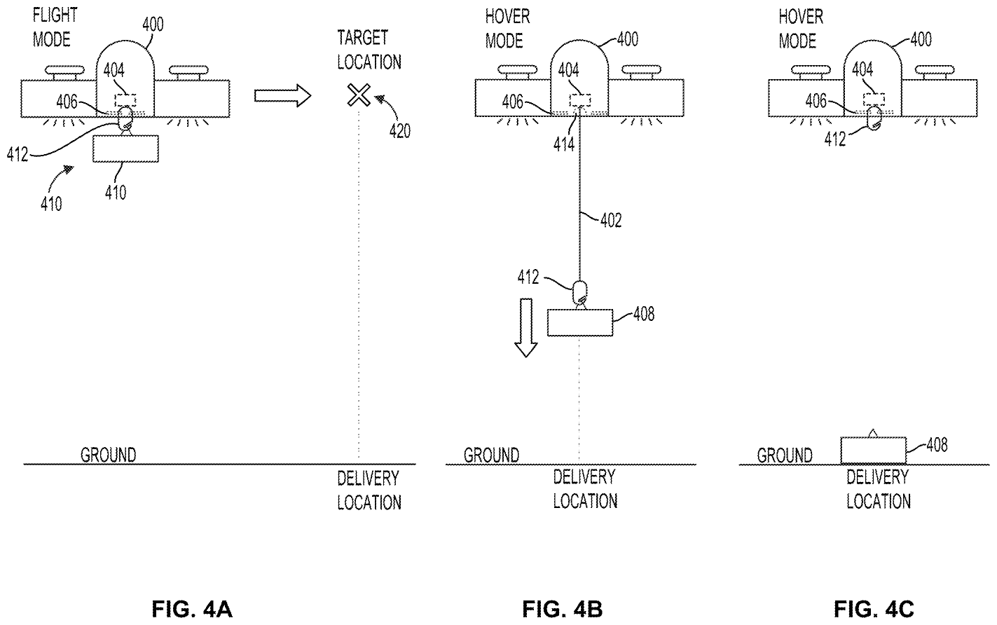

FIGS. 4A, 4B, and 4C show a UAV 400 that includes a payload delivery system 410 (could also be referred to as a payload delivery apparatus), according to an example embodiment. As shown, payload delivery system 410 for UAV 400 includes a tether 402 coupled to a spool 404, a payload latch 406, and a payload 408 coupled to the tether 402 via a payload coupling apparatus 412. The payload latch 406 can function to alternately secure payload 408 and release the payload 408 upon delivery. For instance, as shown, the payload latch 406 may take the form of one or more pins that can engage the payload coupling apparatus 412 (e.g., by sliding into one or more receiving slots in the payload coupling apparatus 412). Inserting the pins of the payload latch 406 into the payload coupling apparatus 412 may secure the payload coupling apparatus 412 within a receptacle 414 on the underside of the UAV 400, thereby preventing the payload 408 from being lowered from the UAV 400. In some embodiments, the payload latch 406 may be arranged to engage the spool 404 or the payload 408 rather than the payload coupling apparatus 412 in order to prevent the payload 408 from lowering. In other embodiments, the UAV 400 may not include the payload latch 406, and the payload delivery apparatus may be coupled directly to the UAV 400.

In some embodiments, the spool 404 can function to unwind the tether 402 such that the payload 408 can be lowered to the ground with the tether 402 and the payload coupling apparatus 412 from UAV 400. The payload 408 may itself be an item for delivery, and may be housed within (or otherwise incorporate) a parcel, container, or other structure that is configured to interface with the payload latch 406. In practice, the payload delivery system 410 of UAV 400 may function to autonomously lower payload 408 to the ground in a controlled manner to facilitate delivery of the payload 408 on the ground while the UAV 400 hovers above.

As shown in FIG. 4A, the payload latch 406 may be in a closed position (e.g., pins engaging the payload coupling apparatus 412) to hold the payload 408 against or close to the bottom of the UAV 400, or even partially or completely inside the UAV 400, during flight from a launch site to a target location 420. The target location 420 may be a point in space directly above a desired delivery location. Then, when the UAV 400 reaches the target location 420, the UAV's control system (e.g., the tether control module 216 of FIG. 2) may toggle the payload latch 406 to an open position (e.g., disengaging the pins from the payload coupling apparatus 412), thereby allowing the payload 408 to be lowered from the UAV 400. The control system may further operate the spool 404 (e.g., by controlling a motor of the tether system 221 of FIG. 2) such that the payload 408, secured to the tether 402 by a payload coupling apparatus 412, is lowered to the ground, as shown in FIG. 4B.

Once the payload 408 reaches the ground, the control system may continue operating the spool 404 to lower the tether 402, causing over-run of the tether 402. During over-run of the tether 402, the payload coupling apparatus 412 may continue to lower as the payload 408 remains stationary on the ground. The downward momentum and/or gravitational forces on the payload coupling apparatus 412 may cause the payload 408 to detach from the payload coupling apparatus 412 (e.g., by sliding off a hook of the payload coupling apparatus 412). After releasing payload 408, the control system may operate the spool 404 to retract the tether 402 and the payload coupling apparatus 412 toward the UAV 400. Once the payload coupling apparatus reaches or nears the UAV 400, the control system may operate the spool 404 to pull the payload coupling apparatus 412 into the receptacle 414, and the control system may toggle the payload latch 406 to the closed position, as shown in FIG. 4C.

In some embodiments, when lowering the payload 408 from the UAV 400, the control system may detect when the payload 408 and/or the payload coupling apparatus 412 has been lowered to be at or near the ground based on an unwound length of the tether 402 from the spool 404. Similar techniques may be used to determine when the payload coupling apparatus 412 is at or near the UAV 400 when retracting the tether 402. As noted above, the UAV 400 may include an encoder for providing data indicative of the rotation of the spool 404. Based on data from the encoder, the control system may determine how many rotations the spool 404 has undergone and, based on the number of rotations, determine a length of the tether 402 that is unwound from the spool 404. For instance, the control system may determine an unwound length of the tether 402 by multiplying the number of rotations of the spool 404 by the circumference of the tether 402 wrapped around the spool 404. In some embodiments, such as when the spool 404 is narrow or when the tether 402 has a large diameter, the circumference of the tether 402 on the spool 404 may vary as the tether 402 winds or unwinds from the tether, and so the control system may be configured to account for these variations when determining the unwound tether length.

In other embodiments, the control system may use various types of data, and various techniques, to determine when the payload 408 and/or payload coupling apparatus 412 have lowered to be at or near the ground. Further, the data that is used to determine when the payload 408 is at or near the ground may be provided by sensors on UAV 400, sensors on the payload coupling apparatus 412, and/or other data sources that provide data to the control system.

In some embodiments, the control system itself may be situated on the payload coupling apparatus 412 and/or on the UAV 400. For example, the payload coupling apparatus 412 may include logic module(s) implemented via hardware, software, and/or firmware that cause the UAV 400 to function as described herein, and the UAV 400 may include logic module(s) that communicate with the payload coupling apparatus 412 to cause the UAV 400 to perform functions described herein.

FIG. 5A shows a perspective view of a payload delivery apparatus 500 including payload 510, according to an example embodiment. The payload delivery apparatus 500 is positioned within a fuselage of a UAV (not shown) and includes a winch 514 powered by motor 512, and a tether 502 spooled onto winch 514. The tether 502 is attached to a payload coupling apparatus or payload retriever 800 positioned within a payload coupling apparatus receptacle 516 positioned within the fuselage of the UAV (not shown). A payload 510 is secured to the payload coupling apparatus 800. In this embodiment a top portion 517 of payload 510 is secured within the fuselage of the UAV. A locking pin 570 is shown extending through handle 511 attached to payload 510 to positively secure the payload beneath the UAV during high speed flight.

FIG. 5B is a cross-sectional side view of payload delivery apparatus 500 and payload 510 shown in FIG. 5A. In this view, the payload coupling apparatus is shown tightly positioned with the payload coupling apparatus receptacle 516. Tether 502 extends from winch 514 and is attached to the top of payload coupling apparatus 800. Top portion 517 of payload 510 is shown positioned within the fuselage of the UAV (not shown) along with handle 511.

FIG. 5C is a side view of payload delivery apparatus 500 and payload 510 shown in FIGS. 5A and 5B. The top portion 517 of payload 510 is shown positioned within the fuselage of the UAV. Winch 514 has been used to wind in tether 502 to position the payload coupling apparatus within payload coupling apparatus receptacle 516. FIGS. 5A-C disclose payload 510 taking the shape of an aerodynamic hexagonally-shaped tote, where the base and side walls are six-sided hexagons and the tote includes generally pointed front and rear surfaces formed at the intersections of the side walls and base of the tote providing an aerodynamic shape.

FIG. 6A is a perspective view of payload coupling apparatus 800, according to an example embodiment. Payload coupling apparatus 800 includes tether mounting point 802, and a slot 808 to position a handle of a payload handle in. Lower lip, or hook, 806 is positioned beneath slot 808. Also included is an outer protrusion 804 having helical cam surfaces 804a and 804b that are adapted to mate with corresponding cam mating surfaces within a payload coupling apparatus receptacle positioned with a fuselage of a UAV.

FIG. 6B is a side view of payload coupling apparatus 800 shown in FIG. 6A. Slot 808 is shown positioned above lower lip, or hook, 806. As shown lower lip or hook 806 has an outer surface 806a that is undercut such that it does not extend as far outwardly as an outer surface above slot 805 so that the lower lip or hook 806 will not reengage with the handle of the payload after it has been decoupled, or will not get engaged with power lines or tree branches during retrieval to the UAV.

FIG. 6C is a front view of payload coupling apparatus 800 shown in FIGS. 6A and 6B. Lower lip or hook 806 is shown positioned beneath slot 808 that is adapted for securing a handle of a payload.

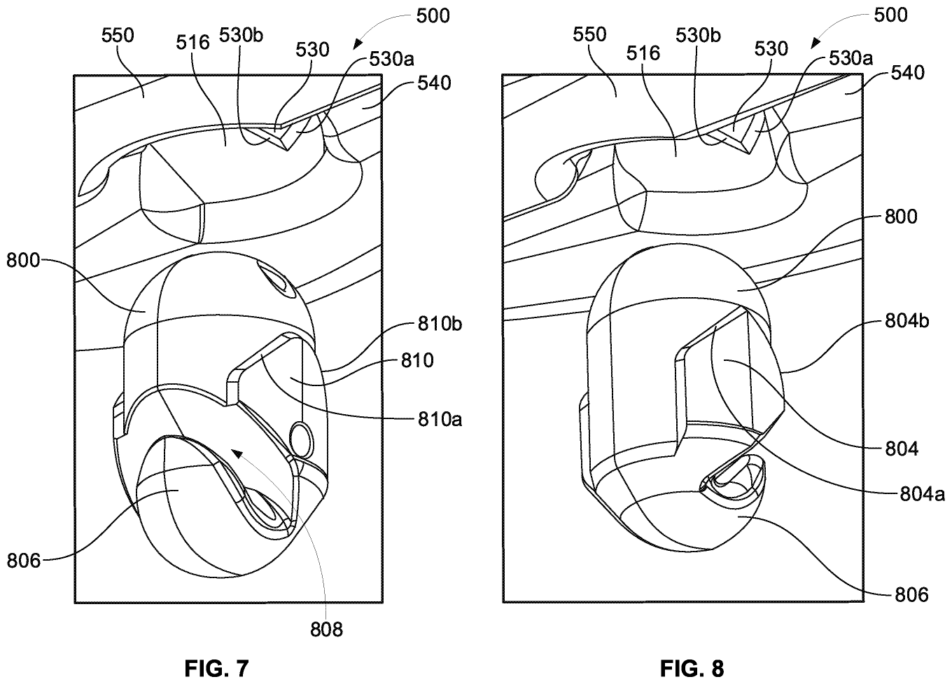

FIG. 7 is a perspective view of payload coupling apparatus 800 shown in FIGS. 6A-6C, prior to insertion into a payload coupling apparatus receptacle 516 positioned in the fuselage 550 of a UAV. As noted previously, payload coupling apparatus 800 includes a slot 808 positioned above lower lip or hook 806, adapted to receive a handle of a payload. The fuselage 550 of the payload delivery system 500 includes a payload coupling apparatus receptacle 516 positioned within the fuselage 550 of the UAV. The payload coupling apparatus 800 includes an outer protrusion 810 have helical cammed surfaces 810a and 810b that meet in a rounded apex. The helical cammed surfaces 810a and 810b are adapted to mate with surfaces 530a and 530b of an inward protrusion 530 positioned within the payload coupling apparatus receptacle 516 positioned within fuselage 550 of the UAV. Also included is a longitudinal recessed restraint slot 540 positioned within the fuselage 550 of the UAV that is adapted to receive and restrain a top portion of a payload (not shown). As the payload coupling apparatus 800 is pulled into to the payload coupling apparatus receptacle 516, the cammed surfaces 810a and 810b of outer protrusion 810 engage with the cammed surfaces 530a and 530b within the payload coupling apparatus receptacle 516 and the payload coupling apparatus 800 is rotated into a desired alignment within the fuselage 550 of the UAV.

FIG. 8 is another perspective view of an opposite side of payload coupling apparatus 800 shown in FIGS. 6A-6C, prior to insertion into a payload coupling apparatus receptacle 516 positioned in the fuselage 550 of a UAV. As shown, payload coupling apparatus 800 include a lower lip or hook 806. An outer protrusion 804 is shown extending outwardly from the payload coupling apparatus having helical cammed surfaces 804a and 804b adapted to engage and mate with cammed surfaces 530a and 530b of inner protrusion 530 positioned within payload coupling apparatus receptacle 516 positioned within fuselage 550 of payload delivery system 500. It should be noted that the cammed surfaces 804a and 804b meet at a sharp apex, which is asymmetrical with the rounded or blunt apex of cammed surfaces 810a and 810b shown in FIG. 7. In this manner, the rounded or blunt apex of cammed surfaces 810a and 810b prevent possible jamming of the payload coupling apparatus 800 as the cammed surfaces engage the cammed surfaces 530a and 530b positioned within the payload coupling apparatus receptacle 516 positioned within fuselage 550 of the UAV. In particular, cammed surfaces 804a and 804b are positioned slightly higher than the rounded or blunt apex of cammed surfaces 810a and 810b. As a result, the sharper tip of cammed surfaces 804a and 804b engages the cammed surfaces 530a and 530b within the payload coupling apparatus receptacle 516 positioned within the fuselage 550 of payload delivery system 500, thereby initiating rotation of the payload coupling apparatus 800 slightly before the rounded or blunt apex of cammed surfaces 810a and 810b engage the corresponding cammed surfaces within the payload coupling apparatus receptacle 516. In this manner, the case where both apexes (or tips) of the cammed surfaces on the payload coupling apparatus end up on the same side of the receiving cams within the payload coupling apparatus receptacle is prevented. This scenario results in a prevention of the jamming of the payload coupling apparatus within the receptacle.

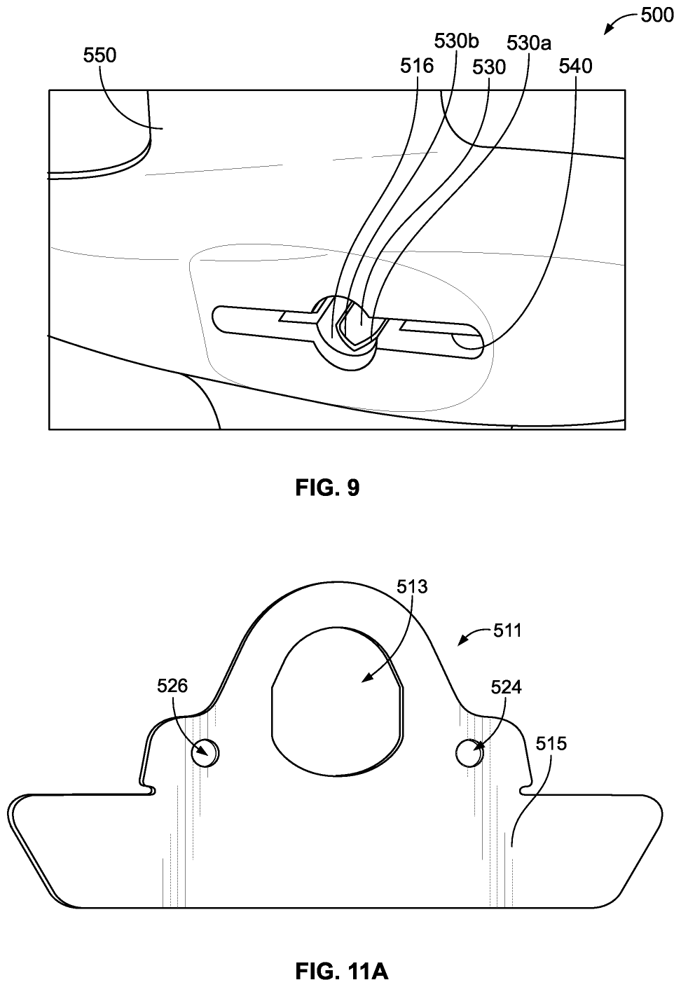

FIG. 9 shows a perspective view of a recessed restraint slot and payload coupling apparatus receptacle positioned in a fuselage of a UAV. In particular, payload delivery system 500 includes a fuselage 550 having a payload coupling apparatus receptacle 516 therein that includes inward protrusion 530 having cammed surfaces 530a and 530b that are adapted to mate with corresponding cammed surfaces on a payload coupling apparatus (not shown). Also included is a longitudinally extending recessed restrained slot 540 into which a top portion of a payload is adapted to be positioned and secured within the fuselage 550.

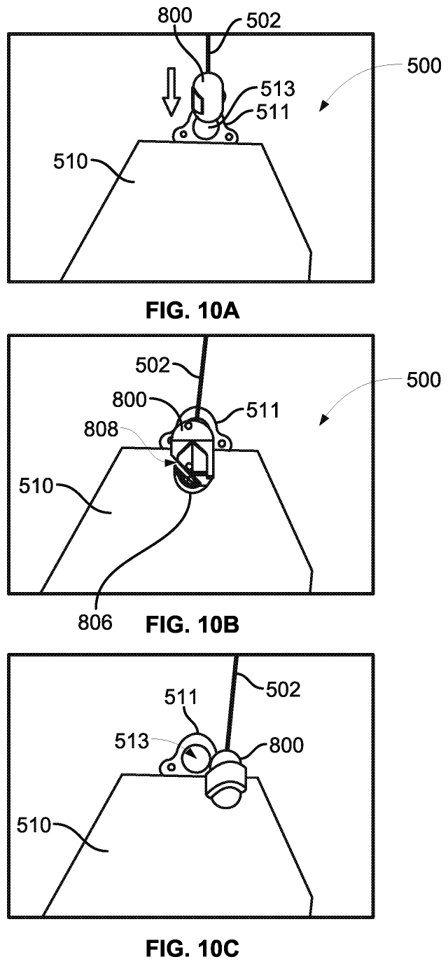

FIG. 10A shows a side view of a payload delivery apparatus 500 with a handle 511 of payload 510 secured within a payload coupling apparatus 800 as the payload 510 moves downwardly prior to touching down for delivery. Prior to payload touchdown, the handle 511 of payload 510 includes a hole 513 through which a lower lip or hook of payload coupling apparatus 800 extends. The handle sits within a slot of the payload coupling apparatus 800 that is suspended from tether 502 of payload delivery system 500 during descent of the payload 510 to a landing site.

FIG. 10B shows a side view of payload delivery apparatus 500 after payload 510 has landed on the ground showing payload coupling apparatus 800 decoupled from handle 511 of payload 510. Once the payload 510 touches the ground, the payload coupling apparatus 800 continues to move downwardly (as the winch further unwinds) through inertia or gravity and decouples the lower lip or hook 808 of the payload coupling apparatus 800 from handle 511 of payload 510. The payload coupling apparatus 800 remains suspended from tether 502, and can be winched back up to the payload coupling receptacle of the UAV.

FIG. 10C shows a side view of payload delivery apparatus 500 with payload coupling apparatus 800 moving away from handle 511 of payload 510. Here the payload coupling apparatus 800 is completely separated from the hole 513 of handle 511 of payload 510. Tether 502 may be used to winch the payload coupling apparatus back to the payload coupling apparatus receptacle positioned in the fuselage of the UAV.

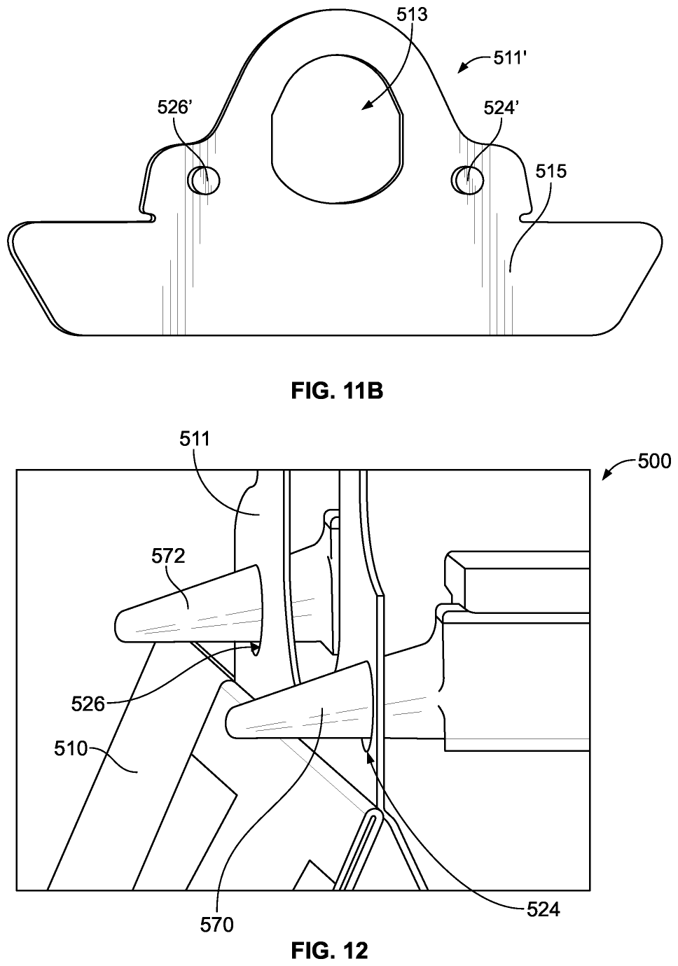

FIG. 11A is a side view of handle 511 of payload 510. The handle 511 includes an aperture 513 through which the lower lip or hook of a payload coupling apparatus extends through to suspend the payload during delivery, or for retrieval. The handle 511 includes a lower portion 515 that is secured to the top portion of a payload. Also included are holes 524 and 526 through which locking pins positioned within the fuselage of a UAV, may extend to secure the handle and payload in a secure position during high speed forward flight to a delivery location. In addition, holes 524 and 526 are also designed for pins of a payload holder to extend therethrough to hold the payload in position for retrieval on a payload retrieval apparatus. The handle may be comprised of a thin, flexible plastic material that is flexible and provides sufficient strength to suspend the payload beneath a UAV during forward flight to a delivery site, and during delivery and/or retrieval of a payload. In practice, the handle may be bent to position the handle within a slot of a payload coupling apparatus. The handle 511 also has sufficient strength to withstand the torque during rotation of the payload coupling apparatus into the desired orientation within the payload coupling apparatus receptacle, and rotation of the top portion of the payload into position with the recessed restraint slot.

FIG. 11B is a side view of handle 511′ of payload 510. The handle 511′ includes an aperture 513 through which the lower lip or hook of a payload coupling apparatus extends through to suspend the payload during delivery, or for retrieval. The handle 511′ includes a lower portion 515 that is secured to the top portion of a payload. Also included are magnets 524′ and 526′ adapted for magnetic engagement with corresponding magnets (or a metal) of a payload holder to secure the payload to the payload holder in position for retrieval on a payload retrieval apparatus. In some examples, magnets 524′ and 526′ are provided on a handle (e.g., handle 511 or 511′) in place of holes 524 and 526. In other examples, magnets 524′ and 526′ are provided in addition to holes 524 and 526.

FIG. 12 shows a pair of pins 570, 572 extending through holes 524 and 526 in handle 511 of payload 510 to secure the handle 511 and top portion of payload 510 within the fuselage of a UAV, or to secure payload 510 to a payload holder of a payload retrieval apparatus. In this manner, the handle 511 and payload 510 may be secured within the fuselage of a UAV, or to a payload holder of a payload retrieval apparatus. In this embodiment, the pins 570 and 572 have a conical shape so that they pull the package up slightly or at least remove any downward slack present. In some embodiments the pins 570 and 572 may completely plug the holes 524 and 526 of the handle 511 of payload 510, to provide a secure attachment of the handle and top portion of the payload within the fuselage of the UAV, or to secure the payload to a payload retrieval apparatus. Although the pins are shown as conical, in other applications they may have other geometries, such as a cylindrical geometry.

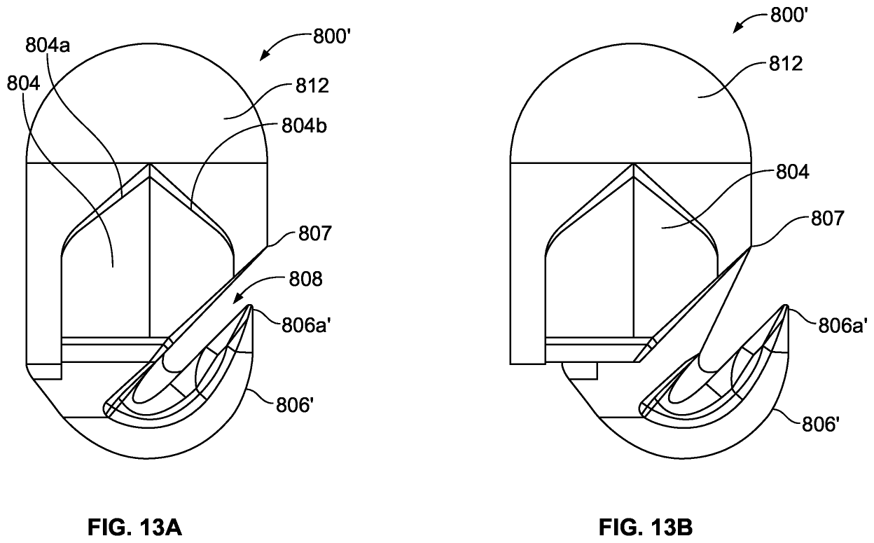

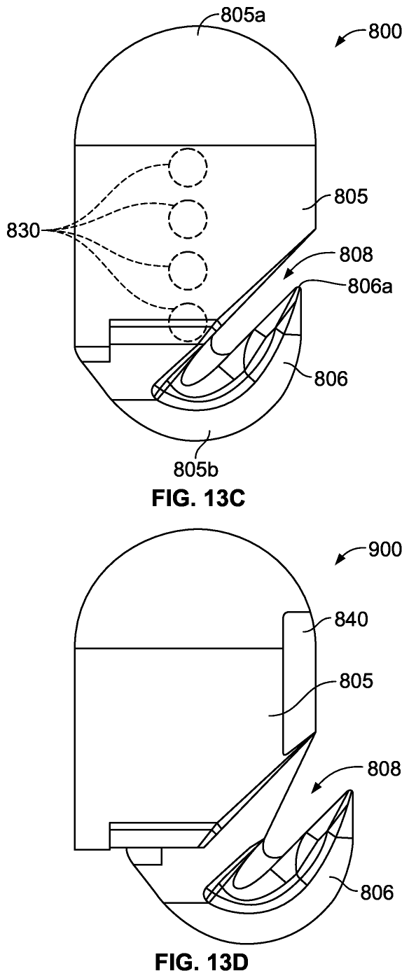

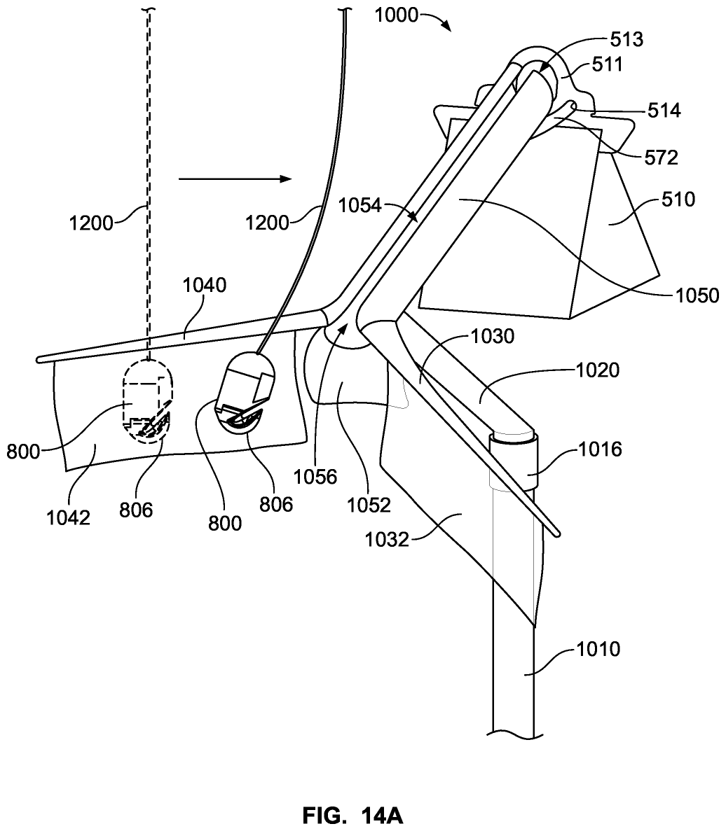

FIGS. 13A and 13B show various views of payload coupling apparatus or payload retriever 800′ which is a variation of payload coupling apparatus 800 described above. Payload coupling apparatus 800′ includes the same exterior features as payload coupling apparatus 800. However, in payload coupling apparatus 800′, lower lip or hook 806′ is extendable and retractable. As shown in FIG. 13A, payload coupling 800′ is in a retracted state where end 806a′ of lip or hook 806′ is positioned inwardly from outer wall 807 of capsule housing 805. In FIG. 13B, payload coupling apparatus 800′ is in an extended state where end 806a′ of lip or hook 806′ has been moved outwardly from capsule housing 805 such that the end 806a of the lip or hook 806′ is positioned outwardly from outer wall 807 of capsule housing 805. Lip of hook 806′ may be moved outwardly via cams or protrusions within channel 1050, or by a spring-loaded portion of channel 1050, or other mechanisms. In the extended state shown in FIG. 13B, the hook or lip 806′ is in position to easily extend through the aperture 513 in handle 511 of payload 510, such that the handle 511 is positioned within slot 808 of payload coupling apparatus 800′ and retrieval of the payload and removal from the payload holder of the payload retrieval apparatus can be achieved. Once the payload 510 is removed from the payload holder the hook or lip 806′ may be moved back to its retracted state as shown in FIG. 13A.

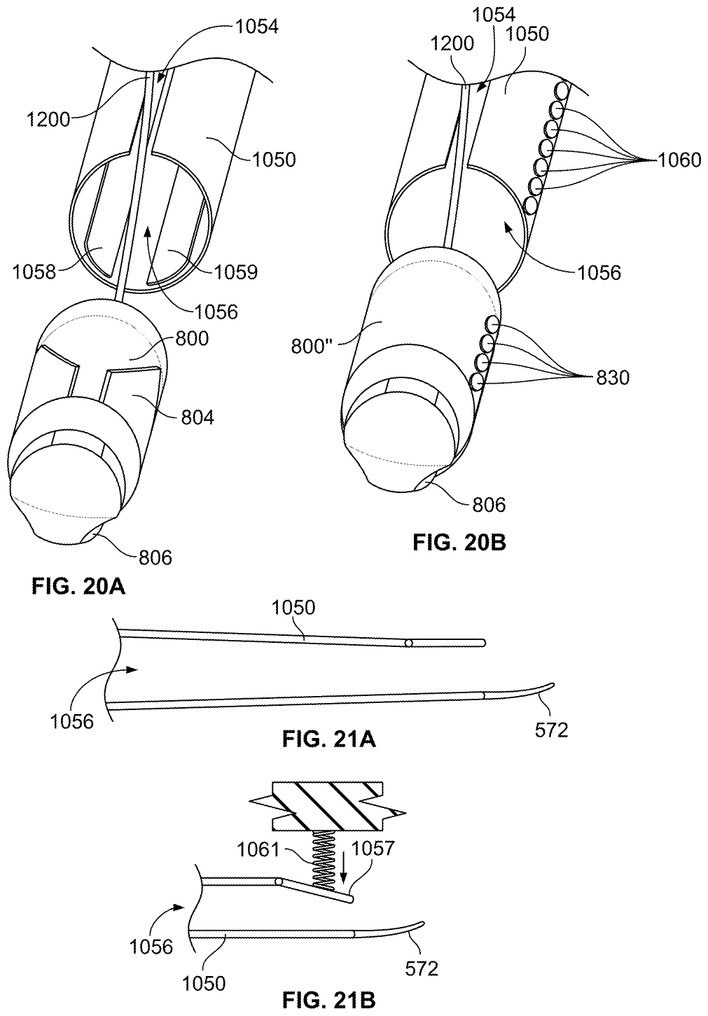

FIG. 13C is a side view of payload coupling apparatus 800″ which in this illustrative embodiment is similar to payload coupling apparatus 800 shown in FIGS. 6A-6C, but instead includes a plurality of magnets 830 positioned thereon. The plurality of magnets 830 are adapted to magnetically engage a plurality of magnets 1060 (or a metal) positioned within the channel 1050 of a payload retrieval apparatus 1000 as shown in FIG. 20 below to orient the payload coupling apparatus 800″ within the channel 1050 of payload retrieval apparatus 1000 so that the hook or lip 806a is in proper position to extend through aperture 513 of handle 511 of payload 510 to effect removal of payload 510 from the payload holder of payload retrieval apparatus 1000.

FIG. 13D is a side view of payload coupling apparatus 900 which in this illustrative embodiment is similar to payload coupling apparatus 800″ shown in FIG. 6C, but instead includes a weighted side 840. The weighted side 840 serves to orient the payload coupling apparatus 900 within the channel 1050 of payload retrieval apparatus 1000 so that the hook or lip 806a is in proper position to extend through aperture 513 of handle 511 of payload 510 to effect removal of payload 510 from the payload holder of payload retrieval apparatus 1000.

In each of the payload coupling apparatuses 800, 800′, 800″, and 900 described above, the upper and lower ends are rounded, or hemispherically shaped, to prevent the payload coupling apparatus from snagging during descent from, or retrieval to, the fuselage of a UAV. Furthermore, each of payload coupling apparatuses 800, 800″, and 900 may have a retractable and extendable hook or lip as is shown in FIGS. 13A and 13B with regard to payload coupling apparatus 800′.

In addition, as illustrated in FIG. 9, the payload delivery system may automatically align the top portion of the payload during winch up, orienting it for minimum drag along the aircraft's longitudinal axis. This alignment enables high speed forward flight after pick up. The alignment is accomplished through the shape of the payload hook and receptacle. In the payload coupling apparatus 800, the lower lip or hook 806 has cam features around its perimeter which always orient it in a defined direction when it engages into the cam features inside the receptacle of the fuselage of the UAV. The tips of the cam shapes on both sides of the capsule are asymmetric to prevent jamming in the 90 degree orientation. In this regard, helical cam surfaces may meet at an apex on one side of the payload coupling mechanism, and helical cam surfaces may meet at a rounded apex on the other side of the payload coupling mechanism. The hook is specifically designed so that the package hangs in the centerline of the hook, enabling alignment in both directions from 90 degrees.

Payload coupling apparatuses 800, 800′, 800″, and 900 include a hook 806 (or 806′) formed beneath a slot 808 such that the hook also releases the payload passively and automatically when the payload touches the ground upon delivery. This is accomplished through the shape and angle of the hook slot and the corresponding handle on the payload. The hook slides off the handle easily when the payload touches down due to the mass of the capsule and also the inertia wanting to continue moving the capsule downward past the payload. The end of the hook is designed to be recessed slightly from the body of the capsule, which prevents the hook from accidentally re-attaching to the handle. After successful release, the hook gets winched back up into the aircraft.

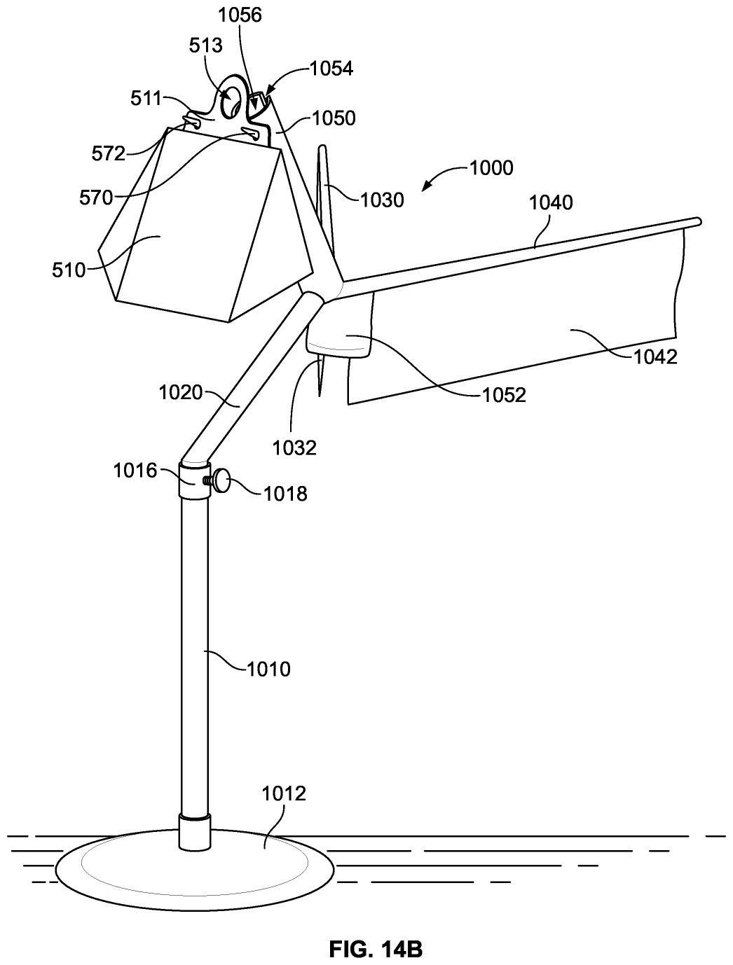

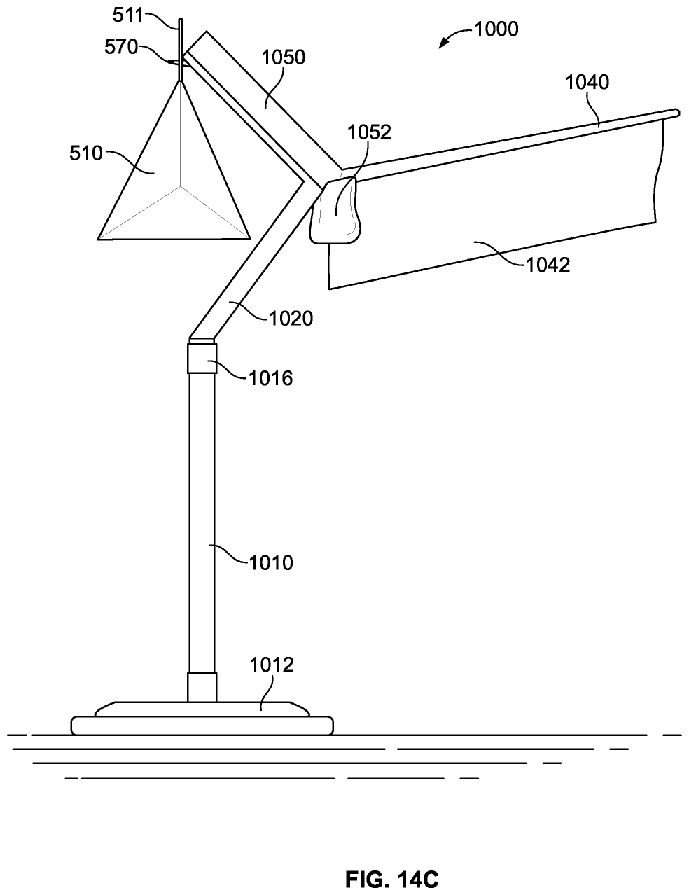

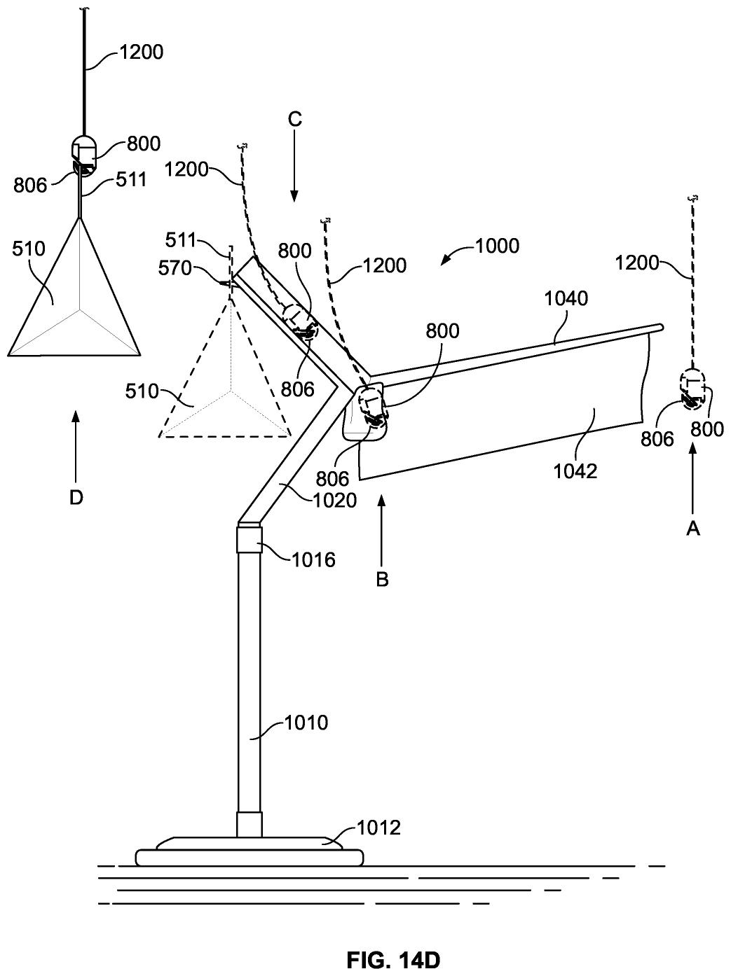

FIGS. 14A-14C are perspective views of payload retrieval apparatus 1000 having a payload 510 positioned thereon, according to an example embodiment. The payload retrieval apparatus 1000 may be a non-permanent structure placed at a payload retrieval site. The apparatus includes an extending member 1010 that may be secured to a base or stand 1012 at a lower end of the extending member 1010. Alternatively, the extending member 1010 may have a lower end that may be positioned within a corresponding hole in the ground or hole in an apparatus positioned on the ground. The payload retrieval apparatus 1000 may be readily folded up, like an umbrella stand, to provide for ease of transport. In addition, because of its non-permanent configuration, payload retrieval apparatus 1000 may not require any type permitting, which may not be the case for a permanent device used for UAV loading and unloading.

An angled extender 1020 may be attached at an upper end of the extending member 1010, and adapter 1016 may be used to adjust the height or angle of the angled extender 1020, and having a threaded set screw with knob 1018 to set the angled extender 1020 into a desired position. The angled extender 1020 is shown with an upper end secured to a channel 1050. A first end of the channel may have a first extension or tether engager 1040 that extends in a first direction from a lower end of the channel 1050 and a second extension or tether engager 1030 that extends in a second direction from the lower end of the channel 1050. A second end of the channel 1050 may have a payload holder 570, 572 positioned near or thereon that is adapted to secure a payload 510 to the second end of the channel 1050.

A shield 1042 is shown extending from the first tether engager 1040, and another shield 1032 is shown extending from the second tether engager 1030. Shield 1042 and 1032 may be made of a fabric material, or other material such as rubber or plastic. A shield 1052 is also shown extending from the first end of channel 1050. Shields 1042, 1032, and 1052 serve to prevent a payload retriever 800 extending from an end of a tether 1200 attached to a UAV from wrapping around the tether engagers 1040 and 1030 or other components of payload retrieval apparatus 1000 when the payload retriever comes into contact with tether engagers 1040 or 1030 during a payload retrieval operation.

Channel 1050 includes a tether slot 1054 extending from a first end to a second end of the channel 1050, and the tether slot 1054 allows for a payload retriever to be positioned within the channel 1050 attached to a tether which extends through the tether slot 1054. A payload holder is shown that is a pair of pins 570, 572 that extend through openings in handle 511 of payload 510 to suspend payload 510 in position adjacent the second end of the channel 1050 ready to be retrieved by a payload retriever attached to a tether suspended from a UAV.

To provide for automatic retrieval of payload 510 with a payload retriever suspended from a UAV with a tether, payload 510 is secured to the payload holder 570, 572 on the second end of the channel 1050 at the payload retrieval site. A UAV arrives at the payload retrieval site with a tether 1200 extending downwardly from the UAV and with the payload retriever 800 positioned on the end of the tether, as shown in FIGS. 14A and 14D. The UAV approaches the payload retrieval apparatus 1000, and as it nears the payload retrieval apparatus 1000, the tether 1200 comes into contact with the first or second extension (tether engager) 1040, 1030. As the UAV moves forward, or the UAV is moved upwardly, or the payload retriever is winched upwardly to the UAV while the UAV is hovering in place (or any combination thereof), the tether slides inwardly along the first or second extension 1040, 1030 where it is directed towards the first end of the channel 1050. With further forward or upward movement of the UAV, or upward winching of the payload retriever, the tether 1200 moves through the tether slot 1054 of channel 1050 and eventually the payload retriever 800 attached to the tether 1200 is pulled into the channel 1050 by the tether. The payload retriever 800 is pulled through the channel 1050 where it engages, and secures, the payload 510 secured to the payload holder 570, 572. The payload retriever 800 then pulls the payload 510 free from the payload holder 570, 572. Once the payload 510 is free from the payload holder 570, 572, the payload 510 may be winched upwardly into secure engagement with the UAV, and the UAV may continue on to a delivery site where the payload 510 may be delivered by the UAV.

FIG. 14D shows a sequence of steps A-D performed in the retrieval of payload 510 from payload retrieval apparatus 1000, shown in FIGS. 14A-14C. A payload retriever, shown in FIG. 14D as payload coupling apparatus 800 having a hook or lip 806 positioned beneath slot 808, is attached to an end of tether 1200 which is in turn attached to a UAV. At point A in the sequence of steps shown from right to left, payload retriever 800 is shown suspended at the end of tether 1200 at a position below the height of tether engagers 1040 and 1030. Payload retriever 800 and tether 1200 move towards the payload retrieval apparatus 1000, where tether 1200 contacts tether engager 1040 or tether engager 1030, and tether 1200 and payload retriever 800 move towards channel 1050 until payload retriever 800 is positioned just outside of channel 1050 shown at point B in the sequence. With further forward or upward movement of the UAV, or upward winching of payload retriever 800 (or any combination thereof), tether 1200 extends through tether slot 1054 of channel 1050 and payload retriever 800 is positioned within channel 1050 as shown at point C of the sequence. With further forward or upward movement of the UAV, or upward winching of the payload retriever 800 (or any combination thereof), payload retriever 800 exits channel 1050 and hook or lip 806 of payload retriever 800 engages handle 511 of payload 510 and removes payload 510 from payload holder 570, 572 positioned on the end of the channel 1050. After removal of payload 510 from payload holder 570, 572 of payload retrieval apparatus 1000, at point D of the sequence, payload 510 is suspended from tether 1200 with handle 511 of payload 510 positioned in slot 808 above hook or lip 806 of payload retriever 800, where payload 510 may be winched up to the UAV and flown for subsequent delivery at a payload delivery site.

### VII. Illustrative Curbside Pickup Process

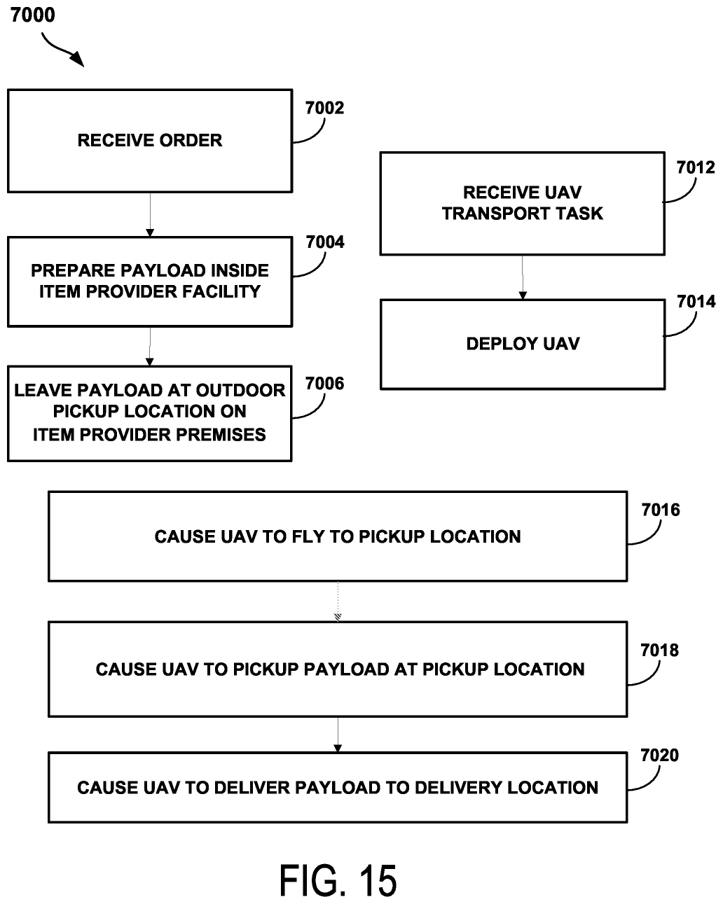

As explained further below, there are various different ways in which an item provider, the ATPS and an individual UAV can communicate and operate in order to complete a delivery that involves curbside pickup by the UAV. FIG. 15 illustrates several steps in a method 7000 of delivering a payload that includes curbside loading. Method 7000 includes steps that are carried out by an order fulfillment system of an item provider, steps that are carried out by a control system of an ATSP, and steps that are carried out by a control system of a UAV.

Blocks 7002, 7004 and 7006 of method 7000 include steps that are performed by the order fulfillment system or personnel of the item provider. As shown at block 7002, method 7000 includes receiving an order in an order fulfillment system of the item provider. The order may include a request for one or more items to be delivered to a delivery location.

After the order is received, as shown at block 7004, a payload including the item or items of the order is prepared. Preparation of the payload is carried out inside a facility of the item provider. The term facility, as used herein, refers to an enclosed structure, such as a building or vehicle, in which the items of the order can be gathered or made and in which a payload including the item(s) can be prepared for delivery by the UAV.

In some embodiments, the payload may be a package including a container that holds the item(s). On the other hand, in some embodiments, the payload may be an item itself without any separate container. Further, the payload may or may not include equipment for securing the payload to a UAV.

The payload may be prepared by employees of the item provider, by automated systems, or by a combination of employees and automated systems. For example, where the item provider is a restaurant and the items for delivery are food items, the food items may be prepared and packaged by restaurant staff. In another example, where the item provider includes a warehouse, the items for delivery may be collected by automated retrieval systems and packaged by employees.

As shown at block 7006, after the payload is prepared, the payload is moved outside of the facility and placed at an outdoor pickup location. Such a pickup location may be provided on the item provider's premises. The term premises, as used herein, includes areas surrounding the item provider facility in which the item provider is authorized to leave a payload, such as a parking lot, walkway, lawn, or another area under the item provider's control. Further, the term premises may also include outdoor space where control of the space is shared by various entities, such as outdoor areas of a shopping center. Indeed, the pickup location itself may be shared by more than one item provider that uses services provided by the ATSP.

Blocks 7012 and 7014 of method 7000 include steps that are performed by the ATSP. As shown at block 7012, method 7000 includes receiving a UAV delivery mission in the control system of the ATSP. As described in more detail below, various different processes can be used to coordinate the receipt of an order in the order fulfillment system of the item provider and the receipt of the UAV delivery mission in the control system of the ATSP.

As shown at block 7014, after the delivery mission is received by the ATSP control system, a UAV is deployed to complete the delivery mission. The term deploy, as used herein, may include instructions to fly to an identified location. For example, in some embodiments, the UAV may be located at a landing platform, such as a charging station, and instructed to initiate a flight path to the identified location. In other embodiments, the UAV may be flying toward a destination, and the ATSP may provide instructions to fly to a new destination or to perform certain tasks upon arriving at the destination.

Blocks 7016, 7018, and 7020 include steps that are performed by a UAV. As shown at block 7016, method 7000 includes causing the UAV to fly to the pickup location, for example after receiving instructions from the ATSP. Block 7018 includes causing the UAV to pickup the payload at the pickup location. As explained further below, picking up the payload may include identifying a location of the payload and following a flight path appropriate for receiving the payload. Method 7000 further includes, at block 7020, causing the UAV to deliver the payload to a delivery location.

Many of the embodiments described below include each of the steps outlined in FIG. 15, though some embodiments may exclude certain steps set forth in FIG. 15. For example, in some embodiments, the UAV may be configured to fly to a particular pickup after a previous task without being deployed by the ATSP. Other variations are also possible.

### A. Order Placement

There are various different ways in which an order may be placed with the order fulfillment system of the item provider. In some embodiments a user may place the order directly within the order fulfillment system of the item provider or in an e-commerce platform associated with the item provider and connected to the order fulfillment system. For example, the user may be a customer who visits an e-commerce platform of the item provider and makes a purchase of one or more items for delivery to a business, residence, public area, or a customer's current location. Such an item provider may be a retail business, a restaurant or another business that provides items for delivery. Based on the purchase, an order is created identifying the items to be delivered.

In other embodiments, the order may not be associated with a purchase. For example, in some embodiments, the order may be associated with items that have already been purchased from the item provider, or the user and item provider may both be associated with the same organization. For example, the user may be an emergency medical technician that is in the field, and the item provider may be a healthcare institution, such as a hospital. If the EMT needs certain medical supplies from the hospital, the EMT may place an order with the hospital's order fulfillment system to have the supplies delivered to a location where they are needed.

Further, in some embodiments, the order may be placed in the order fulfillment system of the item provider by another entity. For example, in some embodiments, the order may be placed by the ATSP or by a third party. As an example, the user requesting the item may initiate the request from the ATSP. Such a user may browse a series of potential item providers from within the ATSP's platform and request delivery from one of the item providers from within the ATSP's platform. The ATSP may then communicate with the item provider's order fulfillment system to generate the order and transfer funds appropriately between the user, the ATSP, and the item provider.

Likewise, in some embodiments, the order may be placed by a third party. For example, the third party may be a service that provides access to various item providers and that coordinates transactions and delivery of the items. As an example, the third party may be an online food ordering platform. The user may browse restaurants from within the food ordering platform, which coordinates placement of the order with the item provider's order fulfillment system. The food ordering platform may also offer the ATSP as a delivery partner, perhaps from a list of several delivery partners. The food ordering platform may then coordinate delivery between the item provider and the ATSP, or facilitate communications between the item provider and ATSP.

In cases where the order is placed in the order fulfillment system by the ATSP or a third party, communication may occur between the order fulfillment system and the AT SP or third party to confirm availability of the requested items as well as timing and completion of the delivery. Such information can then be provided to the user before the order is placed, during order preparation and delivery, as after delivery is completed.

### B. Initiation of Delivery Mission

There are various different ways in which the ATSP may be notified that there is a new delivery mission to be completed. In embodiments where the initial user engagement is with the ATSP, the ATSP may be notified of the delivery mission upon placement of the order by the user. For example, if the user places an order with the item provider from the ATSP's online platform, the ATSP will be aware of a potential delivery mission from the beginning of the process, and may generate the delivery mission as soon as the order is confirmed.

On the other hand, in embodiments where the order is placed with the item provider or a third party, the ATSP may be notified of the delivery mission at various stages. In some embodiments, the order fulfillment system of the item provider and/or the third party may communicate with the ATSP while the order is being placed and notify the ATSP of the delivery mission upon placement of the order. For example, the ATSP may be consulted to confirm that a UAV is available for the potential delivery, to establish a delivery location, to establish a cost for the delivery, or other various reasons before the order and delivery mission are finalized.

Alternatively, in some embodiments, the ATSP may be notified of the delivery mission after the order is placed. For example, the ATSP may have an obligation to complete deliveries for the item provider or third party such that confirmation of the mission before order placement is unnecessary. Likewise, in some embodiments, the item provider or third party may use various delivery providers. In such a case, the item provider or third party may select the ATSP for delivery and notify the ATSP of the delivery mission after the order has been placed.

As explained in further detail below, in some embodiments the ATSP may receive both the pick up location and the delivery location upon being notified of the delivery mission. In other embodiments, the ATSP may initially receive a notification of a delivery mission and the pickup location, and subsequently receive the delivery location at a later time, such as when the payload is received by the UAV.

### C. Initiation of Payload Preparation

There are various different ways in which preparation of the payload can be initiated. In some embodiments, a worker of the item provider may begin preparing the payload after the order is placed without coordinating with the ATSP. For example, the payload may be prepared immediately after placement of the order, or as soon as a worker is available to prepare the order. Such a process may occur in situations where there is typically sufficient UAV availability or where the item provider can select the ATSP from a list of possible delivery providers based on availability or delivery price. This may be a preferred system where the recipient expects delivery as soon as possible, such as with unscheduled food deliveries, and where waiting to prepare an order is undesirable.

In other embodiments, payload preparation may be delayed until a UAV is available for delivery. For example, in some embodiments, the ATSP may provide information regarding UAV availability and/or pricing to the order fulfillment system of the item provider, which may use the information to determine whether to initiate preparation of the payload. For example, in some embodiments the ATSP may provide information to the item provider regarding the availability of a UAV to receive a payload at the item provider's premises. In a simple embodiment, the ATSP may determine whether a UAV is available within a certain threshold time period, and provide a binary indicator that indicates whether or not UAV delivery is available.

The item provider can use the availability information to determine when to prepare payloads for pickup, and/or whether to select the ATSP as the delivery provider. For example, if the item provider has several orders of the same type that would be convenient to prepare simultaneously, and the availability information indicates that a sufficient number of UAVs are currently available for each of the orders, the item provider may use the availability information to determine that the payloads associated with this group of orders should be prepared. Once the decision is made to prepare a certain payload, the order fulfillment system may ‘reserve’ the available UAV(s) for delivery so they are not assigned to other missions.

In some embodiments, the ATSP may determine availability and/or pricing information that is unique to particular orders. For example, the ATSP may receive information about one or more orders and make a determination about the availability of UAV delivery for the orders based on the order information. For example, the ATSP may determine an estimate of the energy that will be consumed to complete the delivery. This determination can be based on the distance of the route from the item provider's premises to the delivery location, elevation changes along the route, current wind conditions and other factors. The energy consumption estimate may also be based on information about the contents of the payload, such as the weight, size, and shape of the payload.

Further, in some embodiments, the ATSP may determine availability and/or pricing information based on the status of the fleet of UAVs. For example, the ATSP may consider the available energy of nearby UAVs (e.g., battery charge), the current location of the UAVs, and the payload capacity of the UAVs to determine the availability of the UAVs to complete a delivery mission. The ATSP may determine the availability of each UAV in the fleet, or within a certain area near the item provider, and provide this information to the item provider for determining when to initiate payload preparation.

### D. Initiation of Payload Placement at a Loading Station

There are various different ways in which the process of placing the payload at a loading station may be initiated. In some embodiments, when the UAV arrives at the pickup location, such as on the premises of the item provider, the UAV will receive the payload from a payload retrieval apparatus (otherwise referred to herein as an autoloader device) at a particular outdoor loading station. However, in other embodiments, the UAV may receive the payload at the loading station without the use of any specific retrieval apparatus, such as if the payload is on the ground or on a flat support surface.

In some embodiments, a worker will take the payload from inside the item provider's facility to the loading station and place the payload at the loading station, such as on the payload retrieval apparatus. In other embodiments, the payload retrieval apparatus may be mobile and loaded inside the facility. In such an embodiment, the payload retrieval apparatus may move to the loading station after receiving the payload. For example, the payload retrieval apparatus may be provided on a mobile robot, including wheels, tracks, legs or other mobile components for moving the payload retrieval apparatus from the facility to the loading station.

In embodiments where a worker places the payload at the loading station, the worker may initially be notified of the availability of the loading station, or an associated payload retrieval apparatus, for receiving a payload. In some embodiments, the worker may determine that a payload retrieval apparatus is available by visual confirmation, such as by looking at the payload retrieval apparatus. In other embodiments, the ATSP may determine that the payload retrieval apparatus is available to receive a payload and provide this information to a worker. For example, the ATSP may track loading and unloading of the payload retrieval apparatus and provide an indication to the worker, such as on a console or a user device. In some embodiments, the ATSP may receive a signal from a device operated by the worker that indicates that a payload was placed on a payload retrieval apparatus. The device may be a console, a mobile device, or a processor on the payload retrieval apparatus. Upon receiving such a signal, the ATSP may determine that the payload retrieval apparatus is unavailable and set the availability status to unavailable.

On the other hand, once the ATSP receives a signal from a UAV that a payload has been received from the payload retrieval apparatus, the ATSP may determine that the payload retrieval apparatus is available and reset the availability status to available.

Alternatively, in some embodiments, the ATSP may determine the availability of status of the payload retrieval apparatus directly from the payload retrieval apparatus. For example, the payload retrieval apparatus may include a sensor that identifies whether a payload is on the payload retrieval apparatus. The payload retrieval apparatus may further include a computer system and transmitter to analyze the sensor information and send the sensor information to the ATSP. For example, the computer system may track the loading and unloading of the payload retrieval apparatus and send corresponding information to the ATSP via the transmitter. Further still, the sensor may be a weight sensor which, in addition to identifying loading and unloading of the payload, may also determine the weight of the payload. The system can then use the weight of the payload to identify an error in the order, such as when the measured weight does not match an expected weight, or to assign or alter the delivery mission. For example, the ATSP may assign a particular UAV to the delivery mission based on the weight of the package, or re-assign the delivery mission to a different UAV if the payload is lighter or heavier than expected, and can be re-assigned to a more appropriate UAV, such as a UAV with a smaller or larger payload capacity.

The payload retrieval apparatus may send the corresponding information to the ATSP and, based on the status indicated by the sensor, set the available status of the payload retrieval apparatus accordingly. Further still, in some embodiments, the ATSP can use either sensor information or the worker loading/UAV unloading information as a confirmation of the status of the payload retrieval apparatus.

In addition to information concerning the availability of the payload retrieval apparatus to receive a payload, the ATSP may also determine a placement signal based on the status of a UAV that has been instructed to receive the payload. For example, the ATSP or order fulfillment system may determine a pickup status Such UAV availability is described above.

If UAV delivery is available, the worker might ‘reserve’ the UAV and begin preparing a payload with the items of the order. The availability can then be provided to personnel of the item provider as a binary indication, such as a check mark for available and an X for unavailable. In other embodiments, additional information about availability may be made available. For example, the ATSP may provide information about the amount of time until a UAV can arrive at the item provider's premises. Such information may be presented numerically, such as the number of minutes until the UAV is available, or using other visual indicators. For example, a visual indicator can be determined and presented to personnel who will prepare the payload based on the time until a UAV is available. For example, if a UAV will be available within a first time range, the system may determine that the UAV is ‘immediately’ available and assign a green indicator to the UAV. If the UAV will be available within a second time range, the system may determine that the UAV is ‘moderately’ available and assign a yellow indicator to the UAV. Further, if the UAV will not be available until some time after the second time range, the system may determine that the UAV is ‘unavailable’ and assign a red indicator to the UAV. These indicators may be presented to the system or personnel of the item provider.

### E. UAV Identification of Loading Station

In some embodiments, there may be a group of loading stations at the pickup location. There are various different ways in which the UAV can determine which loading station to engage for payload pickup.

In some embodiments the UAV may be provided with a particular location of the loading station and fly directly to the loading station. In other embodiments, the UAV may be provided with an identification associated with a particular loading station, such as the identification of an autoloader, and may use the identification to locate the appropriate loading station. For example, in some embodiments, the UAV may use imaging systems to identify the assigned autoloader and approach the autoloader after identification. Further, in some embodiments, the UAV may use both a location and identification to verify the correct autoloader for pickup.

In other embodiments, the UAV may be tasked with picking up a payload at the item provider's premises without being assigned a particular autoloader. For example, in some embodiments, the UAV may be assigned to pick up a payload from an occupied autoloader and subsequently receive a delivery mission. For example, the UAV may scan a payload that has been picked up, and receive a delivery mission based on the scanned information, as explained further below.

### F. UAV Identification of Delivery Location

There are various different ways in which the UAV can determine the delivery location for the payload.

In some embodiments the UAV may receive the entire flight path of a delivery mission before deployment. For example, in some embodiments, at deployment, the UAV may receive a flight path to the item provider, the location and identification of an autoloader to engage, and a delivery location and flight path to the delivery location. In other embodiments, the UAV may receive the delivery location at another time. For example, in some embodiments, the UAV may be provided with the delivery location based on the autoloader it engages. For example, in response to an indication that the UAV has engaged a particular autoloader, the ATSP may send details about a delivery mission, including the delivery location, to the UAV. Likewise, in some embodiments, the UAV may receive the delivery location based on the particular payload that it receives. For example, the UAV may scan the received payload, and receive details about a delivery mission based on the received payload, as explained further below.

### VIII. Example Methods of Delivery

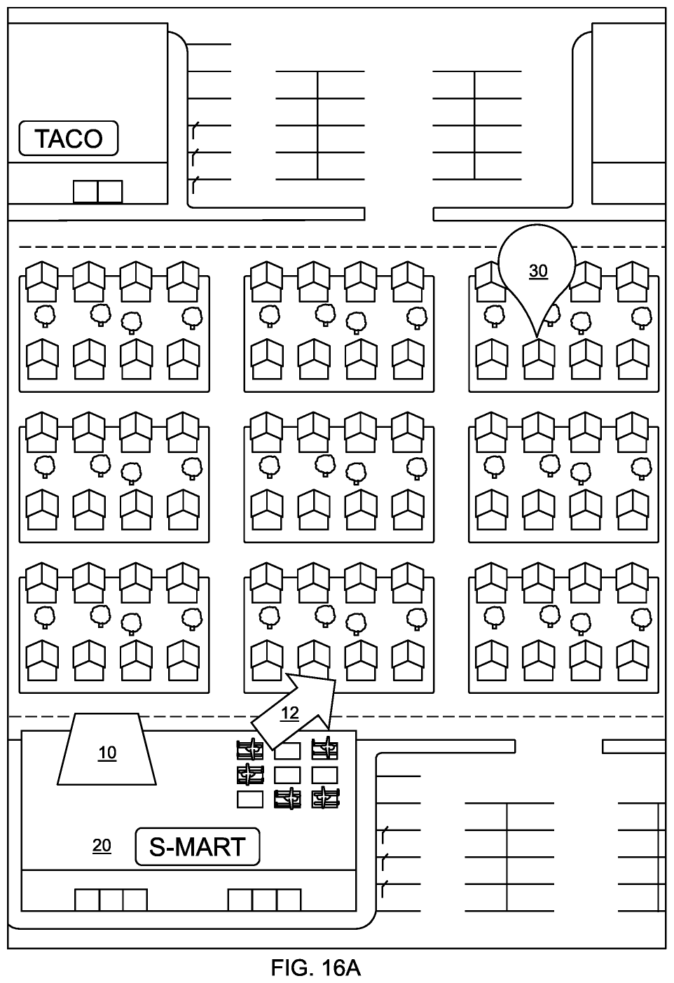

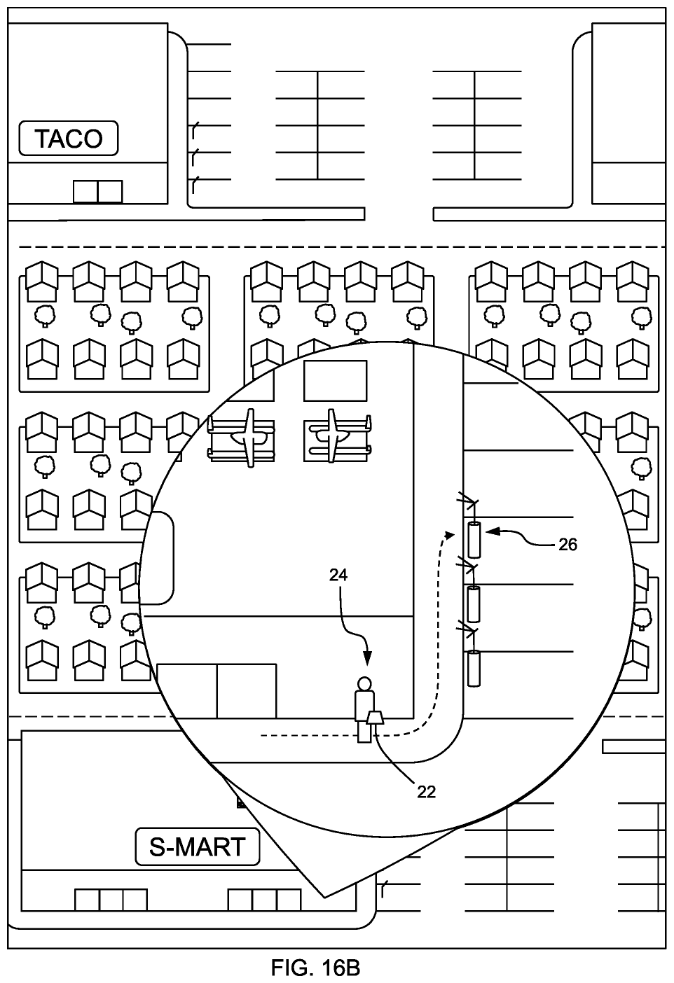

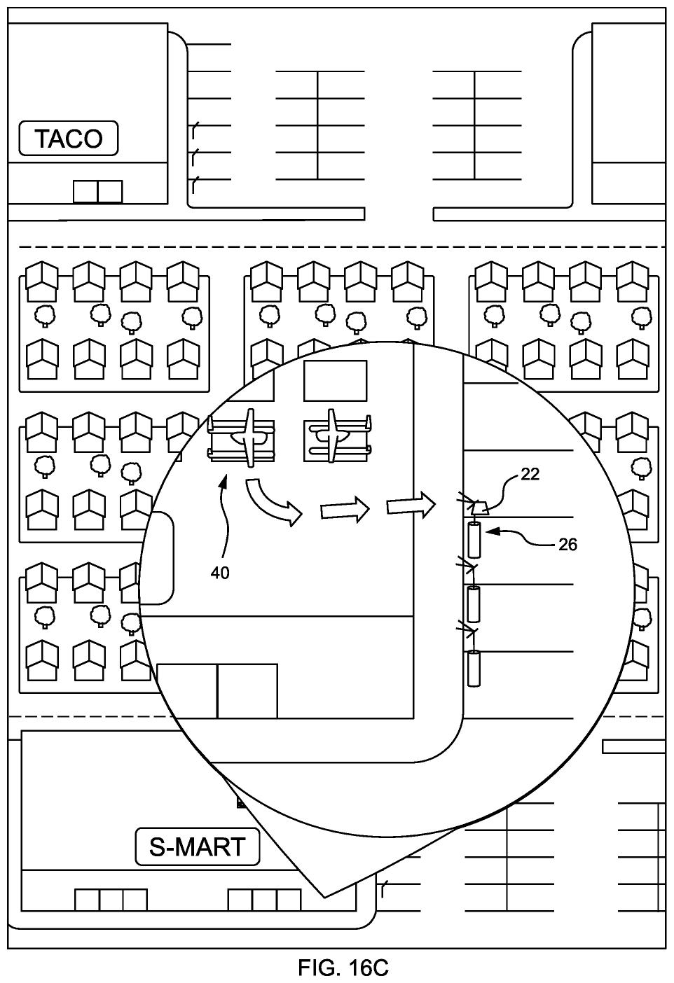

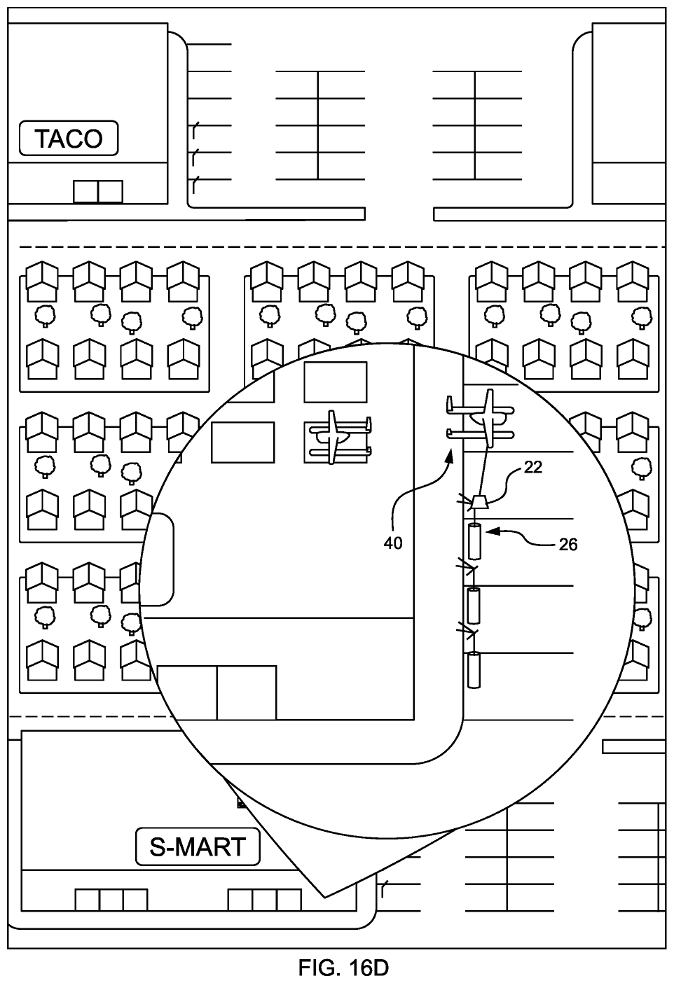

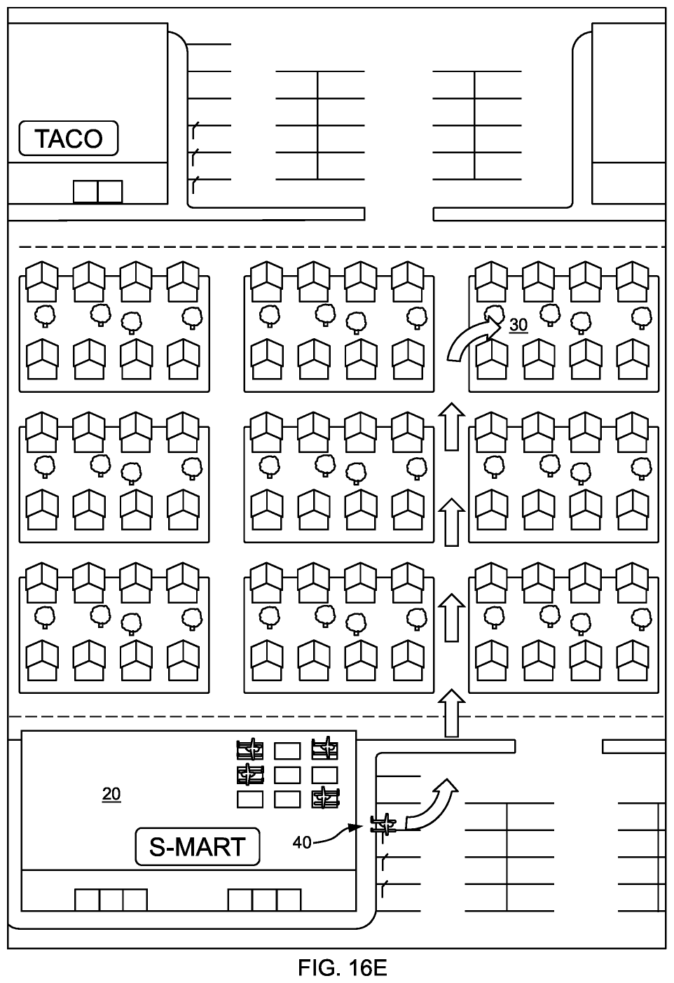

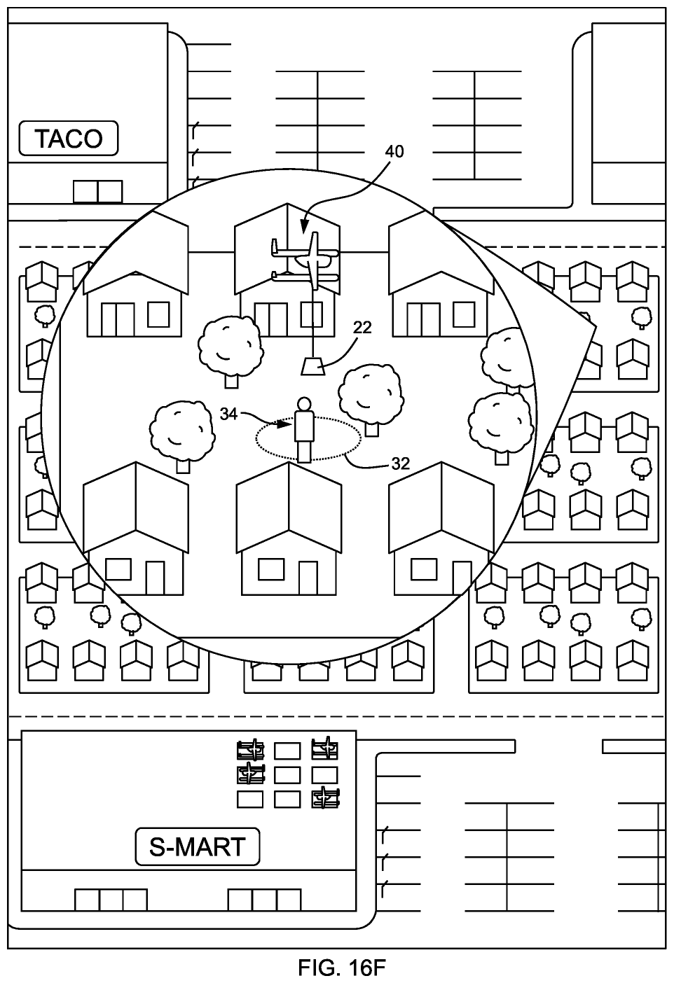

FIGS. 16A-16F illustrate an embodiment of a method where a UAV is deployed from a nest located on the premises of an item provider, retrieves a payload from a loading station on the premises, and then flies to the delivery location for payload delivery.

FIG. 16A illustrates the general details of a delivery mission to be carried out by a UAV. The delivery mission includes an order 10 for one or more items from an item provider 20 to be delivered by a UAV. The order 10 is to be delivered to a delivery location 30, in the form of a residence. The ATSP has determined that a UAV from nest 12, which is located on the premises of item provider 20, will be assigned to complete the delivery. In the illustrated embodiment, the nest 12 of UAVs is located on the roof of the facility of the item provider 20.

The location of nest 12 on the roof takes advantage of otherwise unused space on the item provider's premises. Accordingly, when the UAVs are deployed they are already located at the item provider's facility, limiting the flight duration of the delivery mission. Moreover, having the nest 12 located on the roof also allows the UAVs to begin the delivery mission at an elevated position, which increases efficiency. Of course, in other embodiments, the nest may be positioned at another location on the item provider's premises, or elsewhere.

FIG. 16B illustrates a worker 24 of item provider 20 transporting a payload 22 that includes the ordered items to a payload retrieval apparatus or autoloader 26. The autoloader 26 is positioned at an outdoor loading station on the premises of item provider 20. At an appropriate time, as described above, such as in response to an indication or instruction from the ATSP, the worker 24 may carry the payload 22 from inside the facility of the item provider 20 to the autoloader 26 for receipt by a UAV.

In some embodiments, the autoloader 26 is placed at the same location as an automotive curbside pickup location, such as at a parking spot designated for curbside pickup. In such a case, the route traveled by the worker 24 may be the same for UAV curbside pickup as for automotive curbside pickup. Accordingly, the time required to place the payload 22 on the autoloader 26 may be substantially the same as the time required to deliver an order to an automobile that is parked for curbside pickup.

FIG. 16C illustrates a UAV 40 being deployed from nest 12 with instructions to pick up payload 22 from the autoloader 26. As explained above, there are various ways in which the UAV 40 may be instructed or determine which autoloader 26 to engage in order to receive the payload 22. As shown in FIG. 16D, the UAV 40 then engages the autoloader 26 to retrieve the payload 22. For example, in the illustrated embodiment, the UAV uses a winch and tether system to hook the payload 22 at the autoloader 26 and hoist the payload 22 up to the UAV 40. In other embodiments, various different methods are possible for retrieving the payload 22.

With the payload 22 secured to the UAV 40, the UAV 40 may follow a flight path to the delivery location 30, as illustrated in FIG. 16E. As explained above, there are various ways that the UAV may receive the delivery location 30 and/or the flight path to the delivery location either before or after receiving the payload. As illustrated in FIG. 16F, once the UAV 40 arrives at the delivery location, the UAV 40 may deliver the payload 22. For example, the UAV may lower the payload 22 to a delivery zone 32 at the delivery location 30. The payload 22 may then be received by a recipient 34.

Once the payload 22 has been delivered, the UAV 40 may return to the nest 12 on the premises of item provider 20, complete another delivery mission, or fly to another nest. For example, the ATSP might have a network of nests spread over a geographic area, such that a UAV may be deployed from a first nest, carry out a delivery mission, and then dock at a second nest that is remote from the first nest. Such a system may allow UAVs to carry out longer missions, by making it unnecessary for a UAV to fly back to the original nest after delivery. Thus, a UAV may be deployed from a nest near the pickup location and return to a nest near a delivery location, which can substantially increase the available distance of a delivery mission.

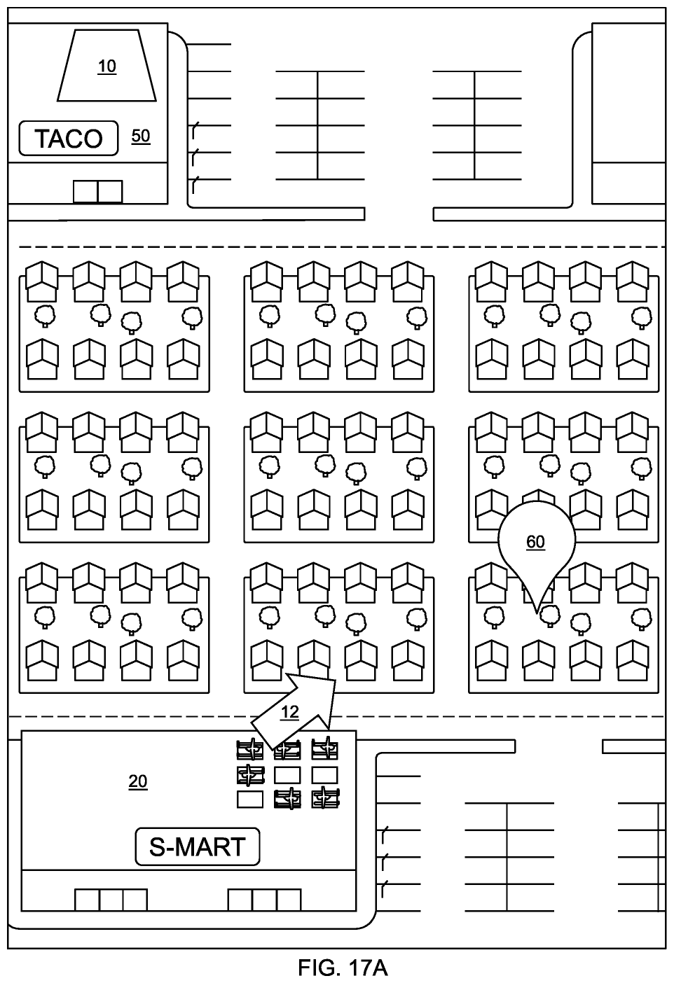

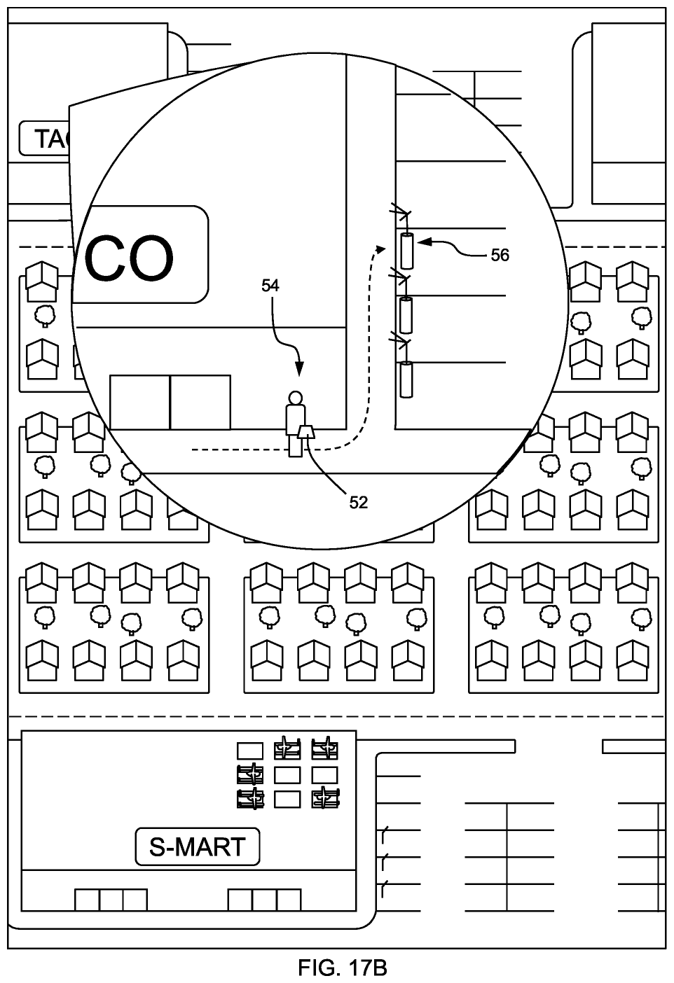

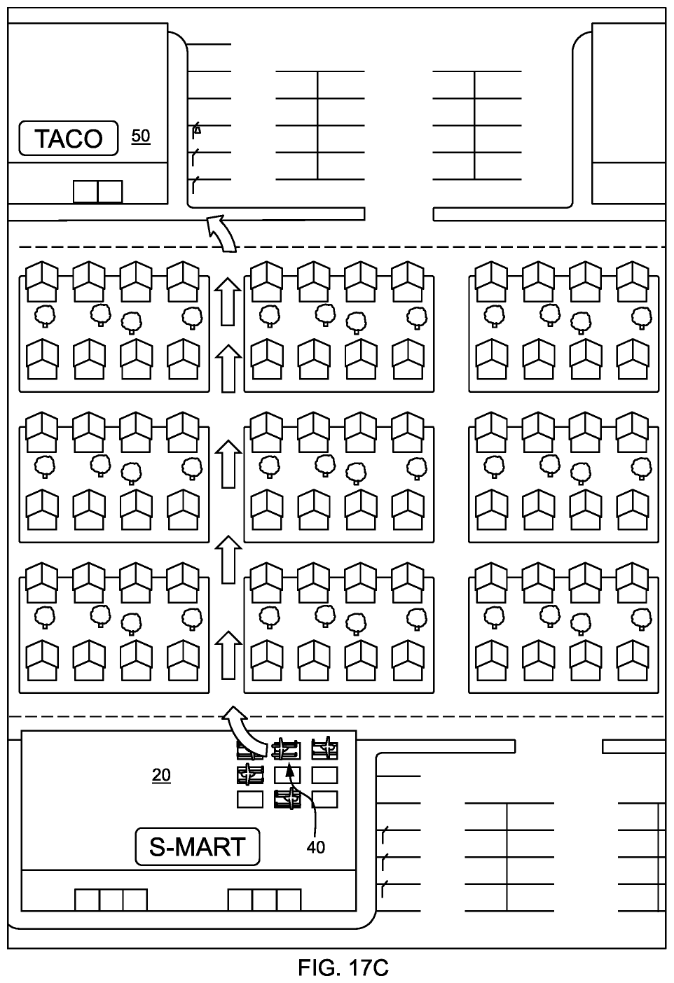

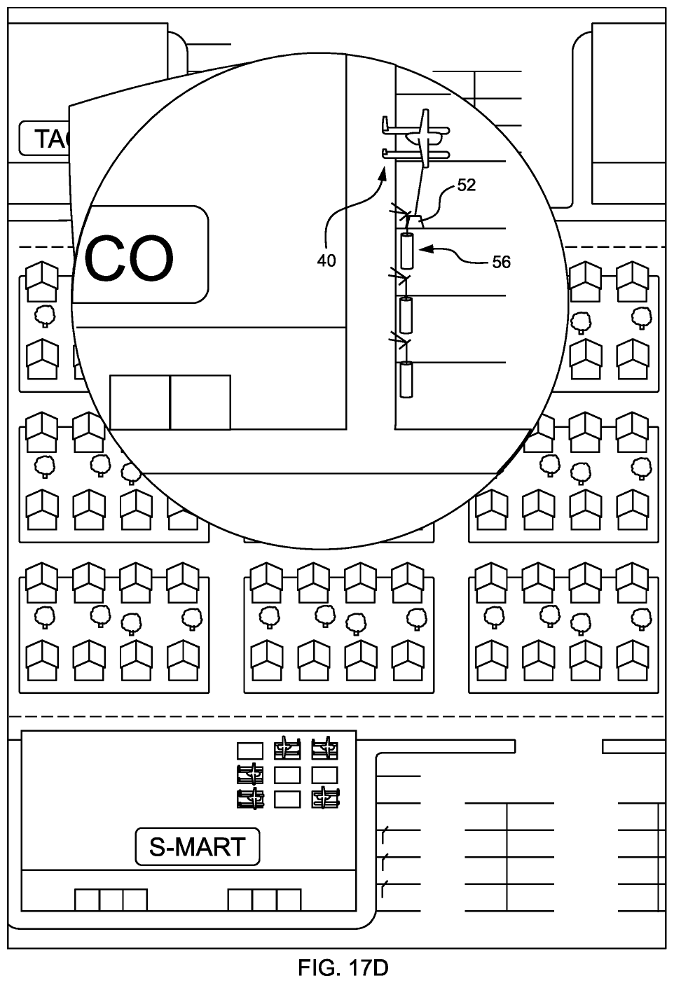

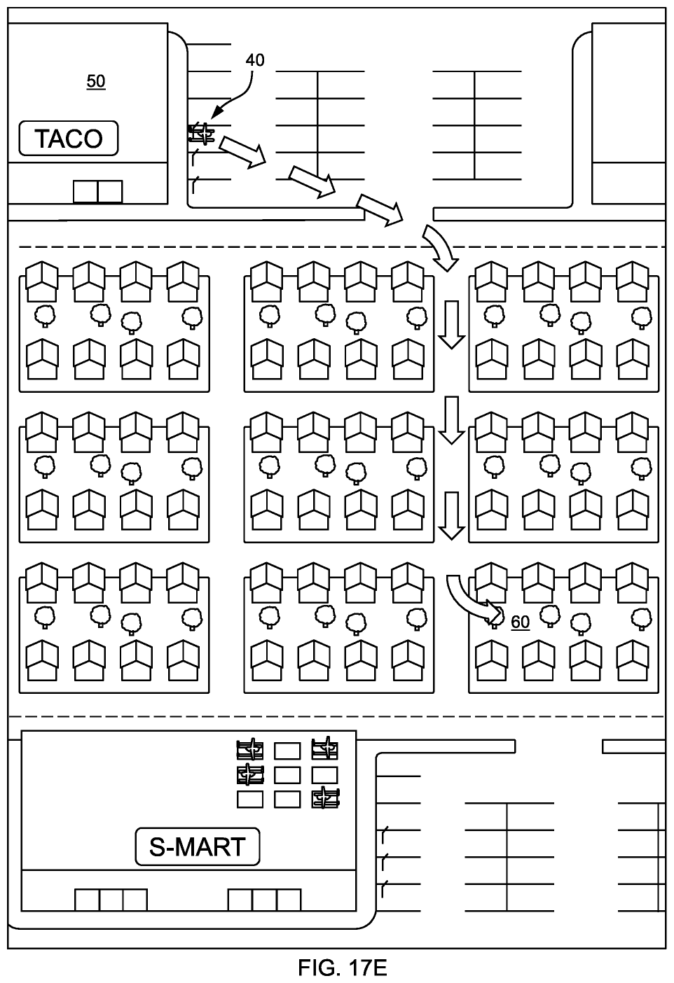

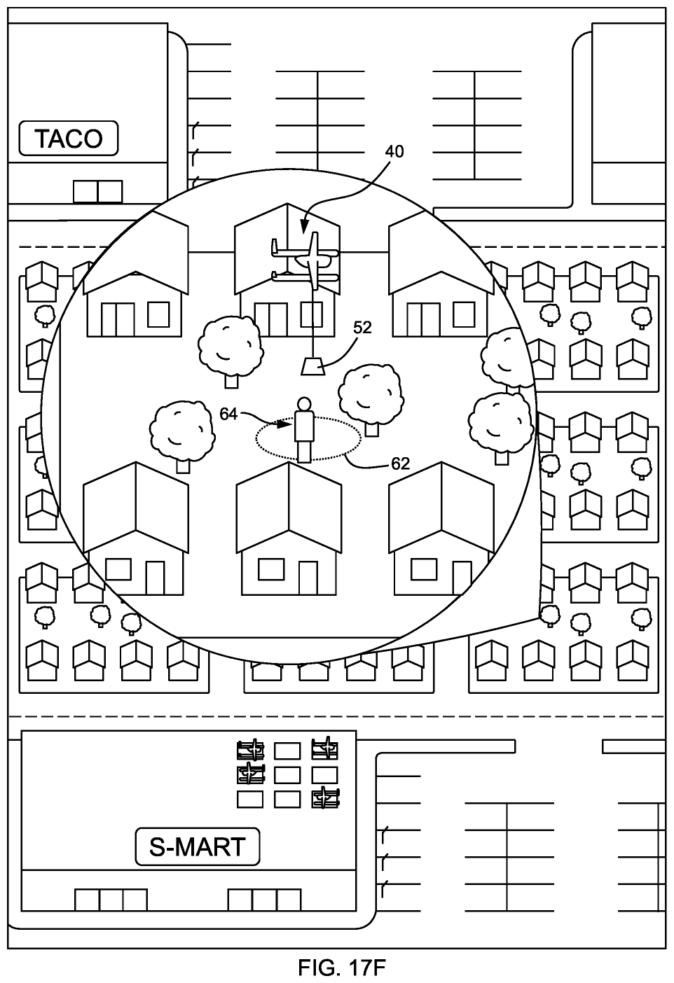

FIGS. 17A-17F illustrate an embodiment of a method where a UAV is deployed from a nest located at a first location, flies to a loading station on the premises of an item provider, retrieves a payload from the loading station, and then flies to the delivery location for payload delivery.

FIG. 17A illustrates the general details of a delivery mission to be carried out by a UAV. The delivery mission includes an order 10 for one or more items from an item provider 50 to be delivered by a UAV. The order 10 is to be delivered to a delivery location 60, in the form of a residence. The ATSP has determined that a UAV from nest 12, which is located on the premises of a different item provider 50, will be assigned to complete the delivery.

FIG. 17B illustrates a worker 54 of item provider 50 transporting a payload 52 that includes the ordered items to an autoloader 56. Again, the autoloader 56 is positioned at an outdoor loading station on the premises of item provider 50. At an appropriate time, as described above, such as in response to an indication or instruction from the ATSP, the worker 54 may carry the payload 52 from inside the facility of the item provider 50 to the autoloader 56 for receipt by a UAV.

FIG. 17C illustrates a UAV 40 being deployed from nest 12 with instructions to fly to the premises of item provider 50. For example, the ATSP may provide the flight path to the UAV 40, or the ATSP may provide a location or identification of the item provider 50. Once the UAV arrives at the premises of item provider 50, the UAV may pick up payload 52 from the autoloader 56, as shown in FIG. 17D. As explained above, there are various ways in which the UAV 40 may be instructed or determine which autoloader 56 to engage in order to receive the payload 52.

With the payload 52 secured to the UAV 40, the UAV 40 may follow a flight path to the delivery location 60, as illustrated in FIG. 17E. Again, there are various ways that the UAV may receive the delivery location 60 and/or the flight path to the delivery location 60, either before or after receiving the payload. As illustrated in FIG. 17F, once the UAV 40 arrives at the delivery location, the UAV 40 may deliver the payload 52. For example, the UAV 40 may lower the payload 52 to a delivery zone 62 at the delivery location 60. The payload 52 may then be received by a recipient 64. Once the payload 52 has been delivered, the UAV 40 may return to the nest 12 on the premises of item provider 20, complete another delivery mission, or fly to another nest, for example as instructed by the ATSP.

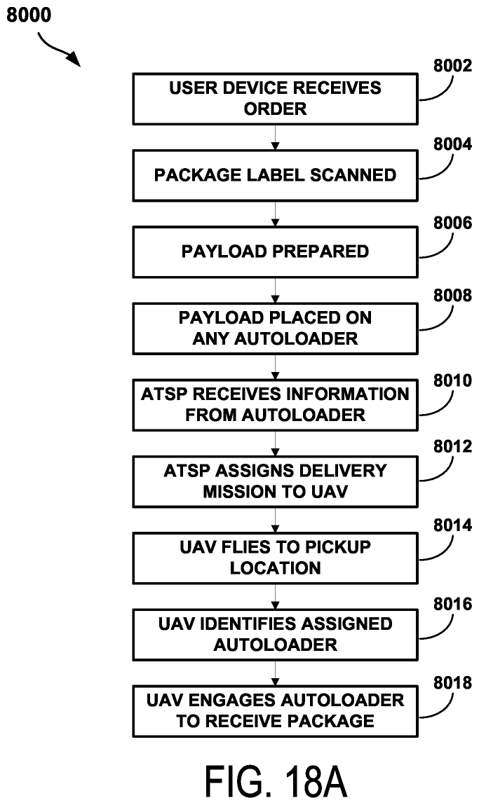

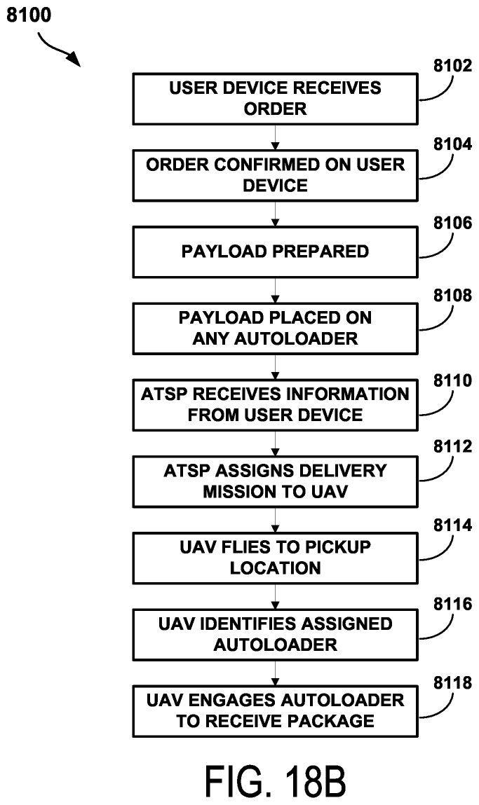

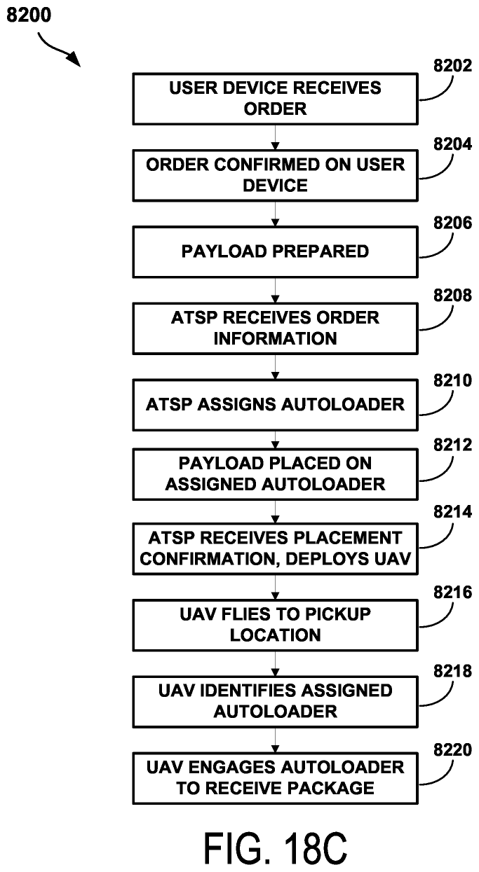

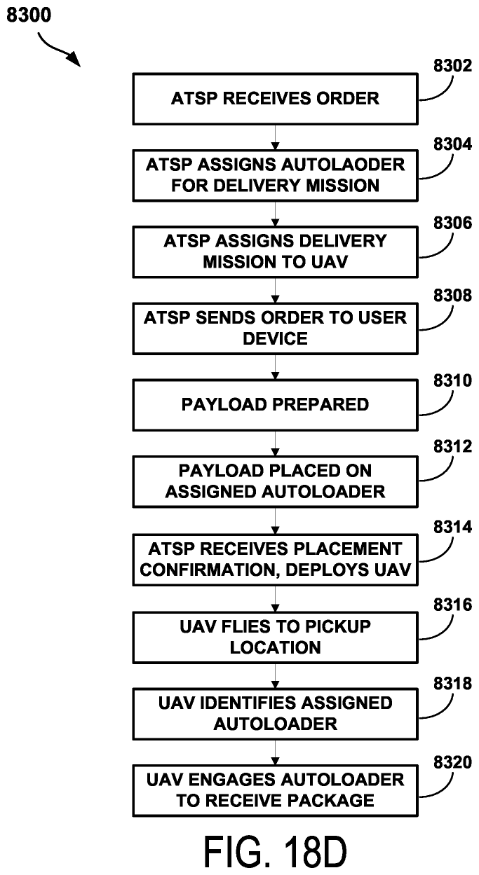

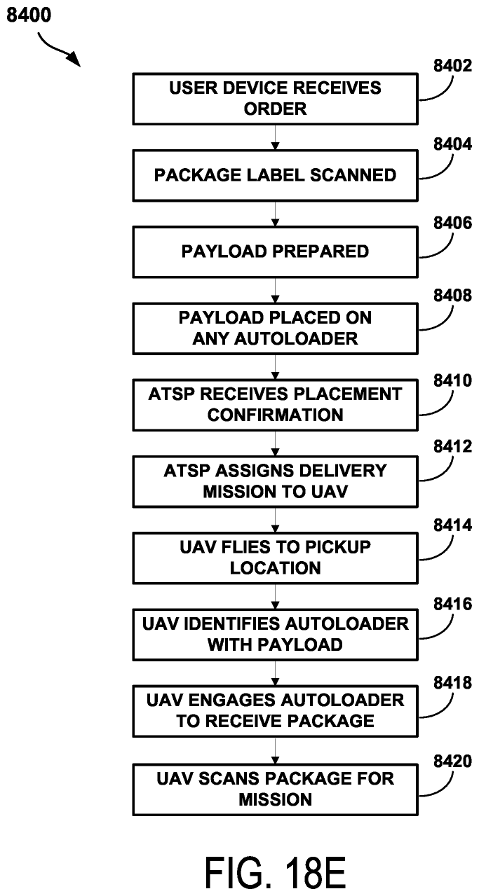

FIGS. 18A-18E describe various UAV delivery methods that include curbside pickup. FIG. 18A is a block diagram of a method 8000, in accordance with examples described herein. At block 8002, the method 8000 includes receiving an order on a user device of the item provider. The user device may be a mobile device, such as a tablet computer, smartphone or other mobile computing device, or may be a stationary device, such as a user console.

At block 8004, method 8000 includes confirming the order by scanning a package label using the user device. For example, the package label may include a machine readable identification so that the user device can recognize the package label and associated package. In some embodiments, the package label is associated with the order before it is scanned, and scanning of the label acts as a confirmation that a worker is preparing the order for delivery. For example, in some embodiments, the package label is printed upon receipt of the order and includes the items of the order. In other embodiments, the package label is associated with the physical container that will hold the items, such as a box, and the package label becomes associated with the order only after being scanned.

At block 8006, method 8000 includes preparing the payload associated with the order for eventual pickup by a UAV. For example, a worker may fill the labeled package with the items of the order and close the package for delivery. At block 8008, the method includes placing the payload on an autoloader for receipt by a UAV. In method 8000, the process is configured so that the worker may place the payload at any available autoloader on the premises. Accordingly, the worker only needs to find an autoloader that has space for the payload, and is not required to find a particular autoloader.

At block 8010, method 8000 includes scanning the package label of the payload using the autoloader and sending information to the ATSP. For example, the autoloader may include a computer system, a transmitter, and a label reader, such as a scanner, an RFID reader, or another reader, to identify the package label and the order associated with the label. With such a configuration, the autoloader may send, via the transmitter, information obtained by scanning the package label, such as an order identification, to the ATSP control system. The ATSP receives the information from the autoloader which may identify the delivery mission. For example, the ATSP may receive an order identification from the autoloader and communicate with the item provider's system to receive further details, such as the delivery location. Alternatively, the ATSP may receive a delivery location directly from the autoloader based on the scanned information, such that additional details about the delivery are not needed to establish a delivery mission.

At block 8012, the method 8000 includes determining, by the ATSP, an appropriate UAV to complete the delivery and assigning the delivery mission to the identified UAV. In various embodiments, the ATSP may consider the location of the UAV, the size of the order, the stored energy (e.g., battery charge) available to the UAV, the size of the UAV, and other factors in determining the appropriate UAV. Based on the information received from the autoloader, the delivery mission may include an assigned autoloader identification.

At block 8014, the method 8000 includes causing the UAV to fly to the pickup location, such as the premises of the item provider, or a specific pickup station on the premises. At block 8016, the method includes causing the UAV to identify the assigned autoloader of the delivery mission. For example, the autoloader may include a fiducial or other identifying characteristics that the UAV can read to identify the autoloader. In some embodiments, the UAV may identify the assigned autoloader as it approaches a group of autoloaders and fly to the assigned autoloader after identifying the autoloader. In other embodiments, the UAV may have a known location for the autoloader and use the identification of the assigned autoloader as a confirmation or verification. At block 8018, the method 8000 includes engaging the autoloader to receive the package. For example, as described in further detail throughout the disclosure, the UAV may lower a payload retriever to retrieve the payload from the autoloader.

FIG. 18B is a block diagram of another method 8100 according to an embodiment of the disclosure. At block 8102, the method 8100 includes receiving an order on a user device of the item provider. At block 8104, method 8100 includes confirming reception of the order with the user device. For example, a user operating the user device may confirm receipt of the order so as to indicate that they will prepare the order for delivery and place the associated payload on an autoloader for pickup. At block 8106, method 8100 includes preparing the payload associated with the order for eventual pickup by a UAV.

At block 8108, the method includes placing the payload on an autoloader for receipt by a UAV. In method 8100, the process is again configured so that the worker may place the payload at any available autoloader on the premises. At block 8110, method 8100 includes sending information to the ATSP to indicate that the payload has been placed at a particular autoloader. For example, the worker may use the user device to confirm that the payload has been placed at an autoloader and to identify the particular autoloader where the payload has been placed. For example, the worker can type an ID of the autoloader into the user device, or use the device to scan an identifier of the autoloader, such as a fiducial. Based on the confirmation on the user device, the ATSP may then receive information regarding the placement of a payload on the identified autoloader.

At block 8112, the method 8100 includes determining, by the ATSP, an appropriate UAV to complete the delivery and assigning the delivery mission to the identified UAV. At block 8114, the method 8100 includes causing the UAV to fly to the pickup location, such as the premises of the item provider, or a specific pickup station on the premises. At block 8116, the method includes causing the UAV to identify the assigned autoloader of the delivery mission. At block 8118, the method 8100 includes engaging the autoloader to receive the package.

FIG. 18C is a block diagram of another method 8200 according to an embodiment of the disclosure. At block 8202, the method 8200 includes receiving an order on a user device of the item provider. At block 8204, method 8200 includes confirming reception of the order with the user device. At block 8206, method 8200 includes preparing the payload associated with the order for eventual pickup by a UAV.

At block 8208, the method includes receiving, by the ATSP, information about the placed order. For example, in response to the order being confirmed on the user device at block 8204, the ATSP may receive information about the order, including the delivery location and other order details. While block 8208 is shown as occurring after the payload has been prepared in 8206, it is also possible for the ATSP to receive the information before the payload is prepared, for example immediately after receipt of the order, or confirmation on the user device. At block 8210, method 8200 includes assigning an autoloader for the prepared package.

At block 8212, a worker places the payload at the assigned autoloader. To confirm the placement of the payload, the worker may indicate that the payload is ready for pickup on the user device, for example by scanning the autoloader or by another verification method.

At block 8214, the method 8200 includes determining, by the ATSP, an appropriate UAV to complete the delivery and assigning the delivery mission to the identified UAV. At block 8216, the method 8200 includes causing the UAV to fly to the pickup location, such as the premises of the item provider, or a specific pickup station on the premises. At block 8218, the method includes causing the UAV to identify the assigned autoloader of the delivery mission. At block 8220, the method 8200 includes the UAV engaging the autoloader to receive the package.

FIG. 18D is a block diagram of another method 8300 according to an embodiment of the disclosure. At block 8302, the method 8300 includes receiving an order at the ATSP. At block 8304, the method includes assigning, by the ATSP, an available autoloader for the delivery mission associated with the order. At block 8306, the method includes determining, by the ATSP, an appropriate UAV to complete the delivery and assigning the delivery mission to the identified UAV. In some embodiments, the UAV may then wait until instructed to carry out the delivery mission.

At block 8308, method 8300 includes sending the order to a user device for receipt by a worker. For example, the ATSP may send the order to an order fulfillment system of the item provider, which then assigns the order to a user device for preparation by a worker. At block 8310, method 8300 includes preparing the payload associated with the order for eventual pickup by a UAV. At block 8312, the method includes placing the payload on the assigned autoloader.

At block 8314, the ATSP receives confirmation that the payload has been placed at the assigned autoloader and deploys the assigned UAV for payload pickup. As explained above, the worker may confirm placement of the payload on the assigned autolader using the user device, for example by scanning an identification of the autoloader.

At block 8316, the method 8300 includes causing the UAV to fly to the pickup location, such as the premises of the item provider, or a specific pickup station on the premises. At block 8318, the method includes causing the UAV to identify the assigned autoloader of the delivery mission. At block 8320, the method 8300 includes engaging the autoloader to receive the package. For example, as described in further detail throughout the disclosure, the UAV may lower a payload retriever to retrieve the payload from the autoloader.

FIG. 18E is a block diagram of another method 8100 according to an embodiment of the disclosure. At block 8402, the method 8400 includes receiving an order on a user device of the item provider. At block 8404, method 8400 includes confirming reception of the order with the user device. At block 8406, method 8400 includes preparing the payload associated with the order for eventual pickup by a UAV.

At block 8408, the method includes placing the payload on an autoloader for receipt by a UAV. In method 8400, the process is configured so that the worker may place the payload at any available autoloader on the premises. At block 8410, method 8400 includes confirming placement of the package on an autoloader using the user device.

At block 8410, the ATSP receives confirmation that the payload has been placed on an autoloader. At block 8412, the ATSP determines a UAV to carry out a delivery mission and deploys the UAV to the item provider's premises for payload pickup. In some embodiments, the UAV may be deployed without a complete delivery mission, and instead only the pickup location.

At block 8414, the method 8400 includes causing the UAV to fly to the pickup location, such as the premises of the item provider, or a specific pickup station on the premises. At block 8416, the method includes causing the UAV to identify an autoloader with an available payload for pickup. For example, the UAV may detect the presence of the payload on the autoloader, or identify a signal from the autoloader indicating that the autoloader contains a payload for pickup. At block 8418, the method 8400 includes engaging the autoloader to receive the package. At block 8420, the method includes scanning the payload, by the UAV, to determine the corresponding delivery mission. For example, the UAV may scan the payload to determine an identification of the payload. In some embodiments, the UAV may then communicate with the ATSP to obtain the details of the delivery mission based on the payload ID. In other embodiments, the UAV may have a number of delivery missions stored in a memory, and may use the payload ID to determine which of the stored delivery missions should be carried out. Further still, scanning the package by the UAV may be used to confirm that the expected package was received by the UAV.

### IX. Example Payload Retrieval Apparatuses

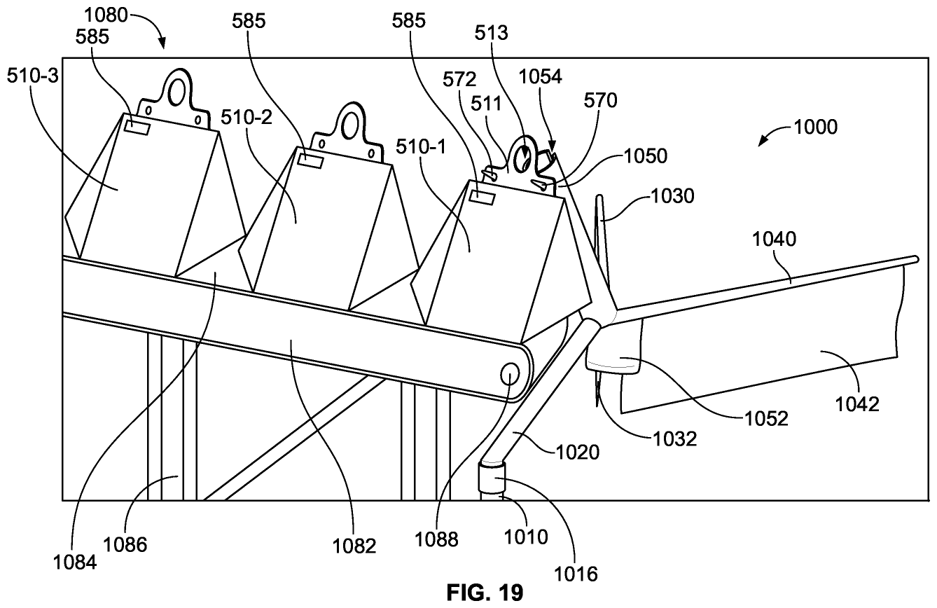

FIG. 19 is a perspective view of payload retrieval apparatus 1000 shown in FIGS. 14A-14D with a payload loading apparatus 1080 having a plurality of payloads 510-2 and 510-3 positioned thereon, according to an example embodiment. Payload loading apparatus 1080 includes a platform 1082 positioned on platform base 1086 having an upper surface 1084 that downwardly slopes towards payload retrieval apparatus 1000. Payload loading apparatus 1080 allows for automatic loading of a subsequent payload positioned on upper surface 1084 of payload loading apparatus 1080 onto payload retrieval apparatus 1000 after a payload positioned on the payload holder has been retrieved. In particular, once payload 510-1 has been removed from payload holder 570, 572 of payload retrieval apparatus 1000, subsequent payload 510-2 slides down the upper surface 1084 of the payload loading apparatus 1080 and is secured to payload holder 570, 572 of payload retrieval apparatus 1000. Payload loading apparatus 1080 may include one or more rollers 1088 that provide for the downward movement of upper surface 1084, like a conveyor belt.

As shown in FIG. 19, the handle 511 of payload 510-1 has openings 524 and 526 (see FIG. 11A) through which pins 570, 572 extend to hold payload 510-1 in position for retrieval. However, handle 511 may also include magnets 524′ and 526′ (see FIG. 11B) that are adapted to magnetically engage corresponding magnets or a metal positioned on the payload holder of the payload retrieval apparatus 1000. With a magnetic handle, the magnets 524′ and 526′ on the handle 511 move into engagement with the payload holder to hold subsequent payload 510-2 into position for subsequent retrieval as illustrated in the sequence of steps at points A-D shown in FIG. 14D. In addition, payloads 510-1 through 510-3 may include fiducials 585 that may take the form of an RFID tag or bar code to identify the contents of the payload and delivery site information and/or delivery instructions. As a result, using payload loading apparatus 1080 in conjunction with payload retrieval apparatus 1000, a plurality of payloads may be retrieved from payload apparatus 1000 without the need for a person to reload subsequent payloads for retrieval, providing for further automated payload retrieval.

In order for the hook or lip 806 of the payload retriever 800 (shown in FIGS. 6A-C) to engage the handle 511 of payload 510 to effect removal and retrieval of the payload 510 from the payload retrieval apparatus 1000, the hook or lip 806 should be positioned downwardly when it exits the channel 1050 in the embodiment shown (different orientations are possible in alternative embodiments). As illustrated in FIG. 19, to ensure that the slot hook or lip 806 of the payload retriever 800 is in a proper orientation as the payload retriever 800 exits the channel 1050 and engages the handle 511 of the payload 510, the payload retriever 800 may be provided with exterior cams 804 or slots that correspond to cams or slots 1058, 1059 positioned on an interior surface of the channel 1050. The interaction of the cams 804 or slots on the payload retriever 800 and cams or slots 1058, 1059 on the interior of the channel 1050 properly orient the payload retriever 800 within the channel 1050 such that hook or lip 806 beneath the slot 808 of the payload retriever 800 is in proper position to extend through the aperture 513 on the handle 511 of the payload 510 to remove the payload 510 from the payload holder 570, 572.

FIG. 20A is a perspective view of channel 1050 of the payload retrieval apparatus 1000 shown in FIGS. 14A-14D with a payload retriever 800 positioned therein. Channel 1050 includes a tether slot 1054 through which tether 1200 extends when tether 1200 draws payload retriever 800 into the interior of channel 1050. The interior of channel 1050 includes cams or slots 1058, 1059 which cooperate with cams 804 or slots on the payload retriever 800 to properly orient the hook or lip 806 and slot 808 in a downward facing position within the channel 1050. Thus, the interaction of cams or slots 1058, 1059 on the interior of channel 1050 with cams 804 or slots on the payload retriever 800 provides a desired orientation of the payload retriever 800 at the point that payload retriever 800 exits the channel 1050 and engages handle 511 of payload 510 to remove the payload 510 from the payload holder 570, 572.

Alternately, or in addition to cams 804, the payload retriever 800″ may have one or more magnets 830 positioned thereon as shown in FIGS. 13C and 20B that cooperate with one or more magnets 1060, or a metal, positioned on an interior of the channel 1050 and magnetic interaction is used to properly orient the payload retriever 800″ within the channel 1050 during the process of payload retrieval.

FIG. 20B is a perspective view of channel 1050 of the payload retrieval apparatus 1000 shown in FIGS. 14A-14D with a payload retriever 800″ positioned therein. Channel 1050 includes a tether slot 1054 through which tether 1200 extends when tether 1200 draws payload retriever 800″ into the interior 1056 of channel 1050. The interior 1056 of channel 1050 includes a plurality of magnets 1060 which magnetically engage with magnets 830, or a metal, on the payload retriever 800″ to properly orient the hook or lip 806 and slot 808 in a downward facing position within the channel 1050. Thus, the interaction of magnets 1060 on the interior 1056 of channel 1050 with magnets 830 or simply a metal on the payload retriever 800″ provides a desired orientation of the payload retriever 800″ at the point that payload retriever 800″ exits the channel 1050 and engages handle 511 of payload 510 to remove the payload 510 from the payload holder 570, 572. Alternatively, or in addition, a metal strip or plurality of metal pieces could be positioned within the channel 1050 to provide for magnetic engagement with the magnets 830 on the payload retriever 800″ Similarly, one or more magnets may be positioned on the interior of channel 1050 that magnetically engage a metal positioned on a payload retriever.

In addition, the payload retriever could be weighted to have an offset center of gravity (see payload retriever 900 shown in FIG. 13D) such that the hook 806 and slot 808 of the payload retriever 900 are positioned properly (with the “heavy” portion of the capsule on a lower side) to engage the handle 511 of the payload 510 and effect removal of the payload 510 from the payload holder 570, 572. The weighted side 840 of payload retriever 900 helps to insure that the hook or lip 806 and slot 808 are positioned downwardly within the channel 1050 so as to be in position for the hook or lip 806 to extend through aperture 513 in handle 511 of payload 510 during the retrieval process. It will be appreciated that the use of cams, magnets, and a weighted side could all be used separately, or used in combination in whole or in part, to provide for a desired orientation of the payload retriever within the channel to effect removal of the payload from the payload retrieval apparatus 1000.

As shown in FIG. 21A, the channel 1050 may also have an interior that tapers downwardly, or decreases in size, as the channel 1050 extends from the first end where the payload retriever enters the interior 1056 of channel 1050 to the second end where the payload retriever exits the channel 1050 to further facilitate the proper orientation of the payload retriever within the channel. In addition, as shown in FIG. 21B, the second end of the channel 1050 could be spring loaded with a spring 1061 exerting a force against outer surface 1057 of channel 1050, or operate as a leaf spring, to also facilitate the proper orientation of the payload retriever (or extension or the hook or lip of the payload retriever) at the point of payload retrieval.

Not only does the payload retrieval apparatus 1000 described above provide for automatic payload retrieval without the need for human involvement, but the UAV advantageously is not required to land for the payload 510 to be loaded onto the UAV at the payload retrieval site. Thus, the UAV may simply fly into position near the payload retrieval apparatus 1000 and maneuver itself to position the tether 1200 between the first and second tether engagers 1040, 1030, which may be aided by the use of fiducials (which could take the form of an RFID tag or bar code) positioned on or near the payload retrieval apparatus 1000 and/or an onboard camera system positioned on the UAV. Once in position, the UAV may then move forward or upward, or the payload retriever may be winched up towards the UAV (or any combination thereof) to pull the payload retriever through the channel 1050 and into engagement with the handle 511 of the payload 510 and effect removal of the payload 510. In some payload retrieval sites, landing the UAV may be difficult or impractical, and also may engage with objects or personnel when landing. Accordingly, allowing for payload retrieval without requiring the UAV to land provides significant advantages over conventional payload retrieval methods.

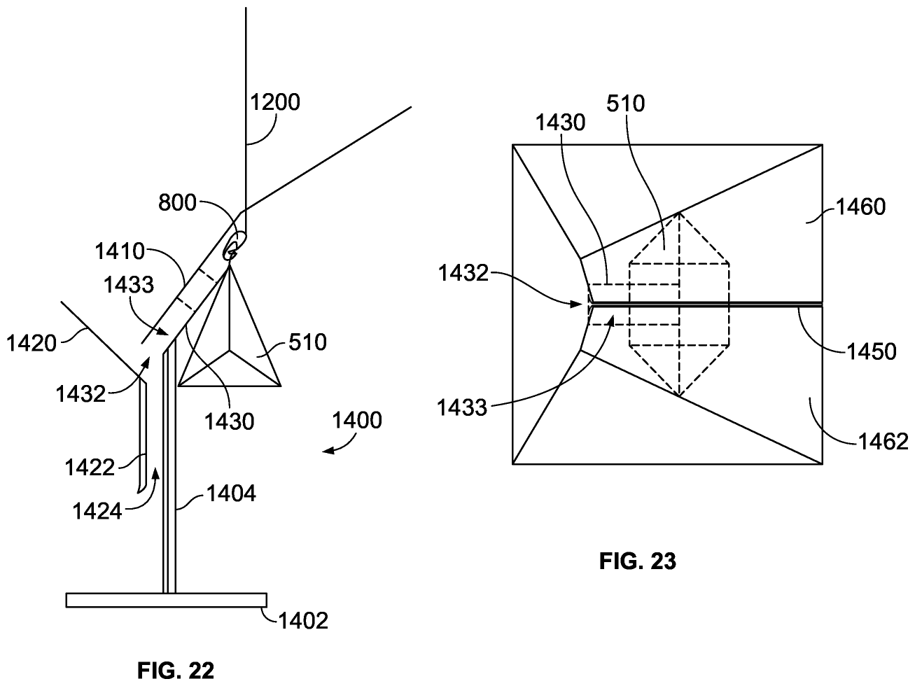

FIG. 22 is a side view of payload retrieval apparatus 1400, which includes a base 1402 and an upwardly extending member 1404. Also included is a first sloped surface 1410 and a second sloped surface 1420. A first channel 1433 is defined between first sloped surface 1410 and surface 1430 and is positioned above upwardly extending member 1404. An opening 1432 is provided to first channel 1433. A payload 510 is positioned at an end of first channel 1433. A second channel 1424 is provided having a wall 1422 extending downwardly from second sloped surface 1420. First and second sloped surfaces 1410 and 1420 provide a funneling system for a payload retrieval 800 attached to a tether 1200 and serves to funnel payload retrieval 800 towards opening 1432 in first channel 1433.

FIG. 23 is a top view of payload retrieval apparatus 1400. Sloped surfaces 1460 and 1462 are provided with a tether slot 1450 positioned therebetween. Opening 1432 to channel 1433 is shown with payload 510 positioned beneath sloped surfaces 1460 and 1462.

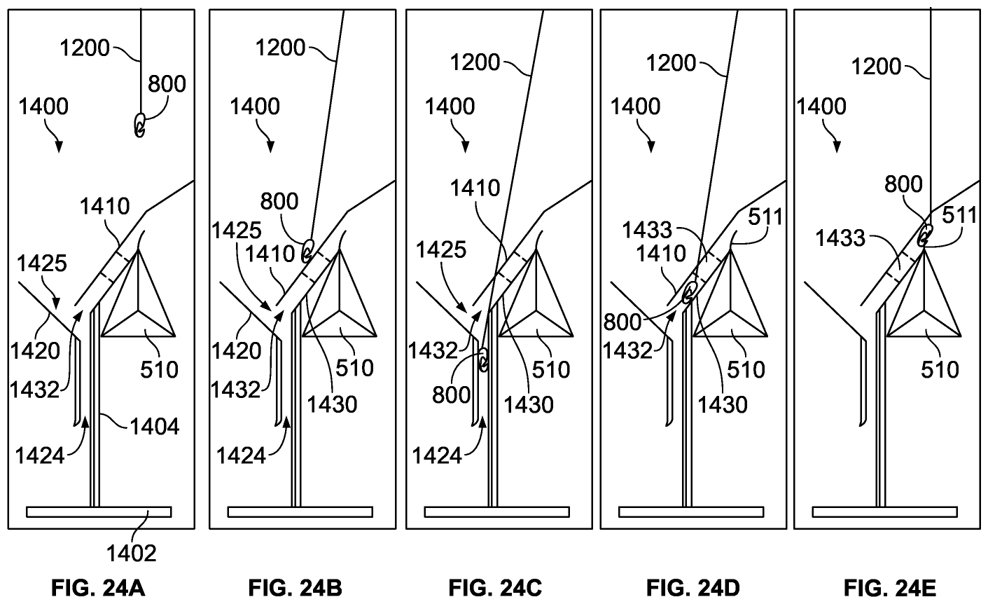

FIGS. 24A-E illustrate a sequence of steps used to automatically pick up payload 510. In FIG. 24A, payload retriever 800 attached to tether 1200 is shown descending towards the funneling system formed by first sloped surface 140 and second sloped surface 1420. FIG. 24B illustrates payload retriever 800 landing on first sloped surface 1410. The payload retriever will then slide down first sloped surface towards opening 1425 between first sloped surface 1410 and second sloped surface 1420. FIG. 24C illustrates payload retriever 800 after it has slid down first sloped surface 1410, through opening 1425 and into second channel 1424. While positioned in second channel 1424, payload retriever 800 is positioned for entry through opening 1432 into first channel 1433. In FIG. 24D, payload retriever 800 has been winched upwardly into first channel 1433, where is it positioned to move further upwardly to secure handle 511 of payload 510. In FIG. 24E, payload retriever 800 has moved further upwardly to secure payload retriever 800 to handle 511 of payload 510, where payload 510 can be removed from the end of the first channel 1433 and winched up to a UAV for transport.

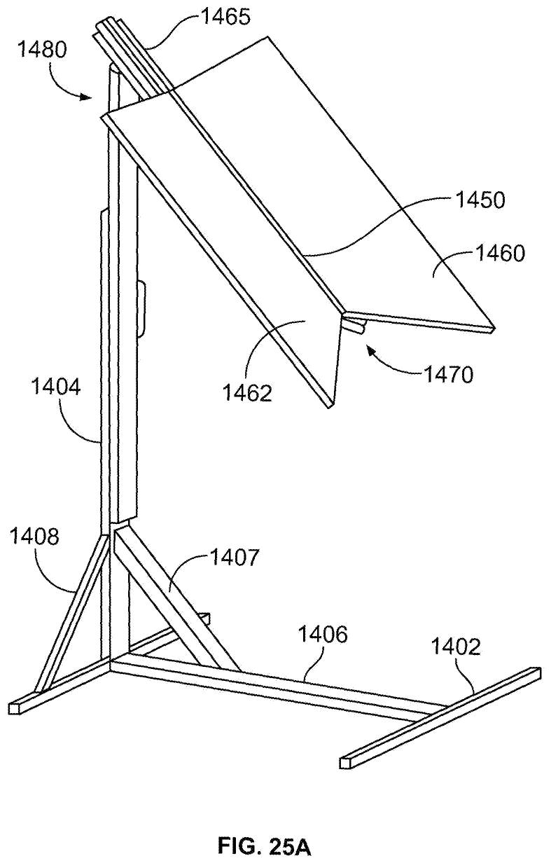

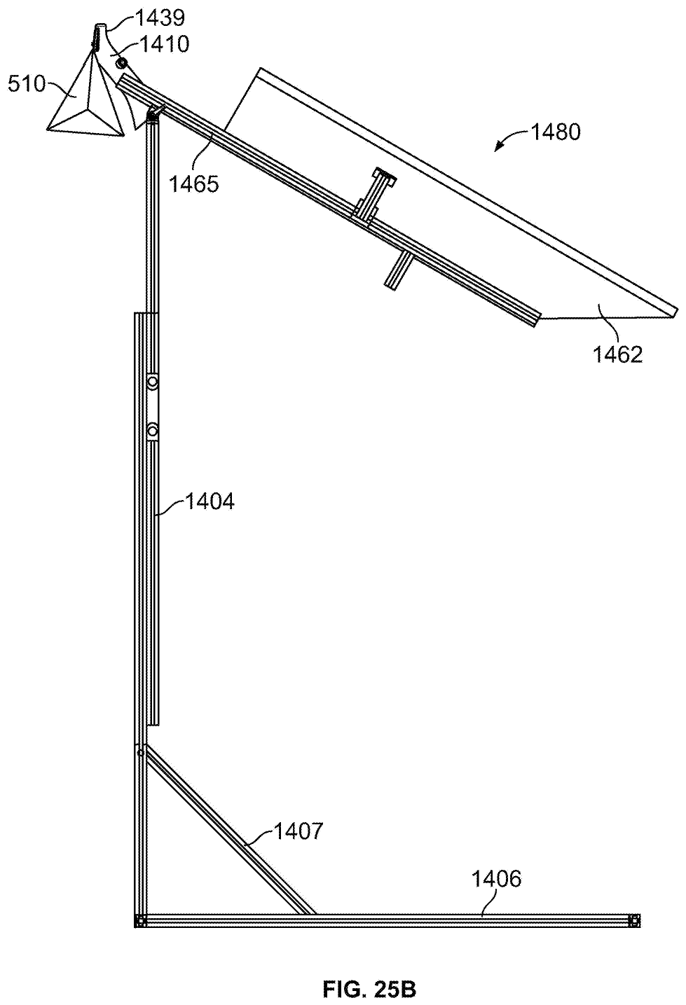

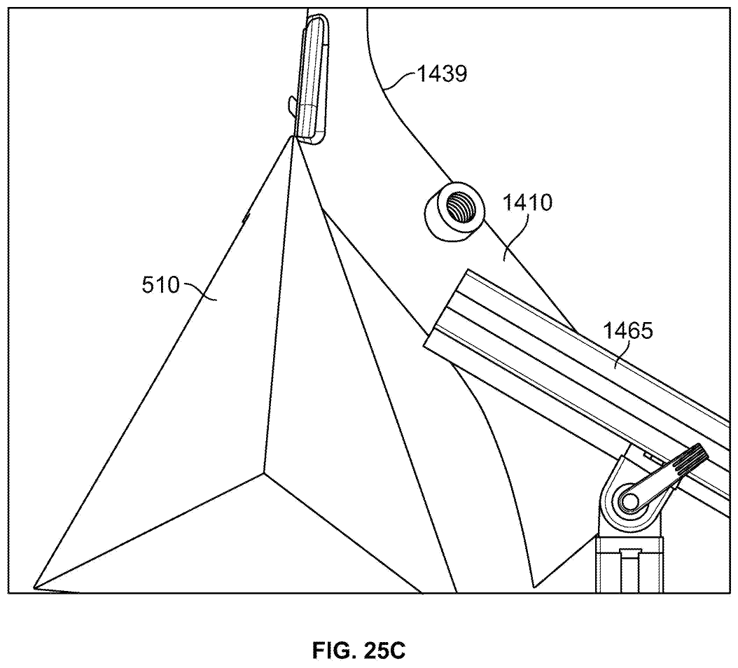

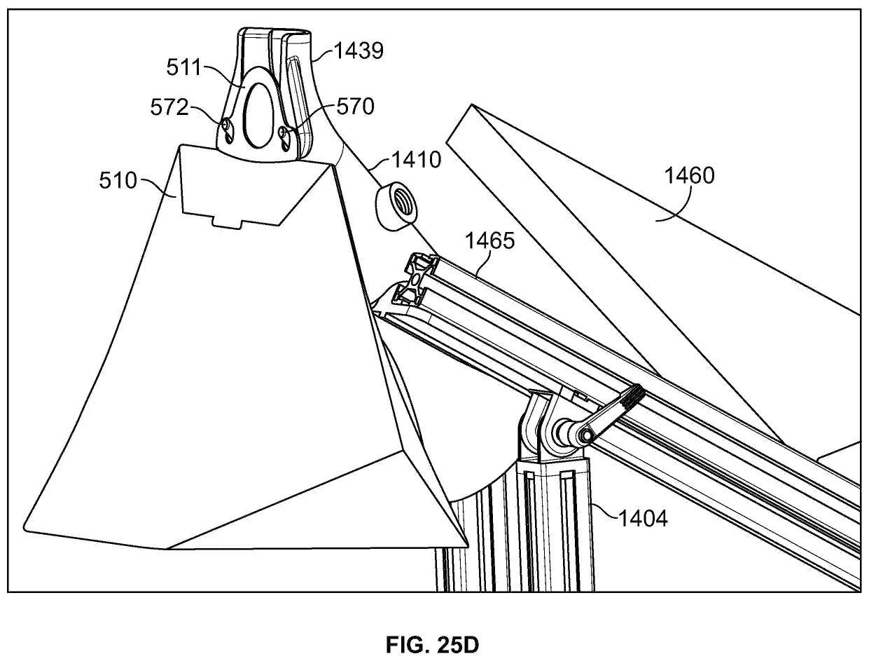

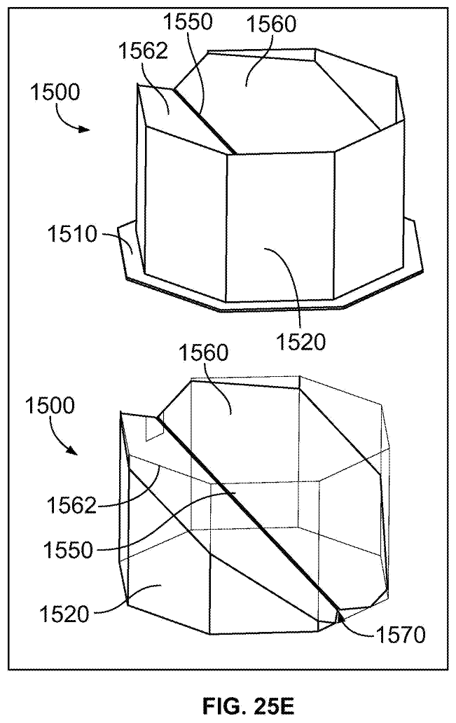

FIG. 25A is a perspective view of payload retrieval apparatus 1480. Payload retrieval apparatus 1480 includes a base 1402 with a cross member 1406 and truss members 1407 and 1408. Upwardly extending member 1404 is attached to base 1402. A first sloped surface 1460 is positioned adjacent second sloped surface 1462 are attached to member 1465 (attached to upwardly extending member 1404) with a tether slot 1450 positioned therebetween. Opening 1470 extends towards a channel positioned on member 1465, or beneath the first and second sloped surfaces 1460 and 1462, which is adapted to receive payload retriever 800. First and second sloped surfaces 1460 and 1462 serve as a funneling system to funnel a payload retriever 800 downwardly towards opening 1470, where a tether 1200 may move the payload retriever 800 into position to extend through opening 1470 into a channel positioned on member 1465, or beneath the first and second sloped surfaces 1460 and 1462, and tether 1200 extends through the tether slot 1450 to draw the payload retriever 800 towards a payload for automated payload retrieval. The payload retriever 800 may land anywhere on either of the first or second sloped surfaces 1460, 1462, and will funnel down until it slides off of the sloped surfaces, where the tether 1200 may be drawn through tether slot 1450 to draw the payload retriever 800 into engagement with the handle 511 of payload 510. First and second sloped surfaces 1460 and 1462 provide a V-shaped funneling system that is downwardly sloped towards opening 1470. It will be appreciated that the sloped surfaces in payload retrieval apparatus 1400 and 1480 may have other configurations and geometries to provide a funneling system for the payload retriever 800. The surfaces may be hard or soft, or even made of netting to reduce wind load. Furthermore, the surfaces are not required to be flat, but could be rounded or concave as well.

In addition, the first and second sloped surfaces 1460 and 1462 are downwardly sloped towards opening 1470 to a channel. The bottoms of the first and second sloped surfaces are also positioned at an angle towards opening 1470. In applications where the payload retriever does not land on either of sloped surfaces 1460 or 1462, the tether 1200 descend in front of opening 1470 and may be drawn towards opening 1470 along the angled lower surfaces of the first and second sloped surfaces 1460 and 1462. The tether 1200 may be drawn, or simply slide, down the angled lower surfaces until the tether 1200 is in front of the tether slot 1450. At this point, the tether 1200 may be drawn through the tether slot 1450, thereby drawing the payload retriever 800 into the channel. It should also be noted that first and second sloped surfaces 1460 and 1462 not only serve to provide a funneling system to funnel the payload retriever 800 towards opening 1470, but also serve to block wind from blowing the payload retriever 800 out of position.

FIG. 25B is a side view of payload retriever apparatus 1480, and includes cross member 1406, truss 1407, and upwardly extending member 1404. Member 1465 extends from upwardly extending member 1404 with second sloped surface 1462 positioned thereon. A channel with a curved portion 1439 is positioned on an end of member 1465, with a payload 510 positioned on curved portion 1439 of the channel. Although the channel is positioned beyond second sloped surface 1462, the channel could also extend beneath second sloped surface 1462.

FIG. 25C is a side view of an end of the payload retrieval apparatus 1480. A channel is shown extending from member 1465 with a payload 510 positioned on curved portion 1439.

FIG. 25D is a perspective view of an end of the payload retrieval apparatus 1480. A channel with a curved portion 1439 is positioned on an end of member 1465, with a payload 510 positioned on curved portion 1439 of the channel. Handle 511 of payload 510 is positioned on pins 570 and 572 extending from curved portion 1439 of the channel.

FIG. 25E shows perspective views of payload retrieval apparatus 1500. Payload retrieval apparatus 1500 includes a base 1510 and upwardly extending side walls 1520. A first sloped surface 1560 is positioned adjacent second sloped surface 1562 are positioned within side walls 1520 with a tether slot 1550 positioned therebetween. Opening 1570 extends towards a channel positioned beneath or near the first and second sloped surfaces 1560 and 1562 which is adapted to receive payload retriever 800. First and second sloped surfaces 1560 and 1562 serve as a funneling system to funnel a payload retriever 800 downwardly towards opening 1570, where a tether 1200 may move the payload retriever 800 into position to extend through opening 1570 into a channel beneath or near the first and second sloped surfaces 1560 and 1562, and tether 1200 extends through the tether slot 1550 to draw the payload retriever 800 towards a payload for automated payload retrieval.

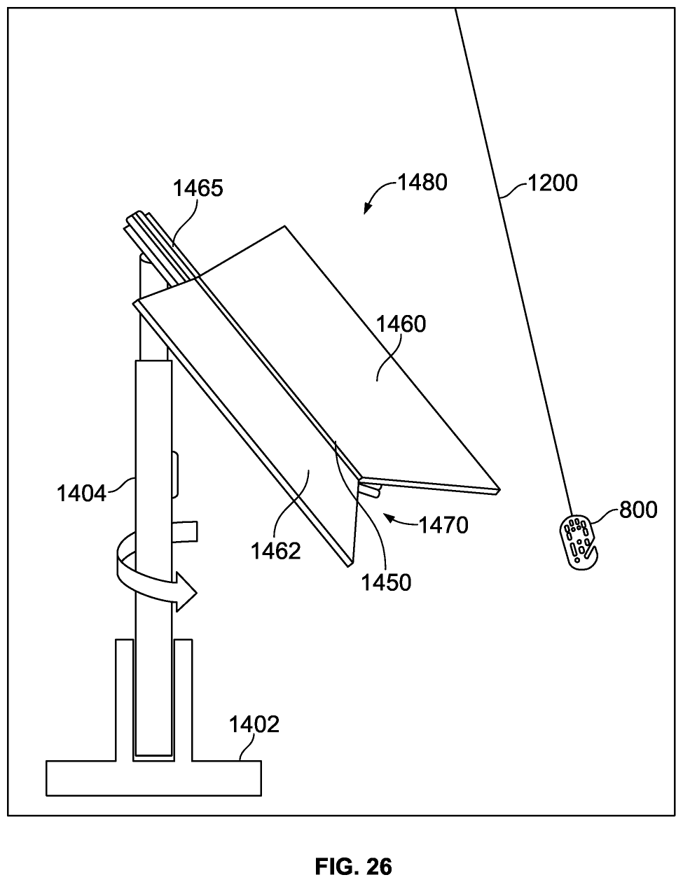

FIG. 26 is a perspective view of payload retrieval apparatus 1480. Member 1465 is rotatable with respect to upwardly extending member 1404 to allow the first and second sloped panels 1460 and 1462 to rotate with the wind such that the stand 1480 is positioned into the wind to reduce the impact of wind on payload retrieval apparatus 1480. As with a non-rotatable payload retrieval apparatus, first and second sloped surfaces 1460 and 1462 not only serve to provide a funneling system to funnel the payload retriever 800 towards opening 1470, but also serve to block wind from blowing the payload retriever 800 out of position.

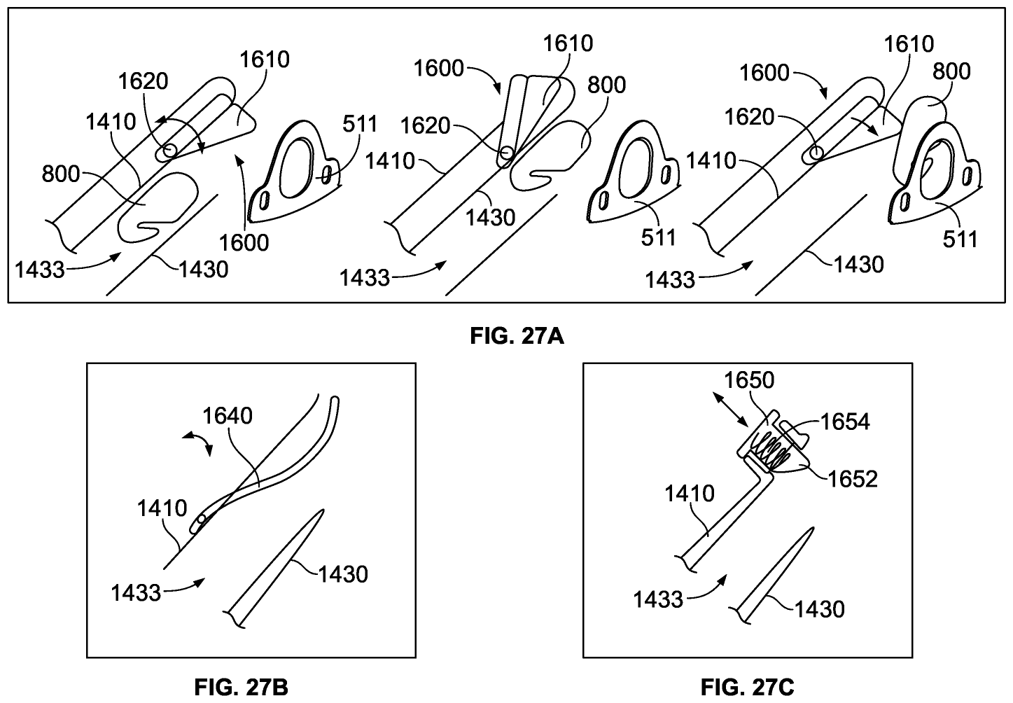

FIG. 27A shows perspective views of rotational spring loaded pusher 1600. Rotational spring loaded push 1600 is positioned near the end of channel 1433 formed between edges 1410 and 1430, with edge 1430 having a shorter length than edge 1410. As the payload retriever 800 exits the channel 1433, the spring loaded pusher 1600, rotatable about pivot point 1620, includes a cam 1610 that initially comes into contact with a top surface of payload retriever 800. As payload retriever 800 exits channel 1433, the spring loaded cam 1610 pushes against a bottom of the payload retriever 800, to force lip 806 of payload retriever 800 forward into engagement with handle 511 of payload 510.

FIG. 27B shows a side view of leaf spring 1640. Leaf spring 1640 operates in a similar manner to rotational spring loaded pusher 1600. As payload retriever 800 exits channel 1433, the leaf spring 1640 pushes against a bottom of the payload retriever 800, to force lip 806 of payload retriever 800 forward into engagement with handle 511 of payload 510. The leaf spring 1640 may be a separate metal spring, or molded-in plastic tabs that deform to impart a spring force on the payload retriever 800.

FIG. 27C shows a side view of linear spring plunger 1650. Linear plunger 1650 includes spring 1654 and protrusion 1652. Linear spring plunger 1650 operates in a similar manner to rotational spring loaded pusher 1600 and leaf spring 1640. As payload retriever 800 exits channel 1433, the protrusion 1652 of linear spring plunger 1650 pushes against a bottom of the payload retriever 800, to force lip 806 of payload retriever 800 forward into engagement with handle 511 of payload 510.

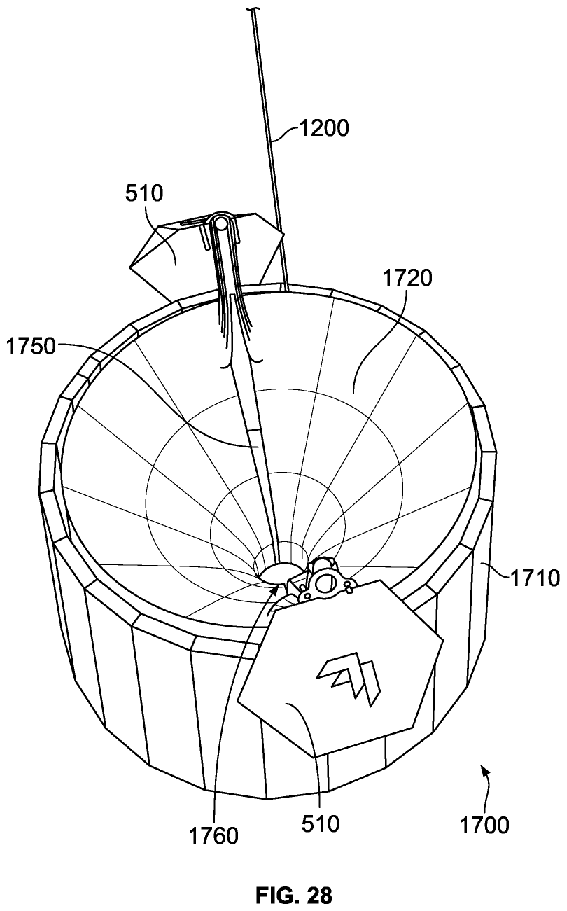

FIG. 28 is a perspective view of payload retrieval apparatus 1700. Payload retrieval apparatus 1700 provides a bowl-shaped funneling system 1720. A payload retriever 800 descends onto the funneling system 1720 and slides down through lower opening 1760. The tether 1200 attached to the payload retriever is drawn through tether slot 1750 until payload retriever connects with handle 511 of payload 510 to secure the payload 510 to payload retriever 800 for removal of payload 510 from the payload retrieval apparatus 1700. Advantageously, payload retrieval apparatus 1700 may accommodate multiple payloads 510. As shown in FIG. 28, one payload 510 is positioned in a northern position and another payload 510 is shown in a southern position. A second tether slot may be provided for access to the southern payload 510 such that the payload retriever 800 may travel beneath tether slot 1750 to the northern payload 510, or beneath the second tether slot to pick up the southern payload 510. Additional payloads could also be provided on payload retrieval apparatus 1700. For example, eastern and western payloads could be included with corresponding eastern and western tether slots.

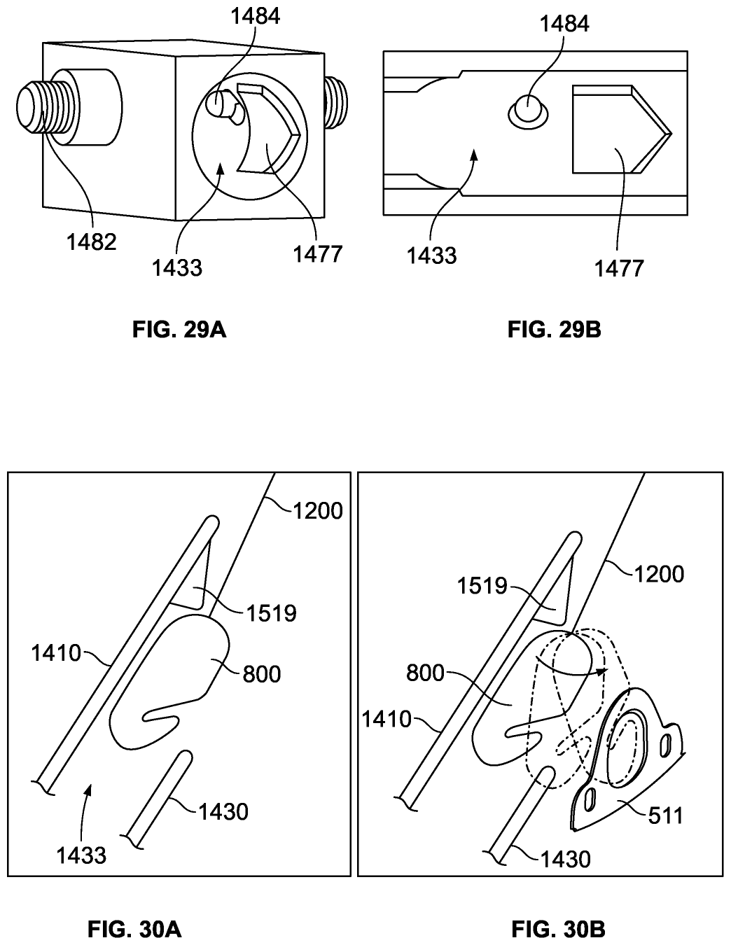

FIGS. 29A-B show perspective and side views of spring loaded plunger pin 1484. Spring loaded plunger 1484 extends into channel 1433, along with an oppositely disposed plunger pin (not shown). As a payload retriever 800 comes into contact with plunger pin 1484, the payload retriever 800 is rotated into a desired position such that the lip 806 of the payload retriever is properly positioned to engage with an opening in the handle 511 of the payload upon exiting the channel 1433.

FIGS. 30A-B show side views of protrusions 1519. Protrusions 1519 operate in a similar manner to rotational spring loaded pusher 1600, leaf spring 1640, and linear spring plunger 1650 shown in FIGS. 27A-C. As payload retriever 800 exits channel 1433, the protrusions 1519 push against a bottom of the payload retriever 800, to force lip 806 of payload retriever 800 forward into engagement with handle 511 of payload 510.

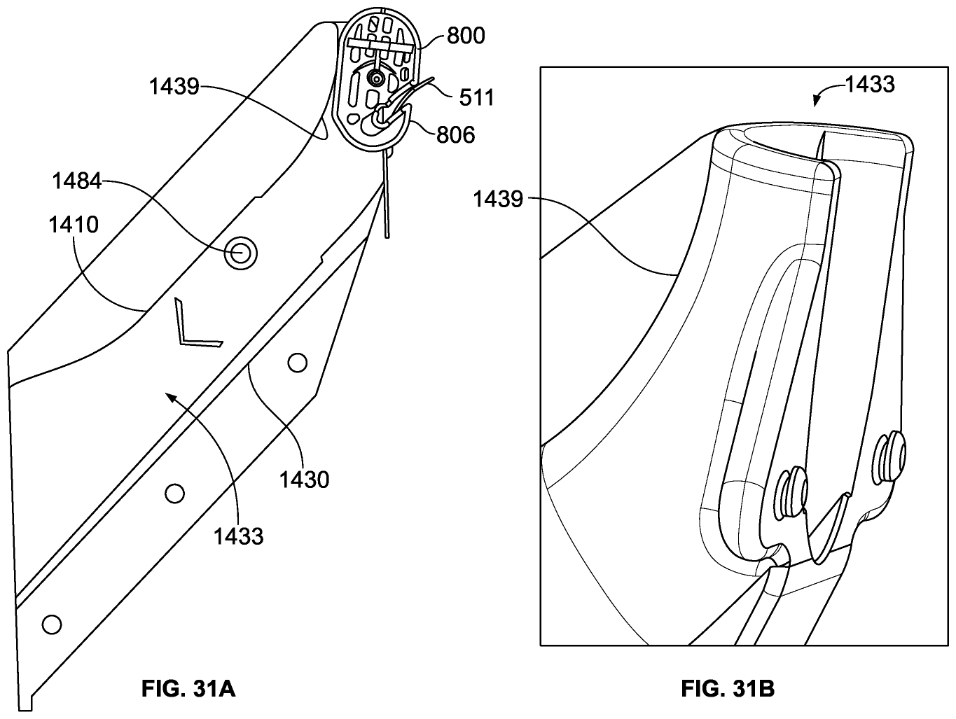

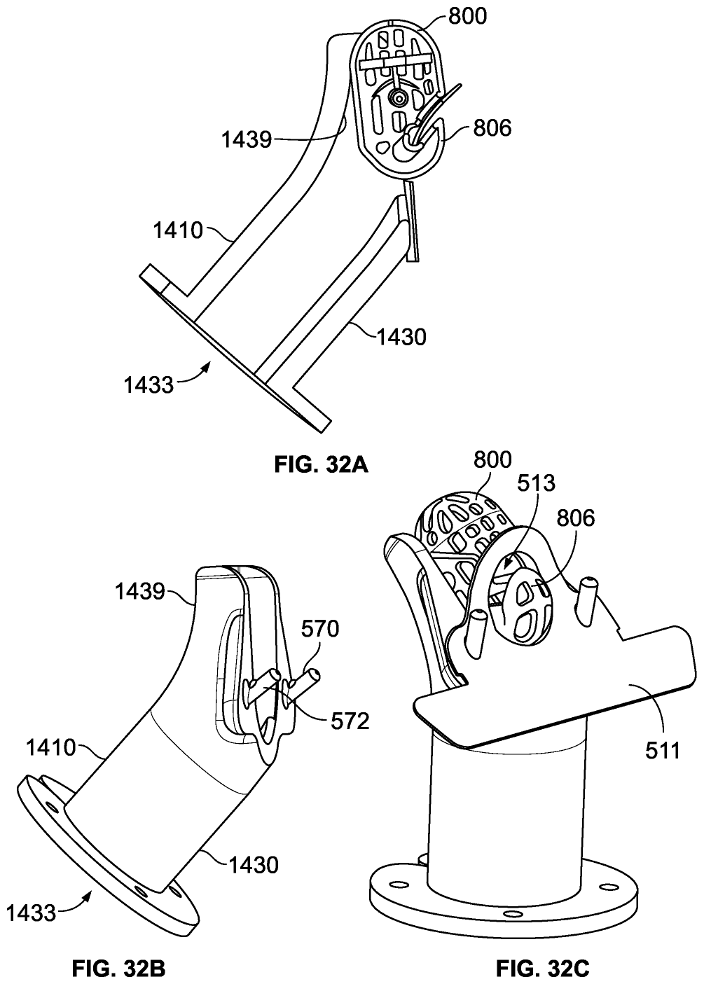

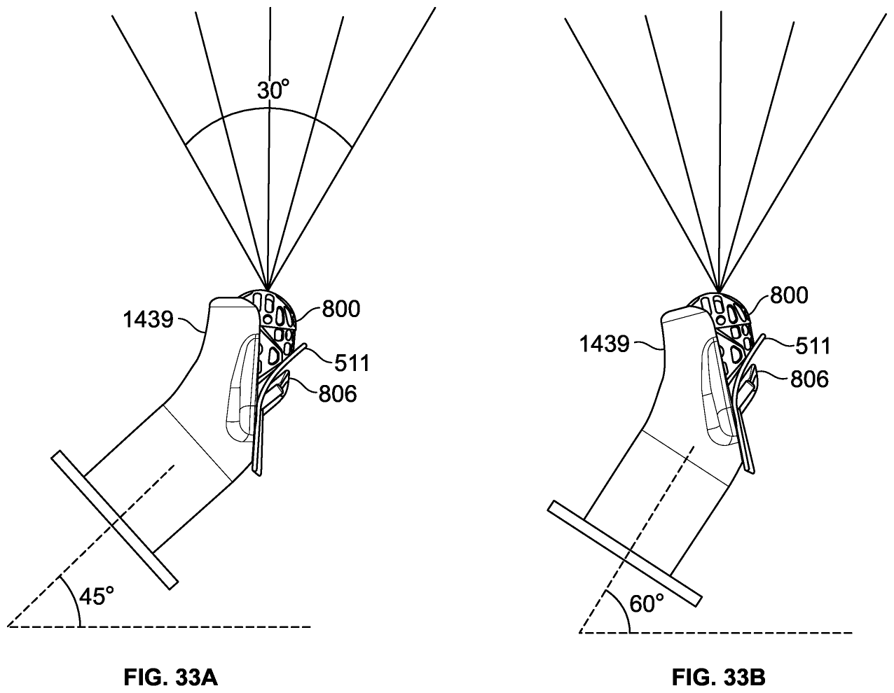

FIGS. 31A-B show side and perspective views of curved portion 1439, FIGS. 32A-C show side and perspective view of curved portion 1439, and FIGS. 33A-B show perspective views of curved portion 1439. Channel 1433 between edges 1410 and 1430 ends with a curved portion 1439. Payload retriever 800 initially travels through channel 1433 along centerline of the channel. However, curved portion 1439 changes the angle of exit of payload retriever 800 from channel 1433. Curved portion 1439 provides significant advantages over an entirely straight channel. The curved portion 1439 at the end of the channel 1433 angles the payload retriever 800 upon exiting the channel 1433 to have the payload retriever 800 “lean back” such that the lip 806 of the payload retriever 800 extends towards the opening 513 in the handle 511 of the payload 510. The curved portion 1439 also allows for a top of the payload retriever 800 to contact the handle 511 such that a portion of the handle 511 over the opening 513 in the handle 511 contacts the payload retriever 800 and the portion over the opening 513 slides down the payload retriever 800 until the lip 806 of the payload retriever 800 extends into the opening 513 in the handle 511 of the payload 510.

In FIG. 32B, payload holder in the form of extending pins 570 and 572 are shown. In FIG. 32C, handle 511 of the payload 510 is shown positioned on extending pins 570 and 572. Lip 806 of payload retriever 800 is shown extending through opening 513 in handle 511. The handle 511 of the payload 510 itself may act as a spring upon entry of the lip 806 into the opening of the handle 511 of the payload 510 to rotate the payload retriever 800 into the proper position. For example, if the rotational position of the payload retriever 800 is off somewhat, then the handle 511 of the payload 510 itself may act to rotate the payload retriever 800 into its desired rotational position. FIGS. 33A and 33B illustrate that the angle of the channel may be altered, for example, between 45 and 60 degrees. The change in angle of the channel can also provide for the positioning of the lip 806 of the payload retriever 800 to be in an improved position for the lip 806 to extend into an opening 513 in the handle 511 of a payload 510. In particular, when the channel is at a 60 degree angle, the lip 806 of the payload retriever 800 extends further outwardly to extend through the opening in handle 511 of the payload 510.

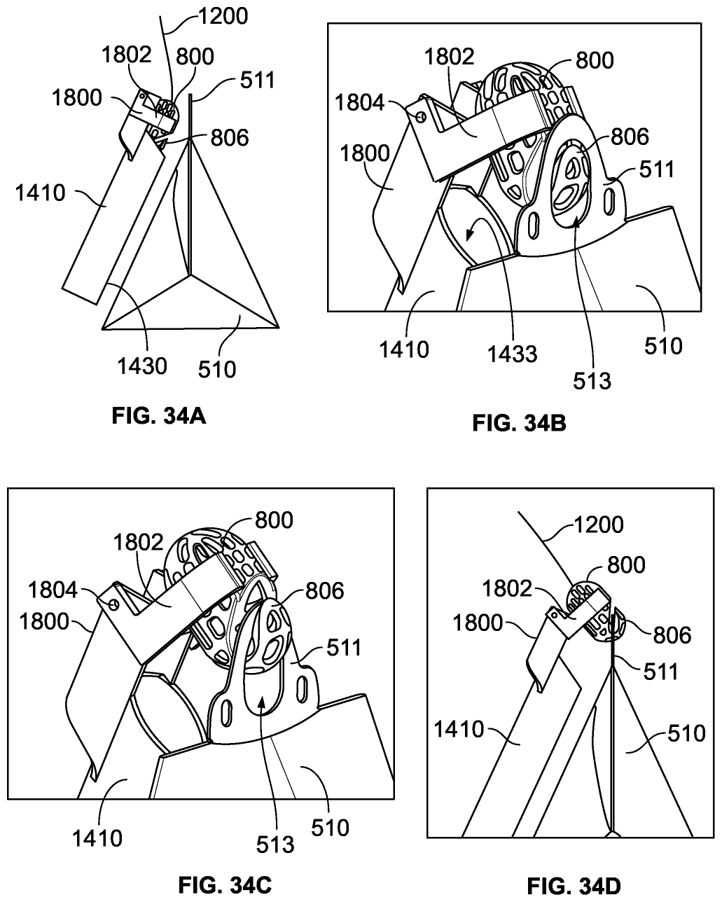

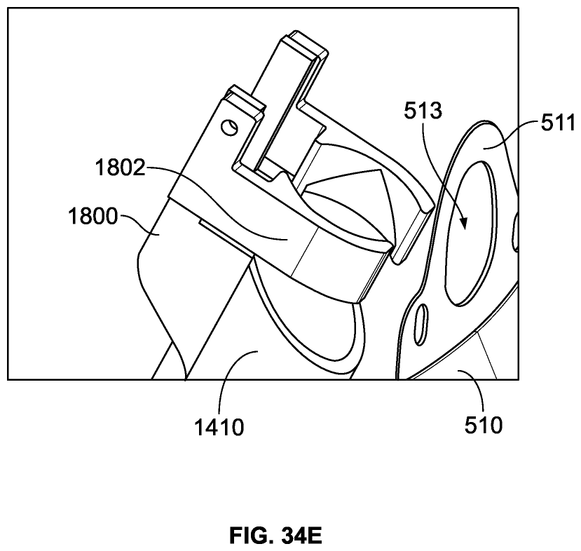

FIGS. 34A-E show various perspective views of pivoting carriage 1800. Pivoting carriage 1800 includes payload retrieval holder 1802 that pivots about pivot 1804. Pivoting carriage 1800 uses payload retrieval holder 1802 to hold payload retriever 800. Payload retrieval holder 1802 pivots downwardly about pivot 1804 to place lip 806 of payload retriever through opening 513 in handle 511 of payload 510. After the payload retriever 800 is secured to handle 511 of payload 510, the payload retriever 800 may be removed from the payload retriever holder 1802 to remove payload 510 from its position.

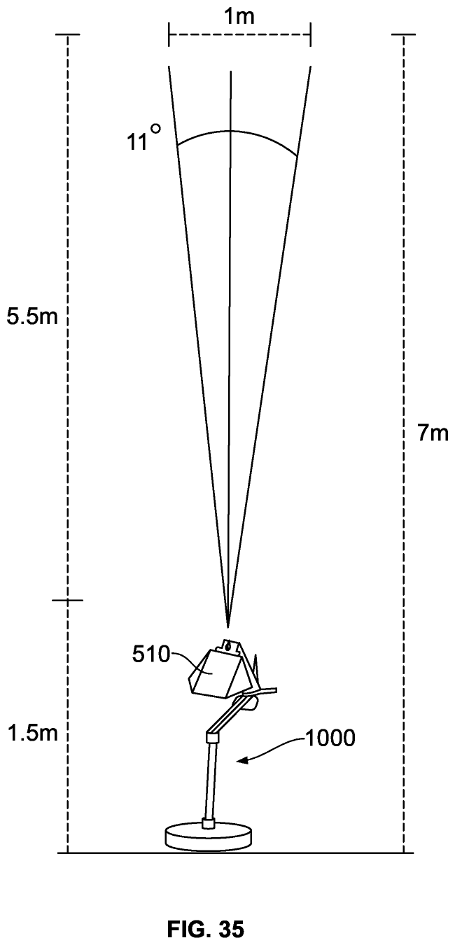

FIG. 35 illustrates that a UAV positioned at 7 meters above the ground may be used to allow a payload retriever 800 to remove payload 510 from a payload retrieval apparatus such as payload retrieval apparatus 1000 shown in FIG. 35.

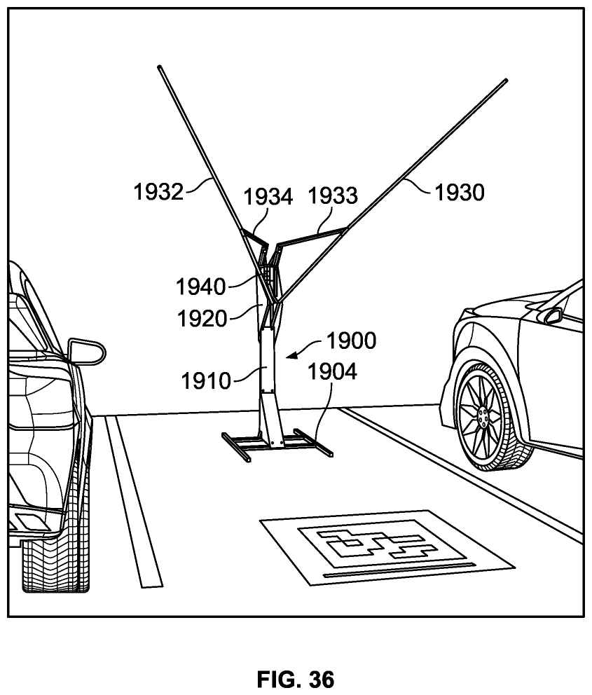

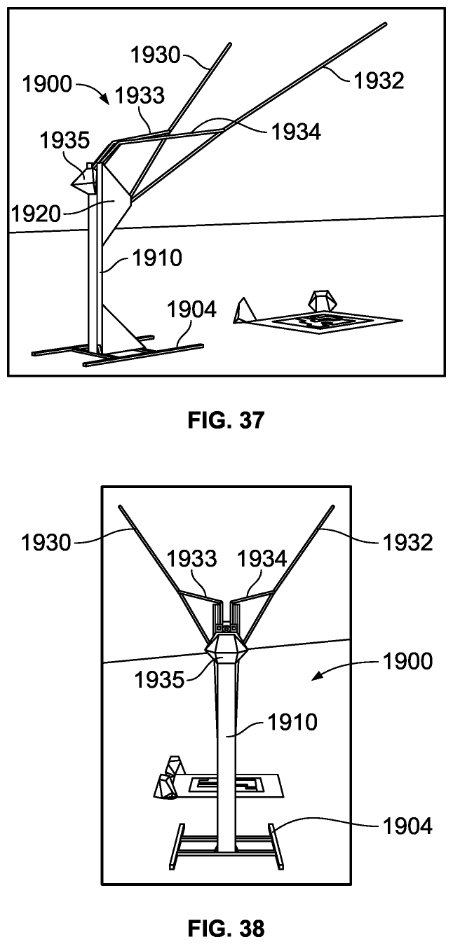

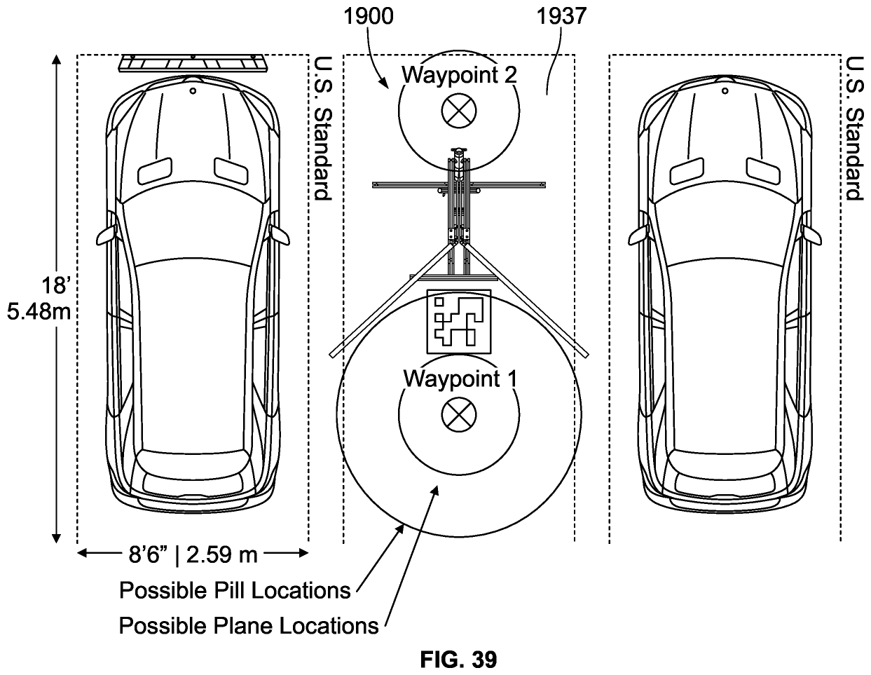

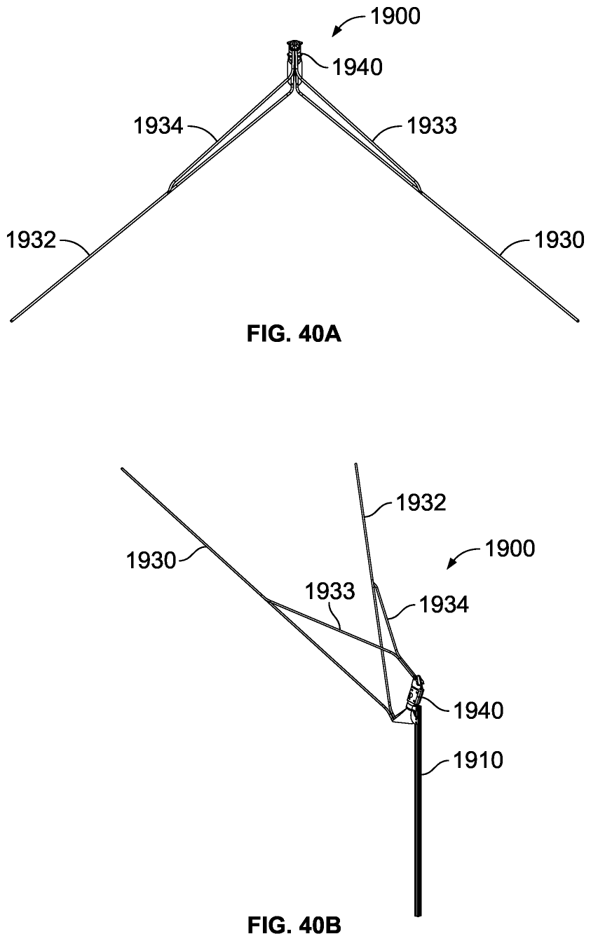

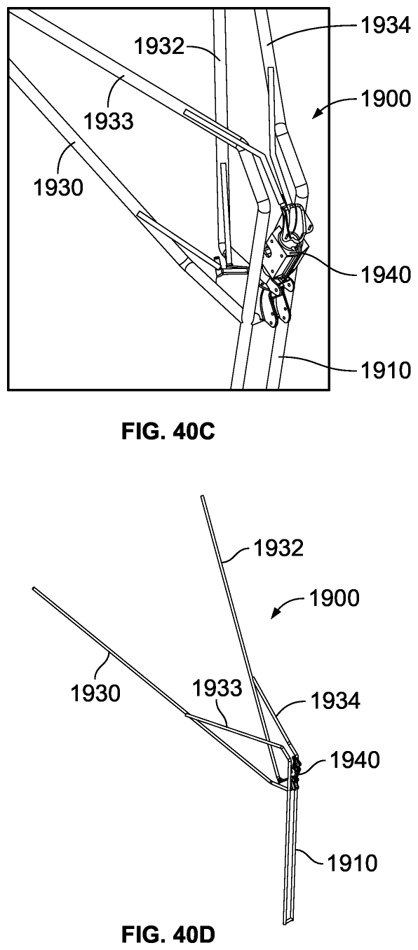

FIGS. 36-40D shows various views of payload retrieval apparatus 1900. Payload retrieval apparatus 1900 is used for automated payload pickup using a UAV. A payload 1935 is positioned on a payload holder on a rear end of payload retrieval apparatus 1900. Payload retrieval apparatus 1900 includes base 1904, upwardly extending member 1910, and a payload coupling apparatus channel 1940 housed within enclosure 1920. Payload retrieval apparatus 1900 also includes tether engagers 1930 and 1932 which are used to engage a tether attached to a payload coupling apparatus, whereafter the payload coupling apparatus is drawn into and through the payload coupling apparatus channel 1940 to pick up payload 1935. Tether engager 1930 includes member 1933 which provides mechanical support for tether engager 1930, and provides other functions. In the same manner, tether engager 1932 includes member 1934 which provides mechanical support for tether engager 1932, and provides other functions. Payload retrieval apparatus 1900 provides for automated pickup of payload 1935, and may operate in the same or a similar manner as payload retrieval apparatuses 1000 and 1480 described above.

Tether engager 1930 includes an upper guide member 1933 that is configured to help maintain the end of the tether in a substantially vertical orientation as the payload coupling apparatus is drawn through the payload coupling apparatus channel 1940. With the inclusion of upper guide member 1933, tether engager 1930 includes both an upper edge and a lower edge for guiding the tether as the payload coupling apparatus is received and drawn through the payload coupling apparatus channel 1940. The lower edge is formed by the primary member of tether engager 1930 and extends toward a receiving end of payload coupling apparatus channel 1940. Accordingly, the lower edge of tether engager 1930 directs a portion of the tether that is near the payload coupling apparatus to the receiving end of the channel 1940.

The upper guide member 1933, on the other hand, extends toward payload coupling apparatus channel 1940 at an elevated height compared to the lower edge formed by the primary member of tether engager 1930. This allows the upper guide member 1933 to engage a portion of the tether that is spaced from the payload coupling apparatus at a position that is elevated above the channel 1940. Accordingly, when the payload coupling apparatus is within the channel 1940, the direction of the portion of the tether that extends upward from the channel 1940 will be substantially vertical. Thus, even if the UAV is laterally offset from the position of the payload retrieval apparatus 1900, such that most of the length of the tether extending between the UAV and the payload retrieval apparatus 1900 is at substantial angle, the end portion of the tether that extends from the channel 1940 will maintain a substantially vertical orientation. With this end portion of the tether in a substantially vertical orientation, the tension on the tether as it is retracted can effectively pull the payload coupling apparatus through the payload coupling apparatus channel 1940.

Similar to tether engager 1930, tether engager 1932 also includes an upper guide member 1934 with a similar configuration that is operable to maintain an end portion of the tether in a substantially vertical orientation.

In addition to helping maintain the orientation of the tether, the upper guide members 1933, 1934 may also provide structural support to the respective tether engagers. For example, because of the inclusion of upper guide member 1933 in tether engager 1930, the tether engager 1930 is secured to upwardly extending member 1910 at two independent points. The primary member of tether engager 1930 is secured to the upwardly extending member 1910 at a lower position and the upper guide member 1932 is secured to the upwardly extending member 1910 at an upper position. Furthermore, a triangular frame is formed between the upwardly extending member 1910, the primary member of tether engager 1930, and the upper guide member 1932, which provides a strong support structure for tether engager 1930.

While tether engager 1930, as shown in FIGS. 36-40D, is formed as a frame, such that upper guide member 1933 is formed as a second pole or rod that extends at an angle from the primary member (or pole) of tether engager 1930, other configurations are possible. For example, in some embodiments, the tether engager may be formed by a similarly shaped structure with a continuous surface for guiding the tether. In such an embodiment, a lower edge of the tether engager may provide a lower guide, while an upper edge of the tether engager may form the upper guide member that maintains the substantially vertical orientation of the tether, as described above.

FIG. 39 illustrates that payload retrieval apparatus 1900 may advantageously be sized to span only a single parking space 1937.

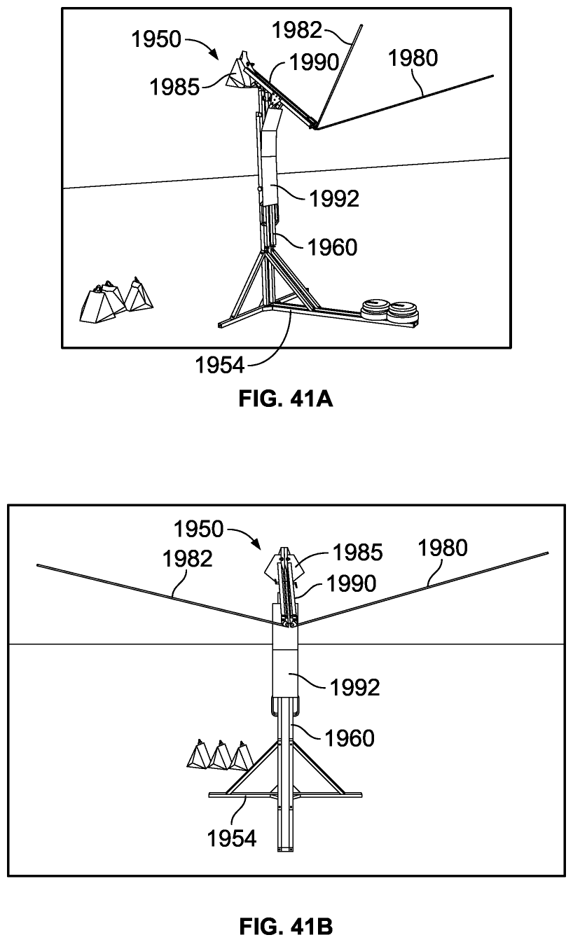

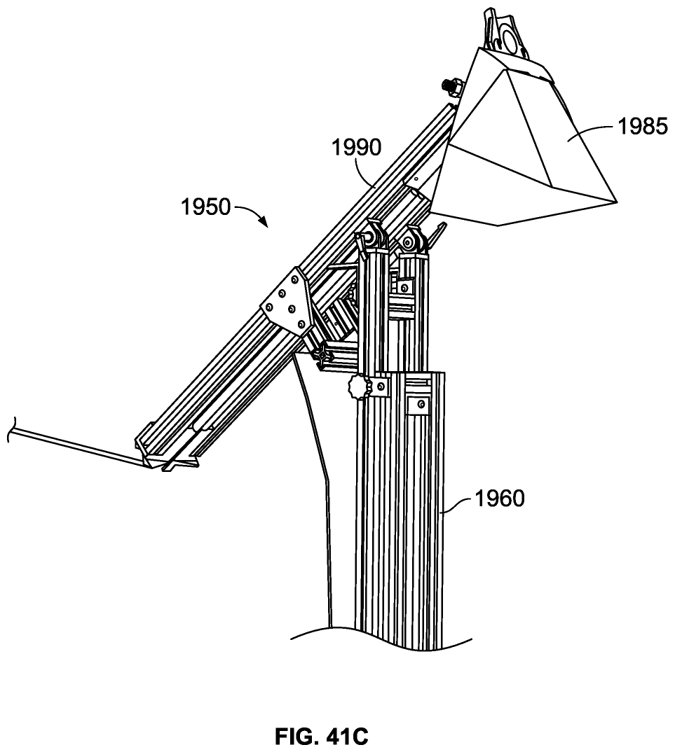

FIGS. 41A-C show various views of payload retrieval apparatus 1950. Payload retrieval apparatus 1950 operates in a manner similar to payload retrieval apparatus 1900. Payload retrieval apparatus 1950 includes base 1954, upwardly extending member 1960, and a payload coupling apparatus channel 1990. Payload retrieval apparatus 1950 also includes tether engagers 1980 and 1982 which are used to engage a tether attached to a payload coupling apparatus, whereafter the payload coupling apparatus is drawn into and through the payload coupling apparatus channel 1990 to pick up payload 1985. Payload coupling apparatus channel 1990 may include a guiding member with a tether slot which the payload coupling apparatus rides beneath until it is drawn into a curved portion of the payload coupling apparatus channel 1990 attached to the guiding member. Payload retrieval apparatus 1950 is shown with a shield 1992 which helps to prevent the payload coupling apparatus from getting tangled with the frame of the payload retrieval apparatus 1950. Payload retrieval apparatus 1950 provides for automated pickup of payload 1985, and may operate in the same manner as payload retrieval apparatuses 1000 and 1480 described above.

### X. Example Methods of Payload Pickup

To achieve a passive solution for automatic loading of packages (i.e., no power) a UAV may be configured to perform a lateral maneuver after deploying the tether to engage the tether with an autoloader device, such as any of the previously described payload retrieval apparatuses. Additionally, building the autoloader device to accommodate the nominal navigation accuracy of a UAV system when outside the nest may result in an impractically large footprint. For this reason, in some examples, the autoloader device may be outfitted with a fiducial marker with a known position relative to the apparatus itself to enable navigation of the UAV relative to the autoloader device. Another source of potential pickup mechanism position uncertainty is wind. This can cause up to several meters of deflection when the tether is fully deployed from a height of 6.8 meters in high winds. Examples described herein therefore may also compensate for wind in order to hit footprint targets for an autoloader apparatus.

In some examples described herein, a UAV may initially descend for pickup and scan for fiducials associated with an autoloader device of interest as encoded in a pickup waypoint. Once observed, the UAV may maneuver itself to be directly over a payout position, plus any lateral offset to compensate for wind. At 6.8 meters over the payout position, the UAV may deploy the tether. Once the tether is fully deployed, the vehicle may maneuver laterally to a winch up position. At this point, the vehicle may optionally remove its windage offset. Once in winch up position, the UAV may retract the tether. Once sufficiently retracted, the UAV may ascend and de-nudge, rejoining the cruise segment at the nominal pickup waypoint position.

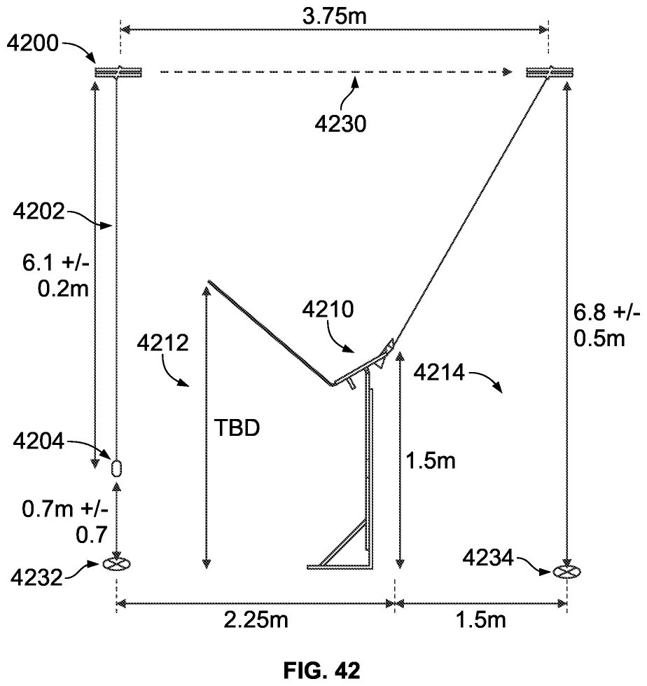

FIG. 42 illustrates an autoloader device and a UAV side-step trajectory, in accordance with examples described herein. More specifically, a UAV 4200 may be equipped with a deployable tether 4202 for payload pickup. The tether 4202 may have a pickup component 4204 in order to enable the UAV 4200 to pickup a payload. In examples described here, this pickup may be achieved without human user assistance with help of an autoloader device 4210.

The autoloader device 4210 may have an approach side 4212 from which the UAV 4200 may approach in order to engage a payload held by the autoloader device 4210 using the tether 4202 and the pickup component 4204. In order to engage the autoloader device 4210, the UAV 4200 may be controlled to move through a side-step trajectory 4230. The side-step trajectory 4230 may start with the UAV 4200 positioned to deploy the tether 4202 and the pickup component 4204 to the payout position 4232 located on a ground surface. The UAV 4200 may then be controlled to follow a lateral movement through side-step trajectory 4230 to reach a position above end position 4234. While moving through the side-step trajectory 4230, the tether 4202 and pickup component 4204 may engage with the autoloader device 4210 in order to pick up a payload held by the autoloader device 4210. In some examples, the pickup logic also includes handlings of pickup component 4204 being wrapped around the autoloader device 4210 or just stuck in general during the side-step maneuver. In these circumstances, slack may be provided and the winch may be retried one or more times. If the pickup component 4204 is still not freed, the pickup component 4204 may be abandoned and disconnected from the UAV.

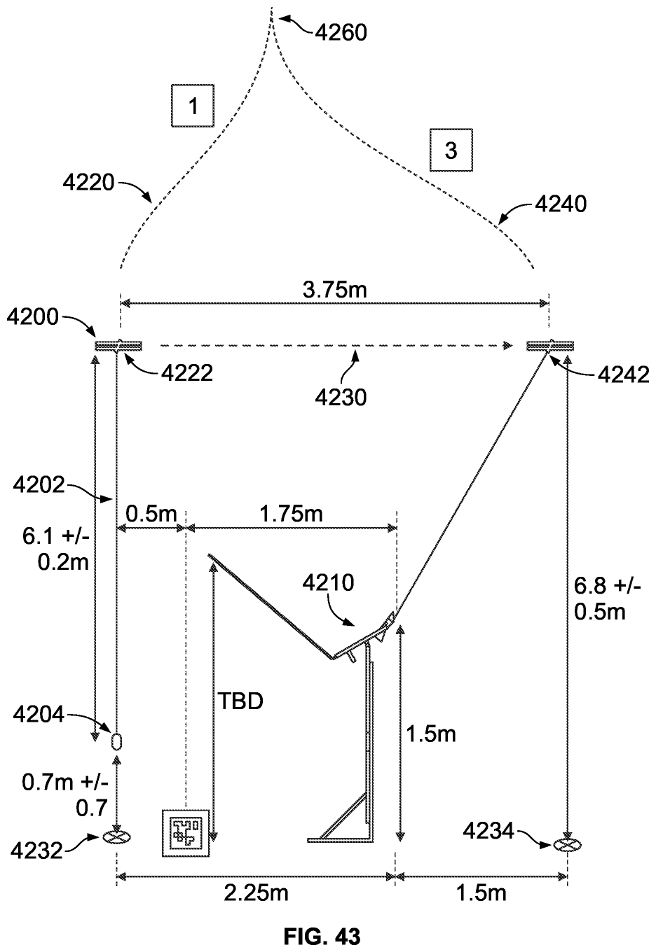

FIG. 43 illustrates an autoloader device and a sequence of UAV trajectories, in accordance with examples described herein. More specifically, the guidance offset during pickup follows a trajectory with three main segments. Each segment may have specific entry and exit position values, as well as associated slew rates. The slew rates limit the rate at which the UAV can change horizontal position to allow the UAV to gracefully move between positions.

Starting from starting position 4260, the UAV 4200 may follow a descent trajectory 4220 to a first nudged position 4222. Determination of the first nudged position 4222 may be based on detection of a fiducial marker 4250. The fiducial marker 4250 may be oriented in a direction towards autoloader device 4210. The UAV 4200 may be controlled to descend over a payout position 4232, which may be a predetermined offset (e.g., 0.5 meters) to the approach side of the autoloader device 4210. In some examples, initial deployment may use a vector fixed in the “autoloader frame”. In some examples, an additional wind-driven offset may be generated to accommodate pill-swing between the first nudged position 4222 and the payout position 4232 under locally-observed wind conditions.

After reaching first nudged position 4222, the UAV 4200 may deploy the tether 4202 and pickup component 4204. The marker-relative guidance offset may then be controlled to fade at a specific slew rate from the approach side to the load side of the autoloader device 4210. Starting from first nudged position 4222, the UAV 4200 may follow a side-step trajectory 4230 as previously described in order to cause the tether 4202 and pickup component 4204 to pick up a payload from the autoloader device 4210. The vertical guidance may be controlled to remain at a fixed position during this time. The side-step trajectory 4230 may end at a second nudged position 4242. The second nudged position 4242 may be at a predetermined offset (e.g., 3.25 meters) past the load side of the autoloader device 4210.

When the side-step trajectory 4230 is complete, the UAV 4200 may retract the tether 4202 and pickup component 4204. In some examples, the UAV 4200 may linger for a few seconds to allow the pickup component 4204 to settle before retracting the tether 4202. After the tether 4202 is fully retracted or a predetermined timeout window has passed, the UAV 4200 may then be controlled to follow ascent trajectory 4240 from the second nudged position 4242 back to the starting position 4260, or to another convenient exit position. The ascent trajectory 4240 will fade the side-step value of the guidance offset to zero, thereby effectively reversing the change in lateral position resulting from the first nudged position 4222 and the second nudged position 4242. After returning to starting position 4260, the UAV 4200 may then continue navigation from the same previously traversed starting position 4260, but now with a payload picked up from the autoloader device 4210.

In some examples, the ascent trajectory 4240 can cause the payload pickup. The tether may then be retracted afterwards. This gives the added benefit of a cleaner retract without a pill computer interaction and thus a potentially better weight estimate.

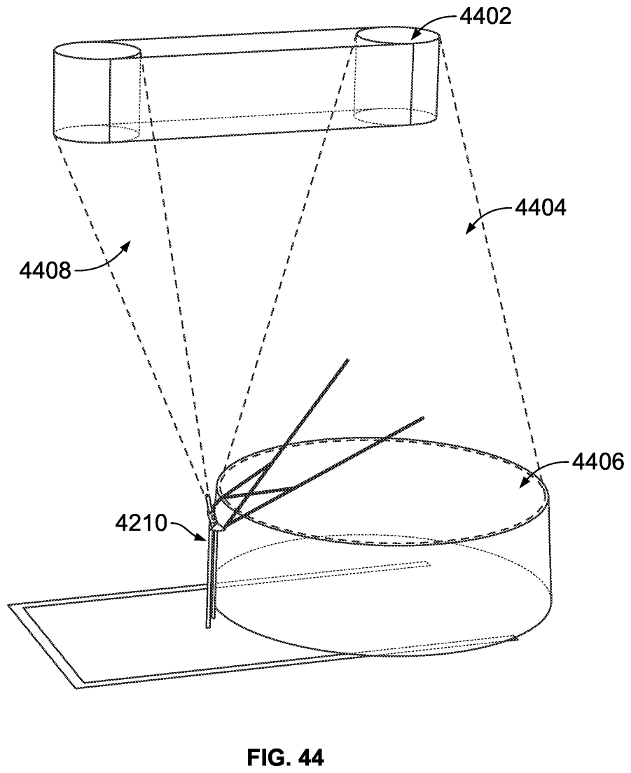

FIG. 44 illustrates a UAV mission profile and tolerances, in accordance with examples described herein. More specifically, potential regions for a UAV and/or UAV components relative to autoloader device 4210 are illustrated based on expected error tolerances. A first region 4402 illustrates potential UAV locations in view of potential localization/navigation errors. A second region 4404 illustrates potential tether locations after payout in view of wind conditions. A third region 4406 illustrates potential pickup component positions in view of the potential tether locations. A fourth region 4408 illustrates possible tether locations before pickup. Potential error tolerances represented by each region may be considered collectively to determine an appropriate UAV trajectory to ensure successful pickup from the autoloader device 4210. Notably determining the exact positioning of the second nudged position is not trivial and may need to account for package attachment success, package swing, wind compensation, and/or positional error.

Some systems may generally assume that a pickup component will hang directly below the UAV, which becomes an inaccurate assumption in the presence of winds as illustrated by FIG. 44. While some amount of pickup component movement can be absorbed into the noise level of the system, at the high end of the wind operating envelope, the amount of uncertainty from pickup component swing may be too large to absorb. Accordingly, it may be necessary to characterize wind speed and/or direction to make necessary accommodations.

Wind speed and/or direction may be determined based on and/or using a pitot tube, an anemometer, GPS, measured UAV air velocity, and/or measured UAV ground velocity, among other possibilities. For example, the UAV may be equipped with one or more pitot tubes, and/or one or more anemometers, each of which may be configured to generate sensor data indicative of a wind speed along one or more directions.

In another example, the wind speed and/or direction may be determined by comparing an air velocity of the UAV to a ground velocity of the UAV. The air velocity of the UAV (i.e., how quickly, and in what direction, the UAV is moving relative to the air) may be determined based on, for example, an amount of propulsion exerted by rotors of the UAV and/or air speed sensors on the UAV. Visual odometry and/or GPS data may be used to determine a ground velocity of the UAV (i.e., how quickly, and in what direction, the UAV is moving relative to the ground). The air velocity may be compared to the ground velocity to determine a wind velocity present in the environment of the UAV. For example, when a forward ground speed exceeds a forward air speed (i.e., the UAV is flying with a tail wind), a magnitude of the difference may indicate a wind speed in the forward direction. When a sideways ground speed exceeds a sideways air speed (i.e., the UAV is facing a cross wind), a magnitude of the difference may indicate a wind speed in the sideways direction.

In some implementations, the wind speed and/or direction may be determined by a model based on a plurality of different wind measurements obtained from a plurality of different sources. For example, the model may be configured to generate a final wind speed and/or direction measurement based on a combination of (i) sensor data generated by one or more wind sensors (e.g., pitot tubes) on the UAV and (ii) an estimate of the wind speed and/or direction determined based on comparing the air velocity of the UAV to the ground velocity of the UAV. The combination may be implemented using, for example, a weighted average, and/or a Kalman filter, among other possibilities

The measured wind speed and/or direction may be used to determine a position of a tethered pickup component of the UAV relative to a position of the UAV. Specifically, due to the tether being flexible, the pickup component may be displaced by the wind laterally relative to the UAV. Thus, when the pickup component is targeted to be positioned at a particular lateral location in the environment, a lateral position of the UAV may be adjusted accordingly to compensate for the wind-induced horizontal displacement of the pickup component relative to the UAV. Further, while a given length of the tether is deployed, the lateral displacement of the pickup component may also be associated with a vertical displacement of the pickup component due to the given tether length now having a horizontal component and a vertical component. Thus, when the pickup component is targeted to be positioned at a particular vertical location, a deployed length of the tether may be adjusted accordingly to compensate for the wind-induced vertical displacement of the pickup component relative to the UAV. Accordingly, nudge positions of the UAV may be based on the wind-induced displacements of the pickup component relative to the UAV, such that the nudge positions cause the pickup component to engage with the autoloader device.

The wind-induced displacements of the pickup component relative to the UAV may be determined using a mathematical model of the tether and pickup component. For example, the mathematical model may be expressed as Oₓ=kₓV_{WIND x}² and O_{z}=k_{z}V_{WIND z}², where O represents the offset of the pickup component, k represents a model-based constant, V represents the wind speed, x denotes the lateral direction (i.e., forward, backward, leftward, or rightward), and z denotes the vertical direction (i.e., up or down). Thus, the wind-induced displacements of the pickup component relative to the UAV may be modeled as a product of a model-based constant and a quadratic wind velocity term.

The value of the model-based constant k may be determined using a physics-based model of the tether and pickup component. For example, the pickup component may be modeled as a point mass with a corresponding drag coefficient. Similarly, the tether may be assumed to be perfectly flexible and have a uniform mass per unit length, and may be modeled as a series of point masses, each of which has a corresponding mass and drag coefficient based on a diameter of the tether. For each point mass, an angle of the point mass relative to the UAV may be individually determined based on the mass thereof, the distance thereof relative to the UAV, and the drag coefficient thereof. A total deflection profile of the entire tether and pickup component may be determined by taking an integral of the angle of each point mass along the length of the tether.

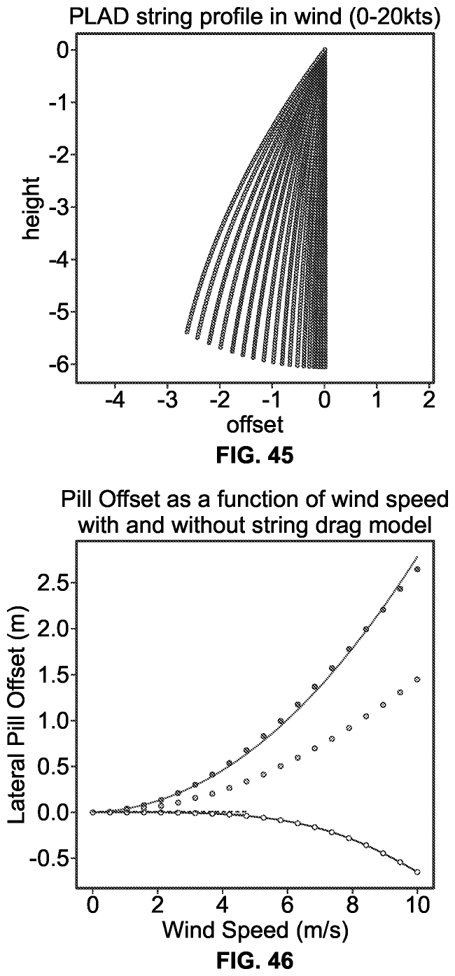

FIG. 45 illustrates a plurality of different deflection profiles of the tether and pickup component corresponding to a plurality of different wind speeds. Specifically, FIG. 45 illustrates twenty one different deflection profiles corresponding to wind speeds ranging from 0 knots (rightmost profile) to 20 knots (leftmost profile) in 1 knot increments. Location (0,0) at the top of FIG. 45 represents the point on the UAV from which the tether is deployed. As can be seen from FIG. 45, wind causes both a lateral and a vertical displacement of the pickup component relative to the UAV, with the vertical displacement becoming more pronounced at larger lateral displacements.

The value of the model-based constant k may be determined by fitting the model to represent the position of the pickup component (i.e., the end of each deflection profile) across different wind velocities. Specifically, the lateral offset constant kₓ may be determined by fitting the function Oₓ=kₓV_{WIND x}² to the lateral displacement of the pickup component, as shown by the horizontal axis of FIG. 45. The vertical offset constant k_{y} may be determined by fitting the function O_{y}=k_{y}V_{WIND y}² to the vertical displacement of the pickup component, as shown by the vertical axis of FIG. 45.

FIG. 46 illustrates the vertical and lateral offsets of the pickup component, as modeled by the expressions Oₓ=kₓV_{WIND x}² and O_{z}=k_{z}V_{WIND z}², for different wind speeds. Specifically, the topmost curve in FIG. 46 represents a horizontal offset of the pickup component as a function of wind speed. The bottommost curve in FIG. 46 represents a vertical offset of the pickup component as a function of wind speed. The middle curve in FIG. 46 represents an estimated horizontal offset of the pickup component when wind drag on the pickup component is considered, but wind drag on the tether is ignored. Accordingly, as can be seen from the difference between the middle curve and the top curve, a non-negligible component of the horizontal offset of the pickup component is caused by wind drag on the tether. Thus, modeling both the wind drag on the pickup component and the tether allows for a more accurate determination of the wind-induced displacement of the pickup component relative to the UAV.

In some embodiments, the position of the UAV may be adjusted to compensate for the wind-induced displacements of the pickup component relative to the UAV starting from, for example, a first time at which the autoloader device is detected and ending at a second time when the pickup component is engaged with the autoloader device. For example, once the pickup component enters a channel of the autoloader device, where the pickup component is no longer affected by wind, wind compensation may end, and the UAV may adjust its position accordingly. For example, the UAV may return to a non-compensated position that the UAV would have been in under windless environmental conditions. This return to the non-compensated position may align the UAV with the autoloader device such that, for example, the UAV is able to pull the pickup component through a channel of the autoloader device, applying a force in approximately a direction of the channel.

In some cases, adjustments to the position of the UAV that compensate for wind could cause unwanted swings of the payload after the pickup component engages with and picks up a payload from the autoloader device. For example, if the UAV is caused to adjust its position forward due to a headwind (which causes the pickup component to swing towards the back of the UAV), the payload could, due to the UAV being far forward relative to the autoloader device, swing forward once it is picked up from the autoloader device. Accordingly, prior to causing the pickup component to engaged the payload, the UAV may be caused to at least partly move back towards the non-compensated position, thereby reducing and/or minimizing a lateral displacement between the UAV and the pickup component, and thus reducing or minimizing payload oscillations after pickup.

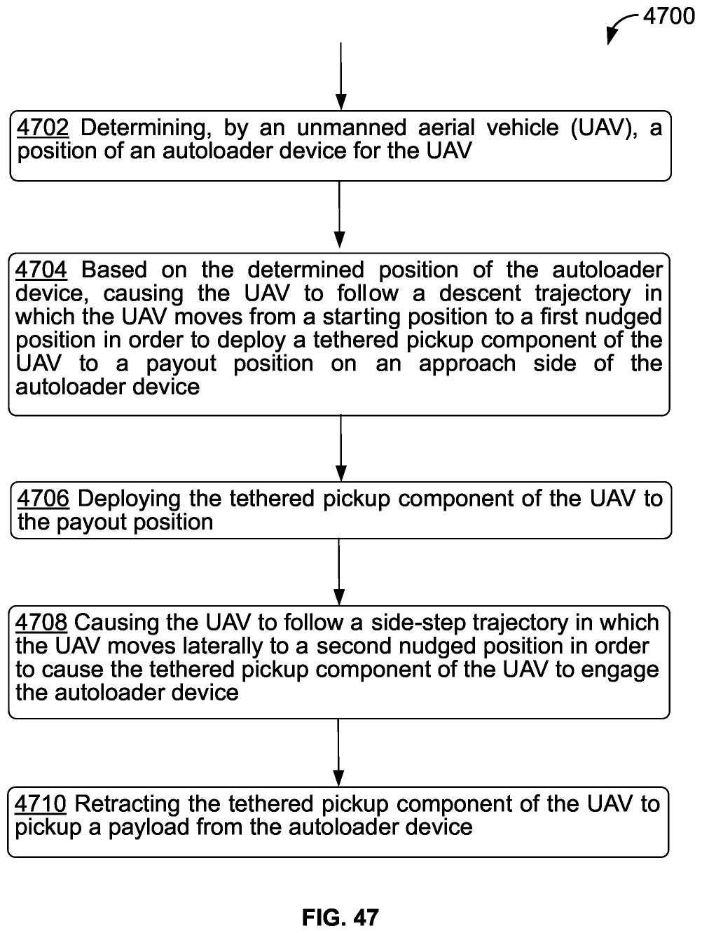

FIG. 47 is a block diagram of a method 4700, in accordance with examples described herein. The blocks of FIG. 47 may be carried out, for example, by a UAV and/or by a control system of a UAV. At block 4702, the method 4700 includes determining, by an unmanned aerial vehicle (UAV), a position of an autoloader device for the UAV. At block 4704, the method 4700 includes based on the determined position of the autoloader device, causing the UAV to follow a descent trajectory in which the UAV moves from a starting position to a first nudged position in order to deploy a tethered pickup component of the UAV to a payout position on an approach side of the autoloader device. At block 4706, the method 4700 includes deploying the tethered pickup component of the UAV to the payout position. At block 4708, the method 4700 includes causing the UAV to follow a side-step trajectory in which the UAV moves laterally to a second nudged position in order to cause the tethered pickup component of the UAV to engage the autoloader device. At block 4710, the method 4700 includes retracting the tethered pickup component of the UAV to pick up a payload from the autoloader device.

In some examples, the method 4700 includes causing the UAV to follow an ascent trajectory in which the UAV moves from the second nudged position back to the starting position or another convenient exit position.

In some examples, determining the position of the autoloader device is based on detecting a fiducial positioned at a predetermined position relative to the autoloader device. In some examples, the fiducial is fixed on the ground and oriented in a direction toward the autoloader device. In some examples, the fiducial is fixed on the autoloader device.

In some examples, the position of the autoloader device can be determined beforehand by a survey and sent to the UAV. In such examples, the UAV may not need to sense the autoloader when doing the pickup.

In further examples, determining the position of the autoloader device is based on applying a machine learned model to one or more images or a time series of images of the autoloader device captured by a camera on the UAV. In additional examples, determining the position of the autoloader device is based on applying a point cloud matching algorithm to a depth image captured by a depth camera or a lidar sensor or an ultrasonic sensor or any other range-finding sensor on the UAV. In further examples, determining the position of the autoloader device is based on detecting a light pattern from a beacon on the autoloader device. In additional examples, determining the position of the autoloader device is based on detecting radio signals emitted by the autoloader device. In further examples, determining the position of the autoloader device is based on detecting one or more retro-reflective surfaces of the autoloader device using an infrared sensor and illuminator on the UAV. In additional examples, determining the position of the autoloader device is based on detecting a plurality of retro-reflective points of the autoloader device using an infrared sensor and illuminator on the UAV.

In some examples, each of the descent trajectory, the side-step trajectory, and the ascent trajectory has a respective slew rate.

In some examples, the first nudged position is directly above the payout position. In further examples, the first nudged position is positioned relative to the payout position based on a wind model.

In some examples, the first nudged position is at a predetermined altitude above ground level. In additional examples, the first nudged position is at a predetermined level of the autoloader device, as determined by a depth estimate or one or more loader-mounted fiducials. Using autoloader level may allow for variable height autoloaders. In further examples, the first nudged position is at an altitude which is determined based on a wind model. In additional examples, the tethered pickup component of the UAV is deployed by a payout length determined based on a wind model.

In some examples, each of the first nudged position and the second nudged position is based on respective predetermined lateral offsets.

In some examples, causing the UAV to follow the ascent trajectory is performed after fully retracting the tethered pickup component or after a predetermined amount of time.

### XI. Example Payload Retrieval Apparatus Mounting Systems

In various embodiments, the payload retrieval apparatus may utilize existing structures, or structures with other purposes, such as buildings, lamp posts, signs, or other structures. In some embodiments, a stand-alone payload retrieval apparatus is mounted onto existing structure, such that the existing structure provides structural support to the payload retrieval apparatus. This can be beneficial for raising the payload retrieval apparatus to a higher elevation that is closer to the UAV, and/or for providing a payload retrieval apparatus without requiring that the payload retrieval apparatus has its own footprint, thereby freeing up ground space. In other embodiments, portions of the existing structure, such as walls, beams or projections, may form a portion of the payload retrieval apparatus, such as one or both of the tether engagers.

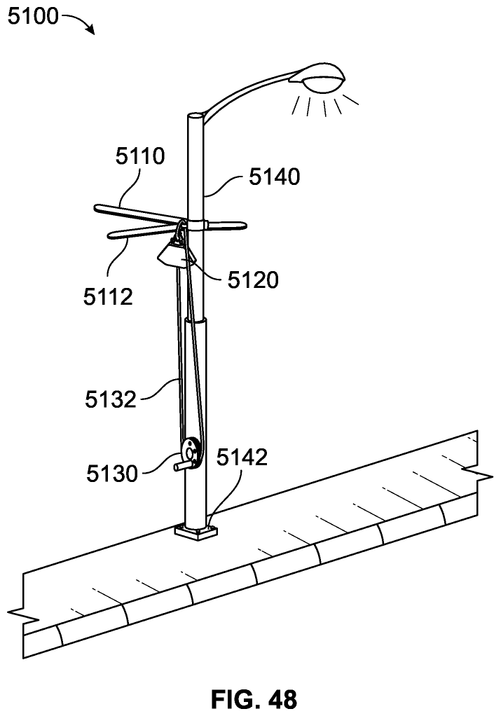

FIGS. 48-54 depict payload retrieval apparatus 5100 shown mounted to various structures in a variety of ways. Payload retrieval apparatus 5100 could take the form of payload retrieval apparatuses 1000, 1460, 1500, 1900, and 1950 described above, and could also be configured in different configurations. Payload retrieval apparatus 5100 is used for automated payload retrieval using a UAV. A payload 5120 is positioned on a payload holder on a rear end of payload retrieval apparatus 5100. Payload retrieval apparatus 5100 preferably includes tether engagers 5110 and 5112 that are used to engage a tether suspended from a UAV and attached to a payload coupling apparatus, whereafter the payload coupling apparatus is drawn into and through a payload coupling apparatus channel in the payload retrieval apparatus 5100 to pick up payload 5120. The use of existing structures as a mount for the payload retrieval apparatus 5100 advantageously eliminates the need to build a separate support structure, and instead allows existing structures to be utilized as a mount for the payload retrieval apparatus 5100. In some examples, any of the illustrated retrieval methods may be powered by a motor (e.g., instead of a manually operated hand crank). Electricity may also be provided to the payload retrieval apparatus 5100 to power a transmitter to enable the payload retrieval apparatus 5100 to communicate information to a central control system and/or UAV, as otherwise described herein. In some such examples, electricity may be provided to the payload retrieval apparatus 5100 by a light post, sign post, or other piece of existing infrastructure.

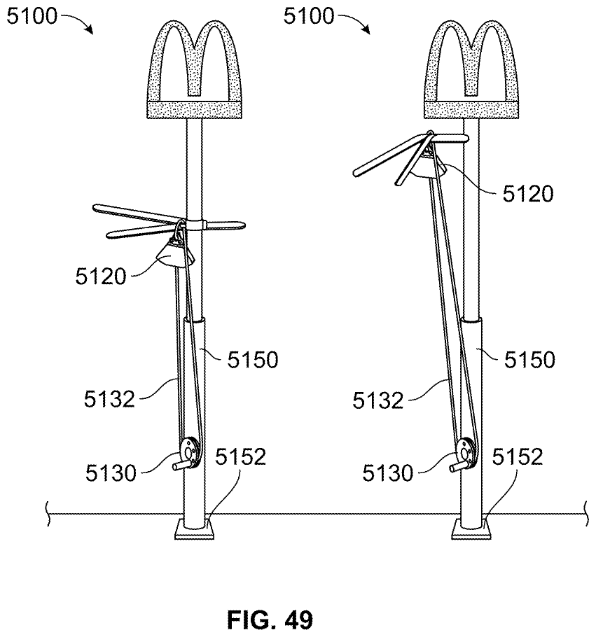

In FIG. 48, payload retrieval apparatus 5100 is mounted to light pole 5140 having a base 5142, and in FIG. 49, payload retrieval apparatus 5100 is mounted to sign post 5150 having a base 5152. For example, the payload retrieval apparatus 5100 may be mounted to such a pole or post on the premises of an item provider in order to assist with curbside pickup, as described above. Further, the payload retrieval apparatus 5100 may be mounted on infrastructure used in a curbside environment, such a sign post that identifies a curbside pickup parking spot for an automobile.

In using either a light post or a sign post as a mount, a pulley system may be used including pulley crank 5130 and pulley strings 5132. The pulley system is used to raise payload retrieval apparatus 5100 and attached payload 5120 into a raised location with respect to light pole 5140 or sign post 5150 to position payload retrieval apparatus 5100 into a desired position to allow for the payload 5120 to be retrieved by a UAV using a payload coupling apparatus attached to a tether suspended from the UAV. Following retrieval of payload 5120, the payload retrieval apparatus 5100 may be lowered using the pulley system and an additional payload may be loaded onto payload retrieval apparatus 5100 for subsequent automatic retrieval using a UAV. In some examples, a pulley system may raise or lower the payload 5120 using an electric motor, which may save time and energy expended by a person loading the payload retrieval apparatus 5100.

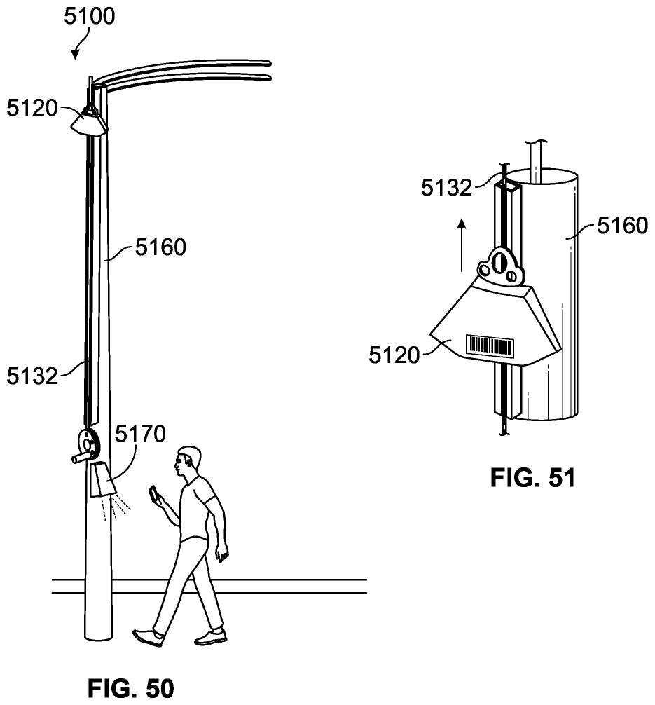

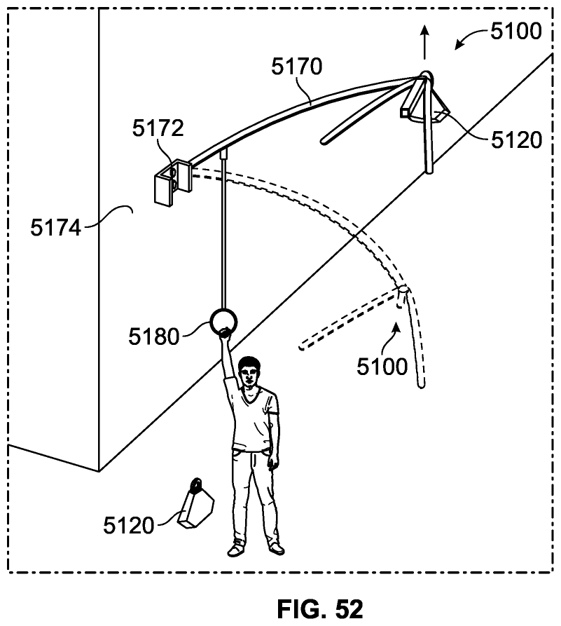

FIG. 50 illustrates that payload retrieval apparatus 5100 may be mounted to other structures as well. In FIG. 50, payload retrieval apparatus 5100 is mounted to flagpole 5160 with payload 5120 secured in a high position using pulley strings 5132. A tablet scanner 5170 may also be positioned on the flag pole 5160 (as well as light post 5140 and sign post 5150) which allows for an operator to scan the payload 5120 before it is raised up the flag pole 5160. In this manner, information can be conveyed to a UAV or UAV fleet that a payload is in position for retrieval. Some details of the pulley system used to raise payload 5120 including pulley string 5132 and an internal return pulley string within flag pole 5160 are shown in FIG. 51.

FIG. 52 illustrates payload retrieval apparatus 5100 attached to boom arm 5170 attached to a wall 5174 using wall mount 5172. Payload 5120 is secured to the payload retrieval apparatus 5100. The boom arm 5170 may be movably mounted with wall mount 5172 mounted to wall 5174. Because the boom arm 5170 is movably mounted to wall mount 5172, an operator may pull down on handle 5180 which has a string 5182 attached to the handle 5180 and the boom arm 5170 to lower the boom arm 5170 such that an operator may secure a payload 5120 to the payload retrieval apparatus 5100. After the payload 5120 is secured to the payload retrieval apparatus 5100, the boom arm 5170 may return to a raised position. The boom arm 5170 may be spring-loaded in wall mount 5172 to bias the boom arm 5170 to its raised position, and the wall mount 5172 may be provided with a return mechanism that allows for a slow, smooth return so that the payload 5120 is not dislodged from the payload retrieval apparatus 5100 upon return of the payload retrieval apparatus 5100 to the raised position. In this manner, an existing structure, here a wall 5174, may be used to mount the payload retrieval apparatus 5100 without requiring the need to build a separate structure to support the payload retrieval apparatus 5100.

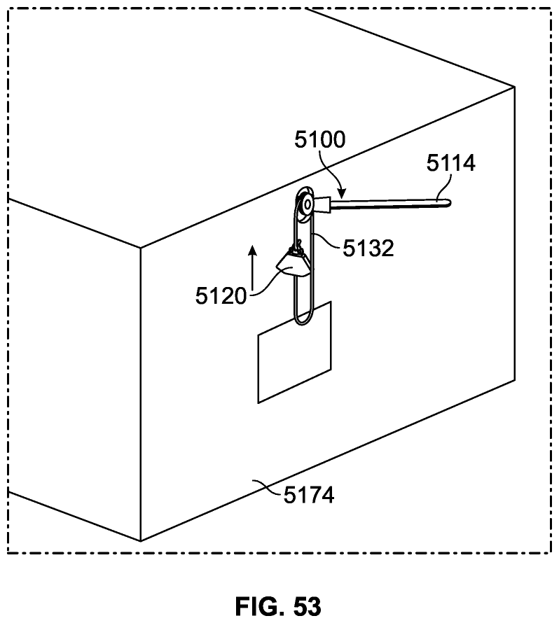

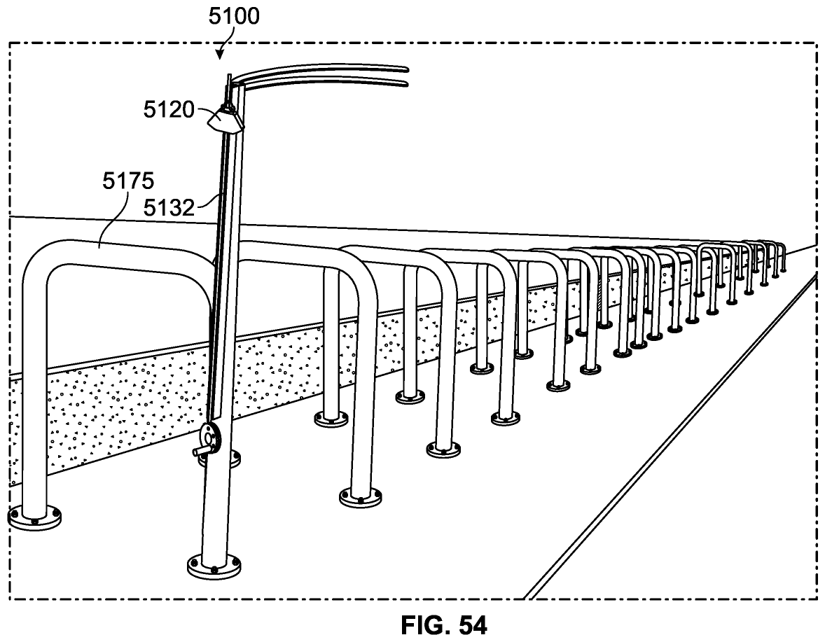

In another embodiment shown in FIG. 53, the payload retrieval apparatus 5100 is mounted directly to the wall 5174, and only a single tether engager 5114 is required, as the wall 5174 serves the same purpose as a second tether engager would if the payload retrieval apparatus 5100 were freestanding. A pulley system using pulley string 5132 may be used to raise the payload 5120 into position secured to the payload retrieval apparatus 5100.

Additional existing infrastructure may also be used to mount the payload retrieval apparatus 5100 such as bike racks 5175 shown in FIG. 54. Shopping cart return structure may also be used for mounting the payload retrieval apparatus 5100, and other suitable existing structures may also be used.

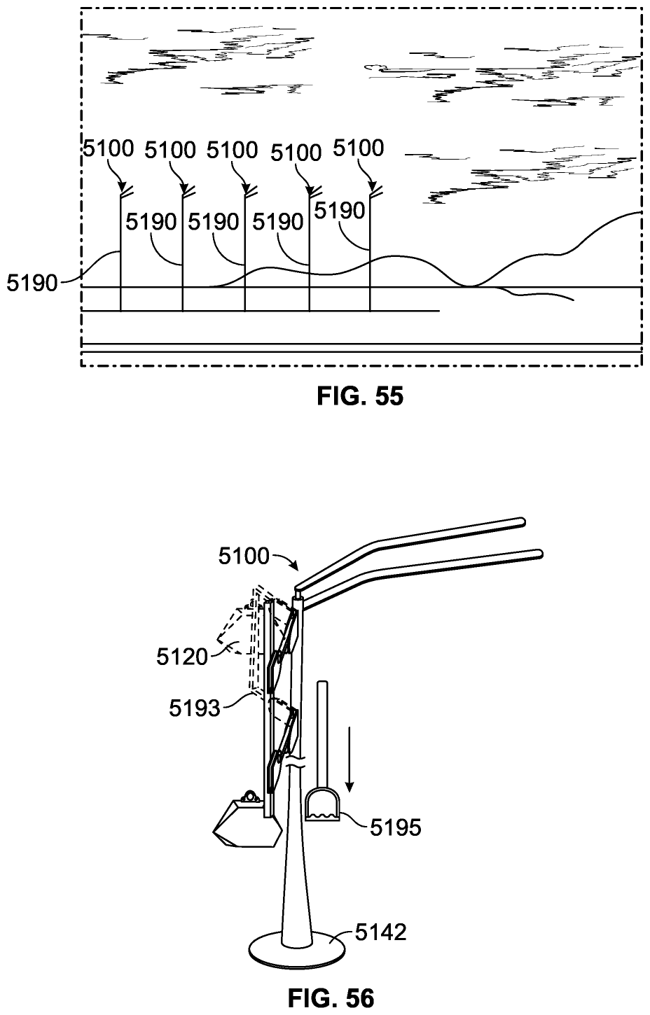

FIG. 55 illustrates that a series of poles 5190 each having a payload retrieval apparatus 5100 mounted on a top of each pole 5190 may be provided to create payload retrieval zone.

FIG. 56 illustrates a freestanding payload retrieval apparatus 5100 positioned above base 10. A linkage system 5193 operated using handle 5195 is used to raise payload 5120 into position while secured to payload retrieval apparatus 5100. The linkage system 5193 is used to raise a payload 5120 into position on the payload retrieval apparatus 5100. Following retrieval of payload 5120, the linkage system 5193 is used to lower the payload attachment point of the payload retrieval apparatus 5100 so that an additional payload 5120 may be positioned on the linkage system 5193 and then the additional payload 5120 may be raised into position on the payload retrieval apparatus 5100.

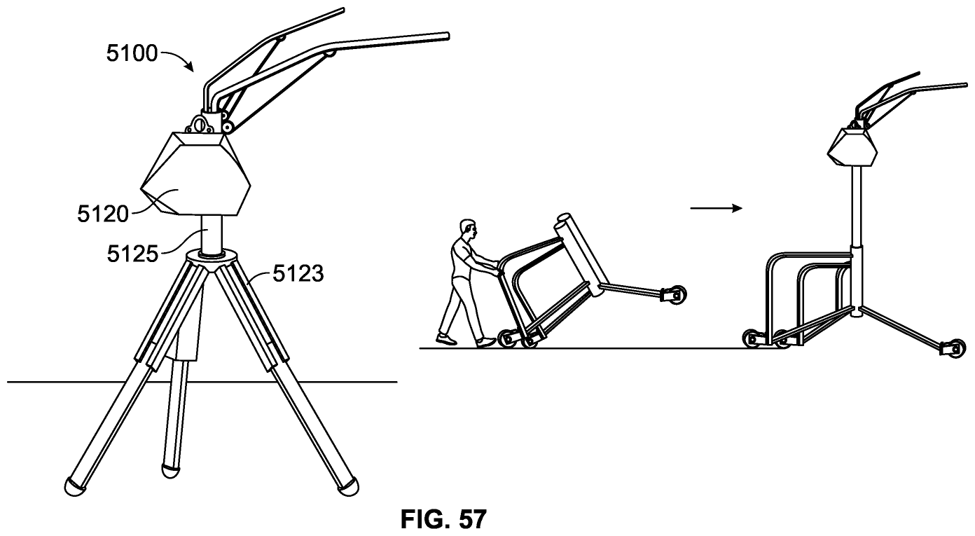

FIG. 57 illustrates a movable payload retrieval system 5100 attached to an upwardly extending member 5135 having a foldable tri-pod style base 5123. In this manner, the payload retrieval apparatus 5100 may be easily moved into a desired position and set up in an easy manner. A wheeled dolly may be used to move the payload retrieval apparatus 5100 into the desired location, where the tri-pod base 5123 may be deployed. Thus, a mobile payload retrieval apparatus 5100 may be provided.

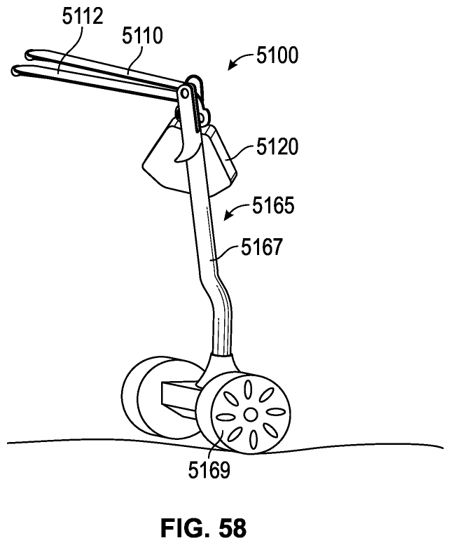

FIG. 58 illustrates a mobile “autoloader” 5165 with payload retrieval apparatus 5100. Payload 5120 is secured to payload retrieval apparatus 5100 having tether engagers 5110 and 5112, where the payload retrieval apparatus 5100 is mounted on top of upwardly extending member 5167 mounted above wheels 5169. The mobile “autoloader” 5165 may be motorized and drive itself to a desired location. In this manner, the payload 5120 may be mounted to the payload retrieval apparatus 5100 inside a building and then the mobile “autoloader” 5165 may drive itself to the desired location. When inside a building, the mobile “autoloader” 5165 may have the tether engagers 5110 and 5112 folded down to reduce the space required to house the mobile “autoloader,” 5165, and the mobile “autoloader” 5165 may be recharged while inside the building.

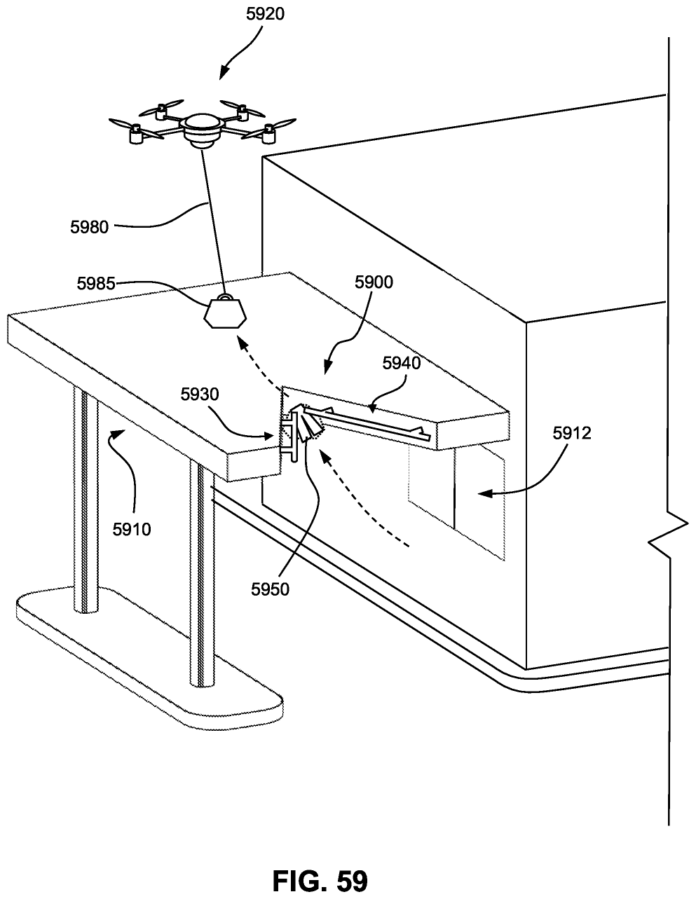

FIGS. 59 to 66 illustrate example payload retrieval apparatuses that are integrated into other structures. The embodiments shown in FIGS. 59 to 64 are shown in the context of a drive-thru window, for example of a restaurant establishment. However, other embodiments with similar features as those of FIGS. 59 to 64 may be provided in other contexts, such as retailers, pharmacies, offices or other establishments.

FIG. 59 illustrates a payload retrieval apparatus 5900 that is integrated into an existing structure 5910 in the form of an overhang. The overhang 5910 extends over a drive-thru window 5912 of a restaurant establishment. Accordingly, orders from the restaurant can be provided to cars that travel through the drive-thru or can be packaged as a payload for receipt by the payload retrieval apparatus 5900. In such a case, similar to the operation of other payload retrieval apparatuses described above, a UAV 5920 may travel along the same route as a car past the drive-thru with its tether 5980 extended. As the UAV 5920 travels along the route the tether 5980 may engage the tether engagers 5930 and/or 5940 which guide the tether 5980 and associated payload retriever toward a channel 5950. The payload retriever is then guided through the channel 5950 by movement of the UAV 5920 and/or retraction of the tether 5980, and the payload retriever collects the payload 5985 from the payload retrieval apparatus 5900.

In payload retrieval apparatus 5900, both tether engagers 5930 and 5940 are integrated into the overhang structure 5910. In particular, the overhang structure 5910 has a v-shaped opening that forms the tether engagers 5930 and 5940, which guide the tether toward the channel 5950. In some embodiments, a hole may be provided at the end of the v-shaped opening to provide additional space for the payload to pass.

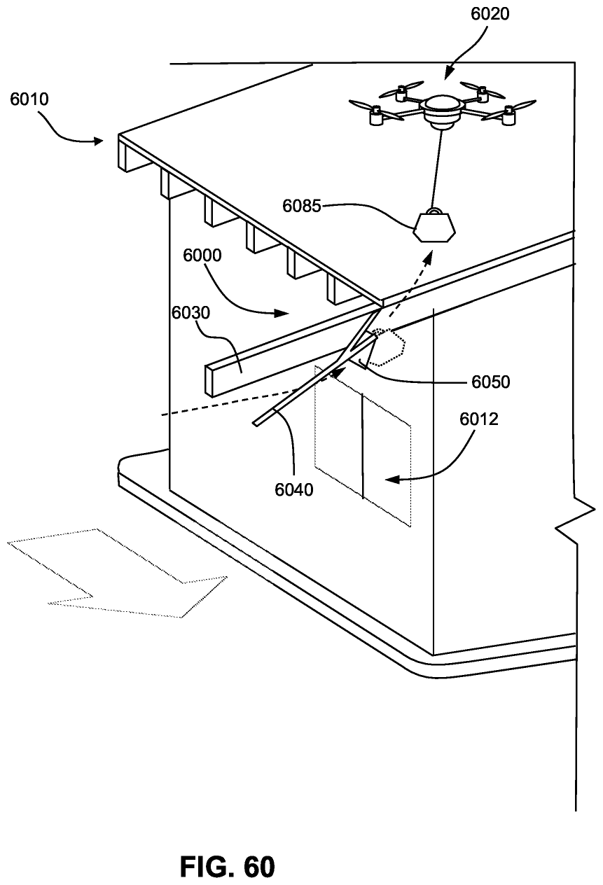

FIG. 60 illustrates another embodiment of a payload retrieval apparatus 6000 integrated into an existing structure in the form of a roof 6010 that extends over the drive-thru window 6012. The payload retrieval apparatus 6000 utilizes a structural beam of the roof 6010 to form one of the tether engagers 6030. In this case, the structural beam extends past the lower eave of the roof 6010 to form the tether engager 6030. A second tether engager 6040 is also attached to the roof 6010, and collectively the two tether engagers 6030 and 6040 are operable to guide a tether toward the channel 6050 to pickup a payload 6085.

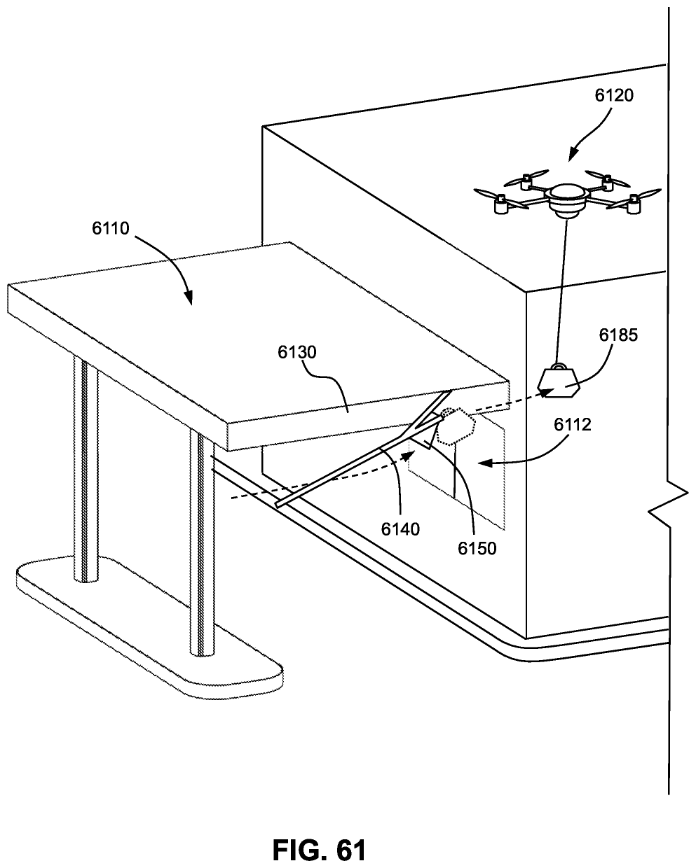

FIG. 61 illustrates a similar embodiment of a payload retrieval apparatus 6100 that is integrated into an existing structure in the form of an overhang 6110 that extends over the drive-thru window 6112 and covers the entire drive-thru area. The edge of the overhang 6110 forms a tether engager 6130 of the payload retrieval apparatus 6100 and a second tether engager 6140 is also attached to the overhang 6110. The two tether engagers 6130 and 6140 are thereby operable to guide a tether to the channel 6150 where a payload 6185 can be retrieved. As shown, with this configuration, the channel 6150 of the payload retrieval apparatus 6100 is very close to the drive-thru window 6112, such that an employee of the restaurant may place the payload on the payload retrieval apparatus 6100 directly from inside the window 6112. In other embodiments, a conveyor or other type of carrier may move payloads from the window to the payload retrieval apparatus, or a person may walk out of the building to place the payload on the payload retrieval apparatus.

In some embodiments, the existing structural component may provide a tether engager of the payload retrieval apparatus without any modification, such that, in operation, the tether directly contacts the unmodified existing structure. For example, in the embodiment shown in FIG. 61, the payload retrieval apparatus 6100 is configured such that the tether directly contacts the existing overhang 6110. In other embodiments, the existing structure may form the tether engager by providing structural support and defining at least a portion of the shape of the tether engager, but may include additional components that are configured to directly contact the tether. For example, in the embodiment shown in FIG. 59, the tether engagers 5930 and 5940 of the payload retrieval apparatus 5900 are formed by the internal edges of the v-shaped opening of the overhang 5910, but the tether engagers also include rails that are configured to directly contact the tether. Other components, such as strips of low friction material or other guides may also be placed on the existing structure that forms the tether engagers.

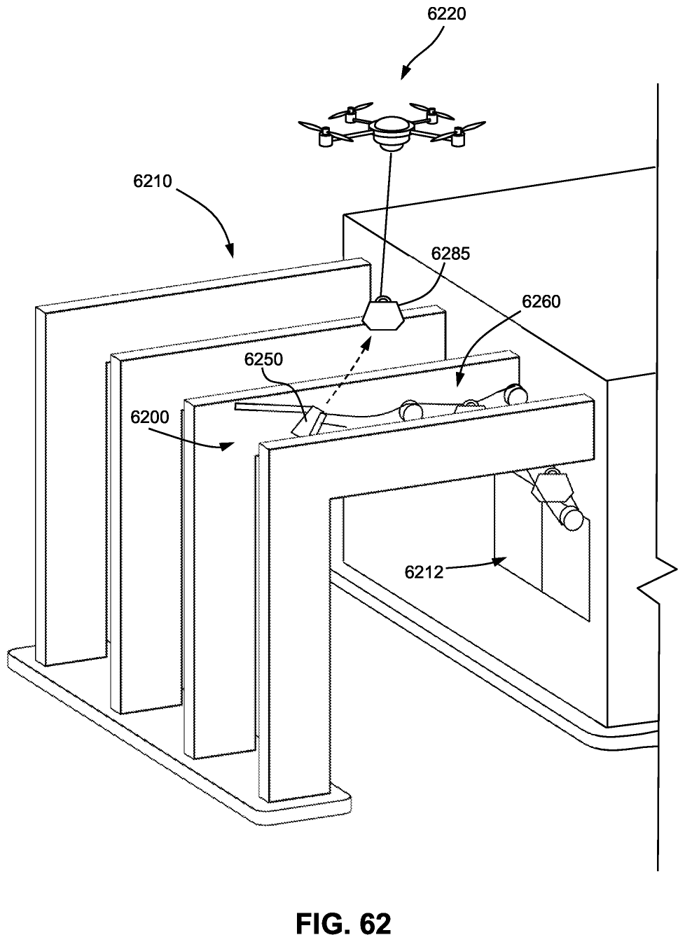

FIG. 62 illustrates another embodiment of a payload retrieval apparatus 6200 that is integrated into an existing structure in the form of a group of parallel beams 6210 that extend over the drive-thru area. In this embodiment, the open area between the individual beams is used to guide the tether toward the channel 6250, such that the beams themselves form portions of the tether guides. The embodiment of FIG. 62 also includes a conveyor device 6260 for moving payloads from the drive-thru window 6212 to the payload retrieval apparatus 6200. The conveyor device 6260 may carry the payloads within the space between the beams to provide protection for the moving payloads.

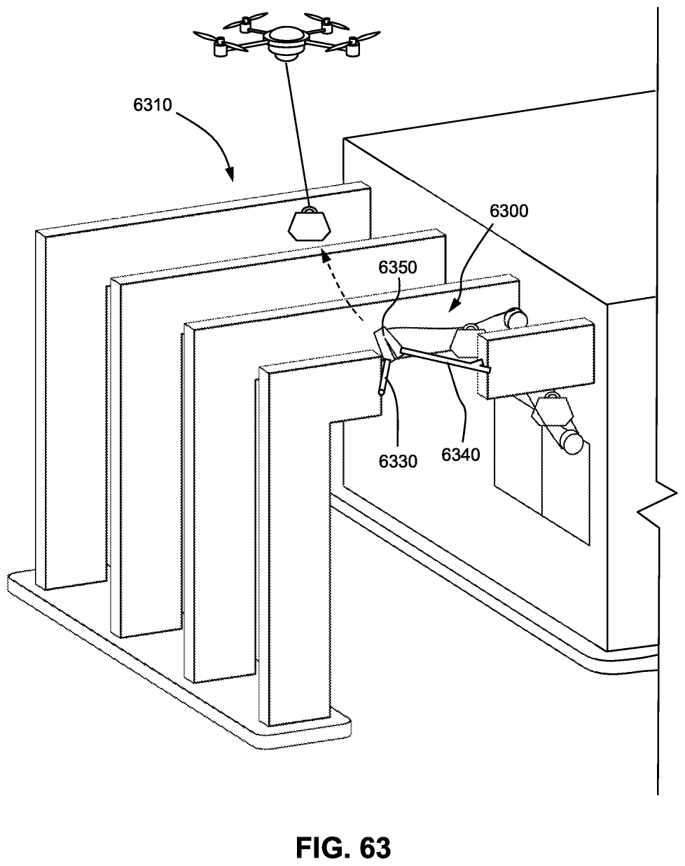

FIG. 63 illustrates another embodiment of a payload retrieval apparatus similar to that shown in FIG. 62, where the payload retrieval apparatus 6300 is integrated into a group of beams 6310 extending over the drive-thru area. In this case, the payload retrieval apparatus 6300 is adapted to guide tethers that are moving perpendicular to the beams rather than parallel to the beams. Accordingly, the tether engagers 6330 and 6340 guide the tether across the beams and toward the channel 6350.

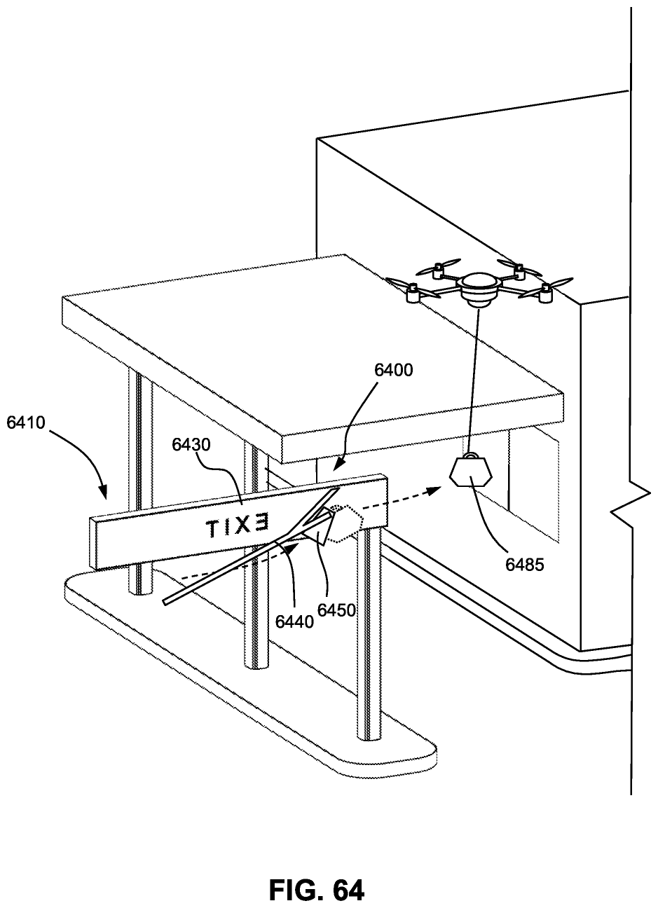

FIG. 64 illustrates another embodiment of a payload retrieval apparatus 6400 that is integrated into an existing structure in the form of a sign 6410 that extends over a driving lane that is adjacent to the drive-thru area. The sign 6410 forms one tether engager 6430 of the payload retrieval apparatus 6400 and a second tether engager 6440 is also attached to the overhang 6410. The two tether engagers 6430 and 6440 are thereby operable to guide a tether to the channel 6450 where a payload 6485 can be retrieved.

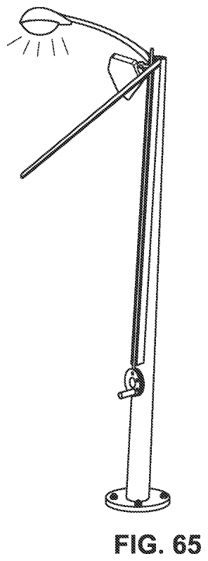

FIG. 65 illustrates another embodiment of a payload retrieval apparatus, in this case integrated with a light post. In contrast to FIG. 48, the elongated light mounting fixture is used as one of the tether engagers in FIG. 65. A separate tether engager is also mounted to the light post so that the two tether engagers may be operable to guide a tether into a channel to retrieve a payload. The illustrated example beneficially leverages the existing structure of the light post to form a portion of a payload retrieval apparatus.

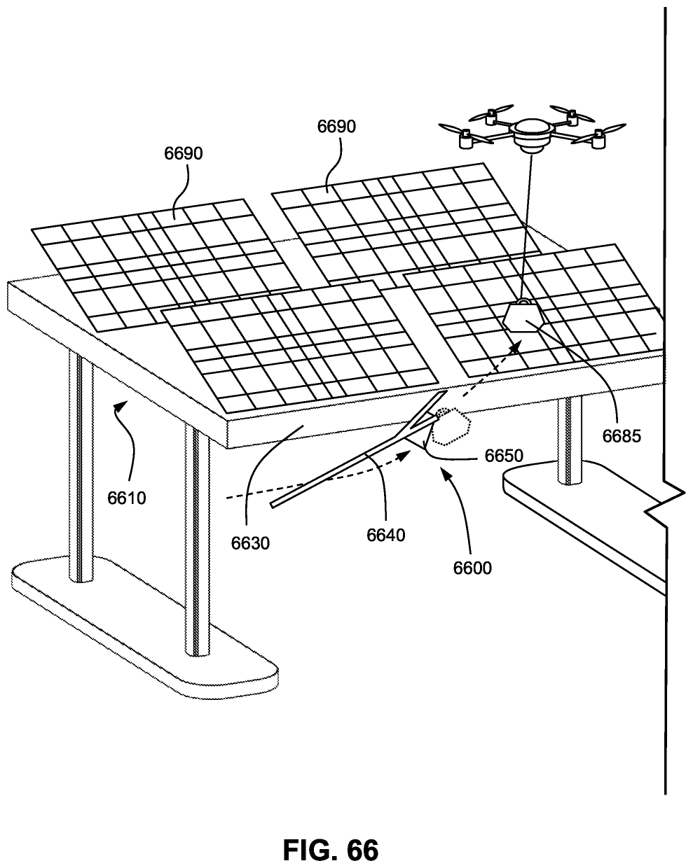

FIG. 66 illustrates an embodiment of a payload retrieval apparatus 6600 that is integrated into a shade structure 6610 for parked cars. The shade structure 6610 includes a plurality of solar panels 6690 thereon, which further utilizes the space for yet another purpose. The edge of the shade structure 6610 forms a tether engager 6630 of the payload retrieval apparatus 6600 and a second tether engager 6640 is also attached to the shade structure 6610. The two tether engagers 6630 and 6640 are thereby operable to guide a tether to the channel 6650 where a payload 6685 can be retrieved.

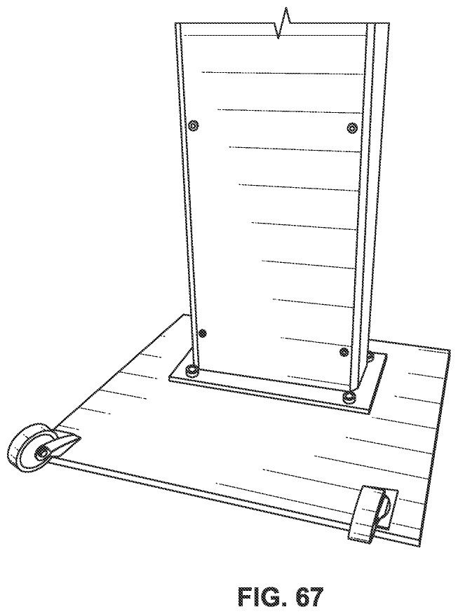

FIG. 67 illustrates an example mobile base for a payload retrieval apparatus. In some examples, the payload retrieval apparatus may include multiple different swappable bases. For instance, a first swappable base may be for a semi-permanent installation into cement or asphalt, while a second swappable base (as illustrated in FIG. 67) may include wheels to enable automatic or manual movement to allow for simple portability of the payload retrieval apparatus between locations. Other types of swappable bases may be included as well or instead in further examples.

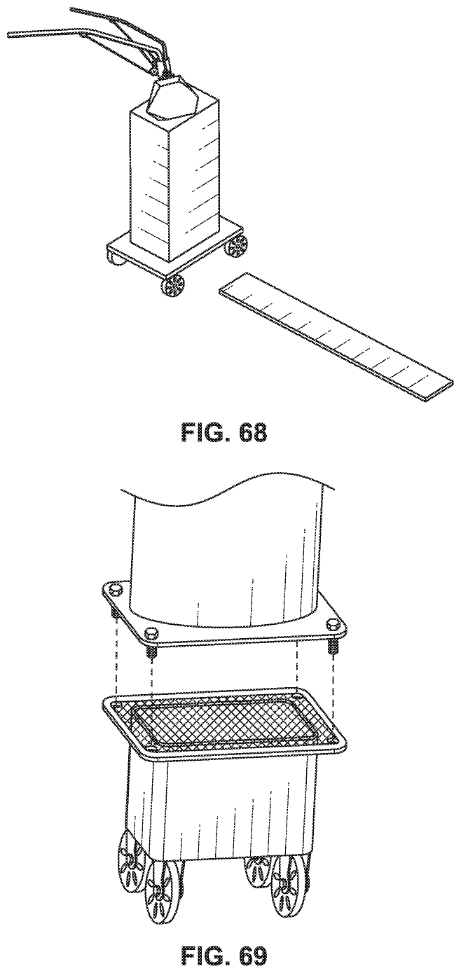

FIG. 68 illustrates movement of a payload retrieval apparatus along a line tracker. More specifically, all or at least a portion of the payload retrieval apparatus may be placed on a platform that moves to integrate with the delivery workflow described herein. In particular, all or a portion of the autoloader device may move between a first location for the physical loading of the payload onto the autoloader device and a second location for the pickup of the payload by the UAV from the autoloader device. FIG. 68 illustrates one example for enabling such movement, placing all or a portion of the autoloader device on a line tracker. More specifically, the autoloader device may use one or more sensors on the autoloader device to detect a white stripe on parking lot asphalt to move a package from a package assembly station to a parking lot ready for pickup. In other examples, all or a portion of an autoloader device may be placed on a linear rail, moving back and forth from a package assembly station to a parking lot ready for pickup. In yet further examples, all or a portion of an autoloader device may be placed on a linear and/or circular rail. Such a rail may be used to cycle the autoloader device (or multiple autoloader devices) through stations ready for package pickup from a package assembly station to locations ready for UAV pickup in a parking lot.

FIG. 69 illustrates mounting a payload retrieval apparatus onto a mobile base. The mobile base may provide intelligence to the payload retrieval apparatus in the form of one or more sensors and/or computer control systems. More specifically, the base of a payload retrieval apparatus may be swapped with a fully autonomous mobile robot (e.g., a delivery robot) with full sensing and processing capabilities. Such an arrangement may advantageously provide a number of opportunities. For instance, the arrangement may enable an autoloader device to sense shadows that would make detection by a UAV difficult. In these circumstances, the autoloader device may move to another location to improve detectability, particularly to enable detection of fiducial markers on the autoloader device. As another example, the autoloader device may be able to sense trees, construction cranes, or other temporary obstacles that would make detection or package pickup difficult. Such detections may be used by the autoloader device to reposition itself before package retrieval. In yet further examples, sensing capabilities may also enable the autoloader device to move itself towards an available UAV for package pickup and/or towards an available payload (e.g., at a drive-thru window or similar location).

### XIII. Example Payload Retrievers

Embodiments of the present disclosure may thus relate to one of the enumerated example embodiments (EEEs) listed below.

EEE 1 is a payload retrieval apparatus comprising: an extending member having an upper end and a lower end; a channel having a first end and a second end, the channel coupled to the extending member; a first tether engager that extends in a first direction from the first end of the channel; and a payload holder positioned near the second end of the channel and adapted to secure a payload, wherein the payload retrieval apparatus is mounted to a structure.

EEE 2 is the payload retrieval apparatus of EEE 1, wherein the structure is a light post.

EEE 3 is the payload retrieval apparatus of EEE 1, wherein the structure is a sign post.

EEE 4 is the payload retrieval apparatus of EEE 1, wherein the structure is a flagpole.

EEE 5 is the payload retrieval apparatus of EEE 1, wherein the structure is a bike rack.

EEE 6 is the payload retrieval apparatus of EEE 1, wherein the structure is a shopping cart return.

EEE 7 is the payload retrieval apparatus of EEE 1, wherein the structure is a wall.

EEE 8 is the payload retrieval apparatus of EEE 1, wherein a pulley system is mounted to the structure, the pulley system operable to raise and lower the payload retrieval apparatus.

EEE 9 is the payload retrieval apparatus of EEE 1, further including a second tether engager that extends in a second direction from the first end of the channel.

EEE 10 is a payload retrieval apparatus comprising: an extending member having an upper end and a lower end; a channel having a first end and a second end, the channel coupled to the extending member; a first tether engager that extends in a first direction from the first end of the channel; and a payload holder positioned near the second end of the channel and is adapted to secure a payload, wherein the payload retrieval apparatus is mounted to a boom arm that is mounted to a wall with a boom mount, wherein the boom mount is movable to allow the payload retrieval apparatus to be lowered to allow an operator to secure a payload to the payload retrieval apparatus.

EEE 11 is the payload retrieval apparatus of EEE 10, wherein the wall boom mount is spring-loaded.

EEE 12 is the payload retrieval apparatus of EEE 11, wherein the wall boom mount includes a return mechanism that provides for a smooth, slow return of the payload retrieval apparatus to a raised position.

EEE 13 is a movable payload retrieval apparatus comprising: an extending member having an upper end and a lower end; a channel having a first end and a second end, the channel coupled to the extending member; a first tether engager that extends in a first direction from the first end of the channel; a payload holder positioned near the second end of the channel and is adapted to secure a payload, wherein the payload retrieval apparatus includes a movable base positioned below the lower end of the extending member.

EEE 14 is the movable payload retrieval apparatus of EEE 13, further including a linkage mechanism with a handle, the linkage mechanism operable to raise a payload into position on the payload retrieval apparatus.

EEE 15 is the movable payload retrieval apparatus of EEE 13, wherein the movable base comprises a tri-pod base.

EEE 16 is the movable payload retrieval apparatus of EEE 13, wherein the movable base comprises a wheeled base.

EEE 17 is the movable payload retrieval apparatus of EEE 16, wherein the wheeled base is motorized and operable to drive the movable payload retrieval apparatus to a desired location.

EEE 18 is an apparatus comprising: an infrastructure component; a channel having a first end and a second end, the channel coupled to the infrastructure component; a first tether engager that extends in a first direction from the first end of the channel, the first tether engager coupled to the infrastructure component; and a payload holder positioned near the second end of the channel and adapted to secure a payload for pickup by a UAV.

EEE 19 is the apparatus of EEE 18, wherein the infrastructure component comprises a second tether engager that extends in a second direction from the first end of the channel.

EEE 20 is an apparatus comprising: an infrastructure component; a channel having a first end and a second end, the channel coupled to the infrastructure component; and a payload holder positioned near the second end of the channel and adapted to secure a payload for pickup by a UAV, wherein the infrastructure component comprises a first tether engager that extends in a first direction from the first end of the channel and a second tether engager that extends in a second direction from the first end of the channel.

EEE 21 is an apparatus comprising: an infrastructure component; and a payload retrieval component mounted to the infrastructure component so as to form a payload retrieval apparatus, wherein the payload retrieval component comprises: a channel adjacent to the infrastructure component and having a first end and a second end, a payload holder positioned near the second end of the channel and adapted to secure a payload for pickup by a UAV, and a first tether engager extending in a first direction from the channel and arranged such that the first tether engager and the infrastructure component are adapted to guide at tether toward the channel.

EEE 22 is the apparatus of EEE 21, wherein the first tether engager extends at an angle to a surface of the infrastructure component.

### XII. CONCLUSION

The particular arrangements shown in the Figures should not be viewed as limiting. It should be understood that other implementations may include more or less of each element shown in a given Figure. Further, some of the illustrated elements may be combined or omitted. Yet further, an exemplary implementation may include elements that are not illustrated in the Figures.

Additionally, while various aspects and implementations have been disclosed herein, other aspects and implementations will be apparent to those skilled in the art. The various aspects and implementations disclosed herein are for purposes of illustration and are not intended to be limiting, with the true scope and spirit being indicated by the following claims. Other implementations may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

What is claimed is:

1. A method comprising:
providing instructions to cause physical loading of a payload onto an autoloader device for subsequent unmanned aerial vehicle (UAV) transport of the payload;
receiving a communication signal indicating that the autoloader device has been physically loaded with the payload;
selecting a UAV from a group of one or more UAVs to pick up the payload from the autoloader device; and
providing instructions to cause the selected UAV to navigate to the autoloader device to pick up the payload and transport the payload to a delivery location.

2. The method of claim 1, further comprising identifying the autoloader device as an empty autoloader device from a plurality of autoloader devices before providing the instructions to cause the physical loading of the payload.

3. The method of claim 1, further comprising selecting the autoloader device after receiving a user-provided input signal at a user device, the input signal indicating to proceed with autoloader loading.

4. The method of claim 3, wherein the communication signal indicating that the autoloader device has been physically loaded with the payload is received from the user device.

5. The method of claim 1, further comprising providing the UAV with a delivery mission to the delivery location before the UAV reaches the autoloader device.

6. The method of claim 1, further comprising providing the UAV with a delivery mission to the delivery location via a wireless connection while the UAV is picking up the payload from the autoloader device.

7. The method of claim 1, wherein the UAV determines the delivery mission by scanning a fiducial marker or reading a radio frequency identification (RFID) tag on the payload.

8. The method of claim 1, further comprising causing a user device to display an indication of a plurality of autoloader devices, wherein the plurality of autoloader devices includes the autoloader device.

9. The method of claim 8, wherein indication of the plurality of autoloader devices is color-coded based on availability of each autoloader device of the plurality of autoloader devices.

10. The method of claim 8, wherein indication of the plurality of autoloader devices is color-coded based on availability of proximate UAVs to each autoloader device of the plurality of autoloader devices.

11. The method of claim 8, further comprising causing the user device to display a listing of delivery orders available for UAV delivery based on UAV availability and capability to reach delivery zones associated with each of the delivery orders.

12. The method of claim 1, wherein the communication signal is received when a user scans an identifier on the autoloader device while loading the payload onto the autoloader device.

13. The method of claim 1, wherein the communication signal is received when a user selects a delivery order on a user device for which the user has loaded the payload onto the autoloader device.

14. The method of claim 1, wherein the communication signal is received from the autoloader device when the autoloader device detects that the autoloader device has been physically loaded with the payload.

15. The method of claim 1, wherein the group of one or more UAVs is associated with a location of the autoloader device.

16. The method of claim 1, wherein the group of one or more UAVs is associated with a different location than a location of the autoloader device, wherein the UAV is selected from the group of one or more UAVs when one or more UAVs associated with the location of the autoloader device are occupied.

17. The method of claim 1, wherein the autoloader comprises one or more computing devices configured to read an attached identifier on the payload and initiate a shipment that specifies a pickup zone associated with the autoloader and the delivery location which is encoded in the attached identifier.

18. The method of claim 1, wherein the autoloader comprises one or more computing devices configured to communicate the delivery location to the UAV.

19. The method of claim 1, further comprising causing the autoloader device to move between a first location for the physical loading of the payload onto the autoloader device and a second location for the pickup of the payload by the UAV from the autoloader device.

20. The method of claim 19, wherein the autoloader device moves using a line tracker.

21. The method of claim 19, wherein the autoloader device is mounted to a rail and moves along the rail.

22. The method of claim 19, wherein the autoloader device comprises a swappable mobile base for movement between the first location and the second location.

23. The method of claim 19, further comprising causing the autoloader device to use one or more sensors on the autoloader device to determine at least one of an available payload at the first location or an available UAV at the second location.

24. One or more computing devices comprising non-transitory computer readable medium comprising program instructions executable by one or more processors to cause the one or more computing devices to perform functions comprising:
providing instructions to cause physical loading of a payload onto an autoloader device for subsequent unmanned aerial vehicle (UAV) transport of the payload;
receiving a communication signal indicating that the autoloader device has been physically loaded with the payload;
selecting a UAV from a group of one or more UAVs to pick up the payload from the autoloader device; and
providing instructions to cause the selected UAV to navigate to the autoloader device to pick up the payload and transport the payload to a delivery location.

25. One or more non-transitory computer readable media comprising program instructions executable by one or more processors to cause one or more computing devices to perform functions comprising:
providing instructions to cause physical loading of a payload onto an autoloader device for subsequent unmanned aerial vehicle (UAV) transport of the payload;
receiving a communication signal indicating that the autoloader device has been physically loaded with the payload;
selecting a UAV from a group of one or more UAVs to pick up the payload from the autoloader device; and
providing instructions to cause the selected UAV to navigate to the autoloader device to pick up the payload and transport the payload to a delivery location.
